(19) United States
(12) Patent Application Publication
(10) Pub. No.: US 2019/0226154 A1
(43) Pub. Date: Jul. 25, 2019

(54) Automatic pre-fabrication of plated railroad ties and sections of railroad track

(71) Applicants: David P. Ollendick, North Llittle Rock, AR (US); Timothy E. Ovel, Waterloo, IA (US)

(72) Inventors: David P. Ollendick, North Llittle Rock, AR (US); Timothy E. Ovel, Waterloo, IA (US)

(21) Appl. No.: 15/932,007

(22) Filed: Jan. 22, 2018

(51) Int. Cl. E01B 9/06; E01B 3/02; B23B 41/00; E01B 9/44; E01B 29/02

(52) U.S. Cl. CPC E01B 9/06; E01B 3/02; E01B 29/02; E01B 9/44; B23B 2215/32; B23B 41/003

(57) ABSTRACT

Novel systems and methods are disclosed for fully automated creation of plated ties and/or pre-fabricated sections of railroad track away from and for shipment to an installation site.

### FIELD OF INVENTION

The present invention relates generally to tie-supported railroad tracks and, more particularly, to systems and methods for automatically pre-fabricating plated railroad ties and sections of railroad track, remote from an installation site.

### BACKGROUND

In regard to plating wooden railroad ties, traditionally such has been labor-intensive, including manual placement of the plates at gauge-defining spaces on top of each tie, but also manual effort to insert the spikes, with a suitable tool, into the ties through apertures in the plates. Sometimes the ties are pre-drilled using human labor to control the drilling. The formation of prefabricated sections of railroad track has not been typically done off-site. Typically, it has been done on-site, where railroad line construction or repair is taking or is to take place.

### BRIEF SUMMARY AND OBJECTS OF THE INVENTION

In brief summary, the present invention overcomes or substantially alleviates time-consuming and labor-intensive problems of the past related to accurately securing tie plates to railroad ties and constructing sections of complete railroad tracks. More specifically, the present invention is directed to novel systems and methods for automated creation of plated ties and/or pre-fabricated sections of railroad track away from and for shipment to an installation site.

As is apparent in the industry and from U.S. Pat. Nos. 6,546,612 and 6,681,474, pre-plating railroad ties typically has not been automated, but has been time-intensive and labor-intensive, even when tools, under human control, are used. Automatic pre-fabrication of entire sections of railroad track away from and for unitary shipment to an installation site, has not been within typical prior art practices.

With the foregoing in mind, it is a primary object of the present invention to overcome or substantially alleviate problems of the past related to time-intensive and labor-intensive pre-plating of railroad ties and pre-fabrication of sections of railroad track.

Another paramount objective is the provision of essentially automated novel systems and distinct methodologies for plating wooden railroad ties in a time efficient way, with little or inconsequential manual labor.

Another critical object is the automated production of sections of railroad track remote from and for shipment to an installation site.

A further significant object of the invention is the provision of systems and methods for automatically creating plated ties from drilled wooden ties, plates and spikes and the automatic creation of pre-fabricated sections of railroad track using the plated ties and also railroad rails, at one or more sites remote from and for shipment to one or more installation sites.

An additional object of value is the provision of clips by which the adjacent ties forming a part of a section of pre-fabricated railroad track are restrained from migrating to or fro in respect to the rails, both during transporting of the track section to the installation site, during installation and after installation as part of an operative railroad line.

Another paramount objective is to utilize robotics to aid in automatically assembling pre-plated wood railroad ties and to aid in automatically pre-fabricating sections of railroad track.

These and other objects and features of the present invention will be apparent from the following detailed description, taken with reference to the accompanying drawings.

### BRIEF DESCRIPTION OF THE DRAWINGS

FIG. 1 is a flow chart of a first embodiment according to the present invention, by which wooden railroad ties are automatically pre-plated and formed automatically into off-site sections of railroad track;

FIG. 2 is a flow chart of a second embodiment according to the present invention, by which wooden railroad ties are automatically plated and formed automatically into off-sites sections of railroad track;

FIGS. 3-5 are diagrammatic representations of the first embodiment by which a collection of wooden ties is delivered to a processing plant at the ingress site and thence into an entry station;

FIGS. 6-8 are diagrammatic representations of the second embodiment by which a collection of wooden ties is delivered to a processing plant at an ingress site and thence into an entry site;

FIGS. 9-11 are diagrammatic representations of the first embodiment by which rows of ties are displaced from the entry station to a drilling station and drilled in an upward direction for reception of plates;

FIGS. 12-14 are diagrammatic representations of the first embodiment with ties at a plating and spike installation station, which ties are first displaced from the drilling station to the plating and spike installation station where the plates are placed over the drilled holes at the bottom of the ties and held there as spikes are force-inserted through apertures in the plates into the drilled holes;

FIG. 15 is a diagrammatic representation of the first embodiment depicting a plated tie at a plated tie handling station, where the plated ties are inverted;

FIGS. 16 and 17 are diagrammatic perspectives of plated ties in space array, with the plates facing upward and receiving a pair of rails to create a section of track at a track pre-fabrication station;

FIG. 18-21 are perspectives of one preferred mode by which clips are inserted on both installed rails between all spaced ties at the track pre-fabrication station to prevent relative movement between the ties and the rails of a track section during transportation, during installation of the track section as part of a railroad line and as trains move over the track section after installation as part of an operating railroad line;

FIG. 18A is a block diagram showing the make-up of certain controls comprising an optical sensor and an activator;

FIG. 18B is a block diagram showing use of a master control to control a plurality of optical sensors;

FIG. 22 is a block diagram showing pre-fabricated track sections alternatively placed in storage or transported to an installation site to be part of a new or repaired railroad line;

FIG. 23 is perspective depicting the displacement of a bundle of ties from the ingress site to the entry station;

FIG. 24 is a fragmentary perspective depicting ties at the entry station and adjacent structure;

FIG. 25 is a perspective showing a bundle of ties at the entry station supported upon a scissor-lift, by which the bundle of ties are elevated one row at a time following displacement of the top row of ties from the entry station toward the drilling station;

FIG. 26 is an elevation showing the utilization of knurled rollers to displace ties from the entry station to the drilling station and by which the ties are spaced one from the next as they move into the drilling station;

FIG. 27 is an elevation, with a part broken away for clarity, showing how knurled rollers of FIG. 26 are displaced along their respective drive shafts causing the ties to separate one from another while retaining a parallel relation;

FIG. 28 is a plan view, with a part broken away for clarity, showing a fork structure used to displace the knurled rollers along their respective shafts causing the ties to remain parallel but spaced from each other as a row of ties move into the drilling station;

FIG. 29 is a perspective showing the knurled rollers having been displaced along their respective shafts to place the ties of a row of ties in parallel spaced relation;

FIG. 30 is a cross sectional view showing how knurled rollers of FIG. 29 are non-rotatably, but slideably mounted on their respective shafts;

FIG. 31 is a perspective depicting a row of ties in parallel space relation at the drilling station held firmly in position by fluid-operated cylinders to accommodate precise drilling of the ties at the tie drilling station;

FIG. 32 is a bottom perspective depicting the manner in which ties at the drilling station are drilled in an upward direction;

FIG. 33-35 are perspectives of structure by which a row of ties at the drilling station is caused to be correctly aligned and correctly positioned for accurate drilling;

FIG. 35A is a plan cross section illustrating structure for orientation of ties passing through a rotating barrel at a drilling station;

FIG. 36 is a fragmentary perspective view showing the use of stops and guides to correctly position a railroad tie at the drilling station;

FIG. 37 is an enlarged fragmentary perspective showing a stop at one end of a tie and side guides for correctly positioning a tie at the drilling station prior to drilling;

FIG. 38 is a fragmentary perspective showing the tie stop of FIG. 37 in an elevated position, allowing the tie to be displaced from right to left;

FIG. 39 is an enlarged fragmentary perspective showing a movable stop mechanism for engaging the trailing end of a tie at the drilling station so that the length of the tie is accurately positioned for drilling;

FIGS. 40-44 are perspectives showing manner in which plates are displaced from inventory to a plate and spike installation station;

FIGS. 44A and 45-50 are perspectives showing how spaced tie plates are processed to engage the bottom surface of a tie, in alignment with drill holes in the tie, at the plate and spike installation station;

FIG. 51 is a diagram showing the manner in which spikes are displaced to the plate and spike installation station;

FIGS. 52-61 are perspectives showing one manner in which spikes are received at the plate and spike installation station and are processed and inserted through apertures in tie plates at the bottom of a tie;

FIG. 55A is a fragmentary perspective of the manner in which spikes are processed by a slotted cylinder preparatory to installation in a tie;

FIGS. 62-65 are perspectives showing how ties are received at a tie inverting station and processed therethrough to provide rows of ties with plates directed upwardly;

FIGS. 65A-65D are diagrammatic presentations of the processing of ties at the tie inverting station;

FIG. 66 is a diagrammatic representation, of one way ties at a track pre-fabrication station may be processed to create track sections;

FIGS. 67-70 are fragmentary elevations showing one way plated ties at the track pre-fabrication station may be processed;

FIGS. 71 and 72 is a fragmentary perspective showing how rails may be placed on spaced plated ties at the track pre-fabrication station;

FIG. 73 is a fragmentary top plan view pertaining to side guides for accurate placement of rails on tie-mounted tie plates at the track pre-fabrication station;

FIG. 74 is a flow chart of still another embodiment of the present invention;

FIG. 75 shows the relationship between FIGS. 75A and 75B;

FIGS. 75A and 75B are diagrammatic representations of one way a track section may be pre-fabricated;

FIG. 76 is a perspective of one embodiment of a rail ingress station;

FIGS. 77 and 78 are fragmentary perspectives of a roller system at the rail ingress station of the rail ingress embodiment of FIG. 74;

FIG. 79 is a perspective of a tie bundle ingress station of the embodiment of FIG. 74;

FIG. 80 is a perspective of a tie bundle entry station of the embodiment of FIG. 74;

FIG. 81 is a fragmentary perspective of the tie conveyor system running from the tie bundle entry station through a tie drilling station and a tie inversion station to a drilled tie discharge station of the embodiment of FIG. 74;

FIG. 82 is a fragmentary perspective of the tie drilling station of the embodiment of FIG. 74;

FIG. 83 is a fragmentary perspective of the tie inversion station of the embodiment of FIG. 74;

FIG. 84 is a diagrammatic plan view of the tie transport system between the drilled tie discharge station and the tie, plate, spike and rail assembly station of the embodiment of FIG. 74;

FIG. 85 is a diagrammatic plan view of the tie plating, the tie spiking and the rail placement station of the embodiment of FIG. 74;

FIG. 86 is a diagrammatic elevational view showing the manner in which a plated tie at the plating and spiking station is elevated to contact two spaced rails preparatory to receiving spikes, of the embodiment of FIG. 74;

FIGS. 87 and 88 are diagrammatic plan views showing the manner in which spacing clips are added to the rails during prefabrication of a track of the embodiment of FIG. 74;

FIG. 89 is a perspective of one presently preferred clip according to the present invention;

FIG. 90 is a fragmentary perspective of a completed track section in accordance with the embodiment of FIG. 74;

FIG. 91 is a fragmentary perspective showing one configuration of two contiguous distal ties of a track section and, in exploded perspective, a joint bar and nut and bolt assemblies by which a joint bar is added to the distal end of a rail comprising part of a track section;

FIGS. 92-94 are perspectives illustrating a further presently preferred plate delivery system useable when forming a track section; and

FIGS. 95-96 are perspectives illustrating a further presently preferred spike delivery system useable when forming a track section.

### DETAILED DESCRIPTION OF THE ILLUSTRATED EMBODIMENTS

In respect to terminology, the outside lower flange of each rail is called a field flange, while the inside lower flange of each rail is called a gauge flange. Likewise, the part of each plate outside each rail of a railroad track is called the field part and the apertures therein are called field apertures. The part of each plate inside each rail of a railroad track is called the gauge part and the apertures therein are called gauge apertures. Spikes driven through the field apertures of any plate are called field spikes. Spikes driven through the gauge aperture of any plate are called gauge spikes. The central part of each plate, which receives a rail is sloped downward slightly at its upper surface toward the gauge side of the plate.

This specification contains numerous references to cylinder assemblies comprising an external cylinder, an internal piston and an exposed reciprocal piston rod connected at one end to the piston and exposed at the other end beyond the cylinder. This cylinder assembly technology is well known and, therefore, need not be described herein in detail. Unless otherwise stated, all cylinder assemblies mentioned herein are two way assemblies pneumatically operated using two ports on the cylinder.

This specification refers to spaced stations or sites, where ties are drilled, plates are made contiguous with the ties and spikes are inserted through apertures in the plates into drill holes in the ties. For ease of presentation, certain mechanisms are shown in the singular, but it should be understood that a plurality of such mechanisms can and preferably sometimes are used either simultaneously or consecutively to increase the rate at which plated ties and pre-fabricated sections of railroad track are assembled.

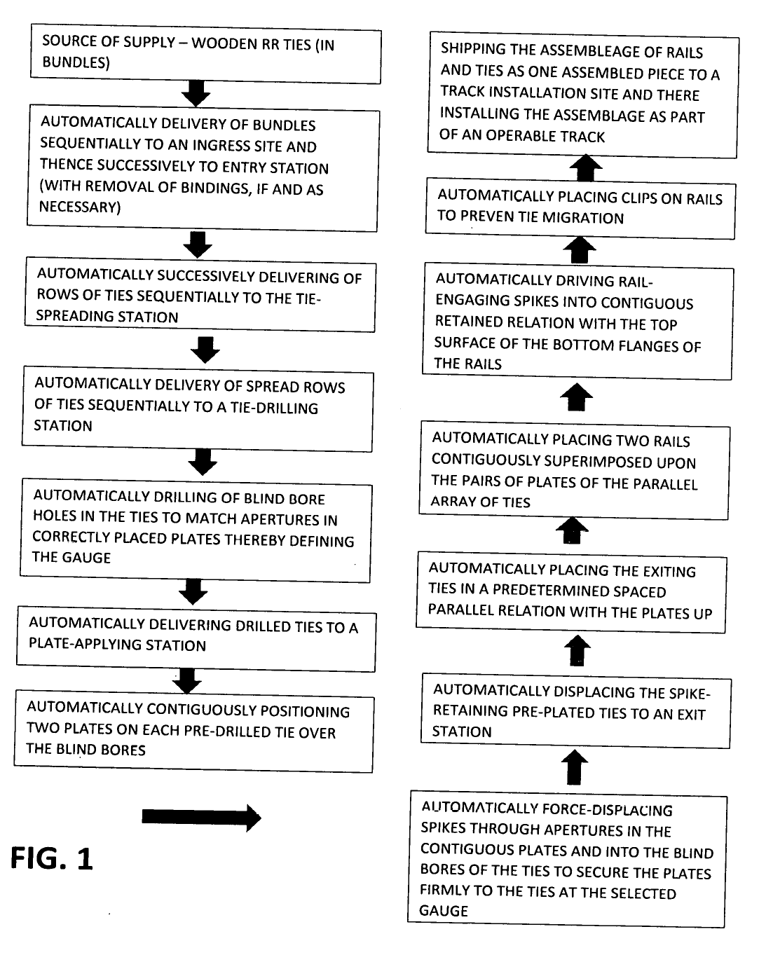

Reference is now specifically made to the drawings, wherein like numerals are used to designate like parts throughout. In respect to the disclosed embodiments, it is presently preferred that computer-controlled robots comprise mechanisms which command some of the automated processes and equipment by which ties are pre-plated and sections of railroad track are prefabricated. FIG. 1 is a flow chart which illustrates one form of methodology, which embodies principles in accordance with the present invention, by which wooden railroad ties are pre-plated and the plated ties are assembled with rails, remote from an installation site, as a prefabricated section of railroad track (a panel) in advance of use in initially constructing or repairing a railroad line.

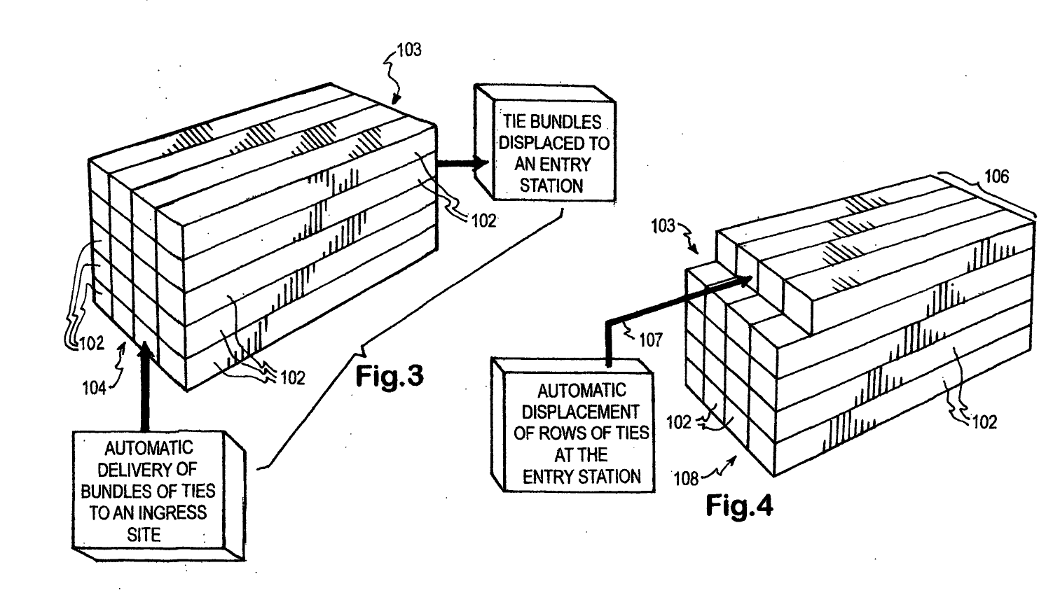

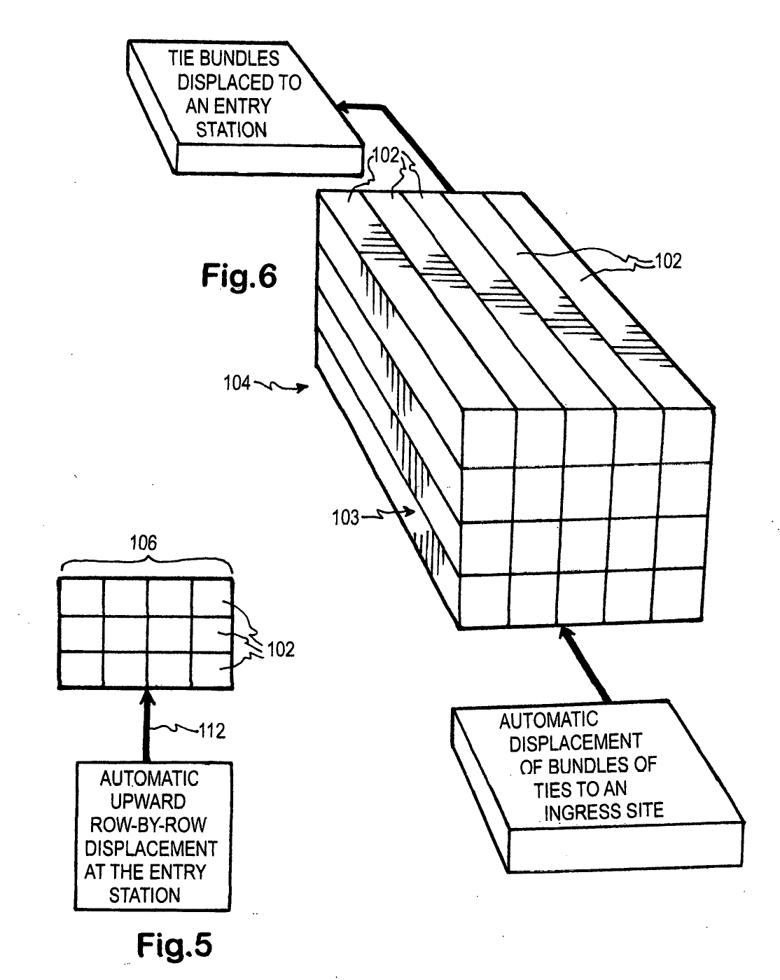

In respect to FIG. 1, inventories of wooden railroad ties, steel railroad plates, steel railroad spikes and joint bars are positioned adjacent to the assembly site. A stack or bundle 103 of railroad ties from a source of supply of ties 102 is positioned at an ingress site 104. FIG. 3. End cleats are typically placed at both ends of each tie to alleviate splitting. It is typical for wooden ties to be impregnated with creosote. Automatically each successive tie bundle 103 is displaced from the ingress site into an entry station. FIGS. 4 and 6. Successive rows 106 sequentially brought to the top of one bundle of ties 102 are advanced horizontally by a force 107 from the stack or bundle 103 of ties 102 at the entry station. The stack or bundle 103 of ties 102 at the entry station is periodically lifted vertically by force 112 (FIG. 8), so that the next top row 106 of ties 102 at the entry station becomes horizontally aligned at entry station with the previously advanced top row. FIG. 5. Thus, in respect to FIGS. 3-5, to commence the pre-plating process, successive bundles 103 of ties 102 are displaced from the ingress site into the entry station and thence forward from the entry station as successive top rows 106 of ties 102 so that the ties 102 of each displaced row 106 are parallel to the process path, with the ties initially in contiguous side-by-side relation.

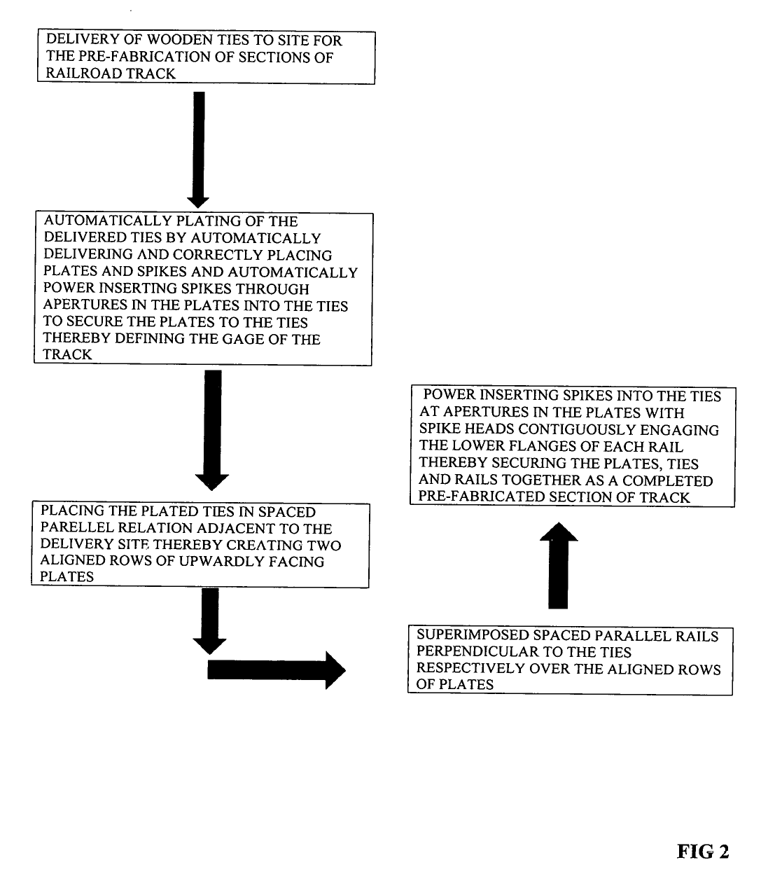

FIG. 2 is another flow chart which illustrates a second type of methodology, which embodies principles in accordance with the present invention, by which wooden railroad ties 102 are pre-plated and the plated ties are assembled with two rails remote from an installation site, as a prefabricated section of railroad track, in advance of use in initially constructing or repairing a railroad line. In respect to FIG. 2, inventories of wooden railroad ties, steel railroad plates and steel railroad spikes are positioned adjacent to the assembly site.

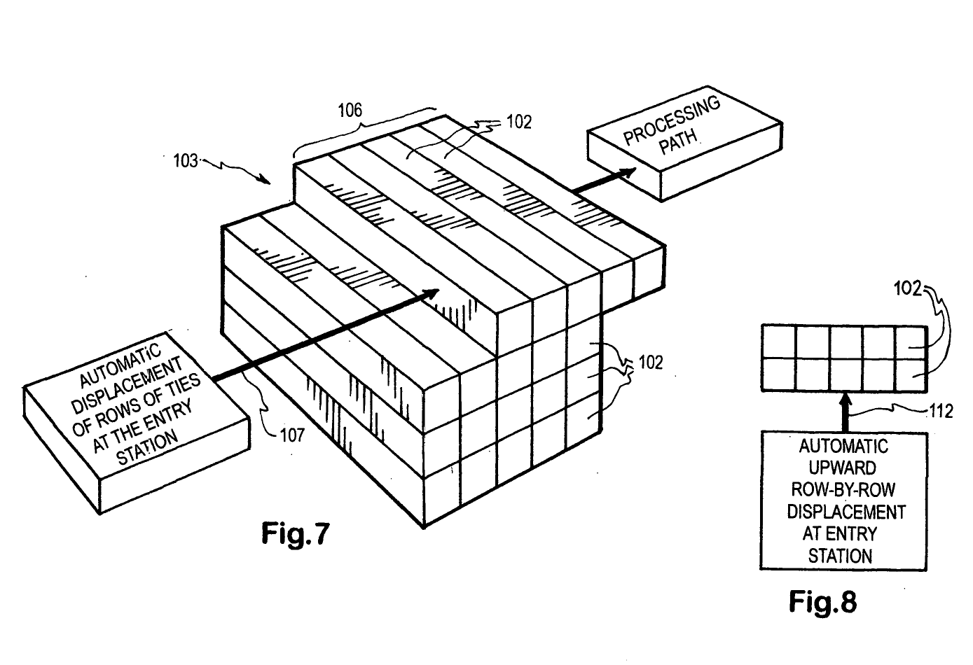

Referring still to the embodiment of FIG. 2, a stack or bundle 103 of railroad ties 102 from a source of supply of ties 102 is positioned at an ingress site 104, and advanced perpendicular to the processing path into the entry station. FIG. 6. Automatically and sequentially, perpendicular rows 106 of contiguous side-by-side wooden railroad ties 102 are displaced to a tie separation station 114 from the entry station 108. FIGS. 7, 9 and 10. After one row 106 of ties 102 has been fully displaced horizontally by a force 107 from the stack or bundle 103 of ties 102 at the entry station, the stack of ties is automatically lifted vertically by force 112, so that the next top row of ties 102 is horizontally aligned at the entry station with the previously advanced top row of ties at the tie separation station 114. FIGS. 8 and 10. Thus, further in respect to the first embodiment of FIGS. 2 and 6-8, to commence the pre-plating process, a bundle 103 of ties 102 is placed in a perpendicular orientation to the processing path, at the entry station, with the ties 102 in contiguous side-by-side relation. FIG. 7.

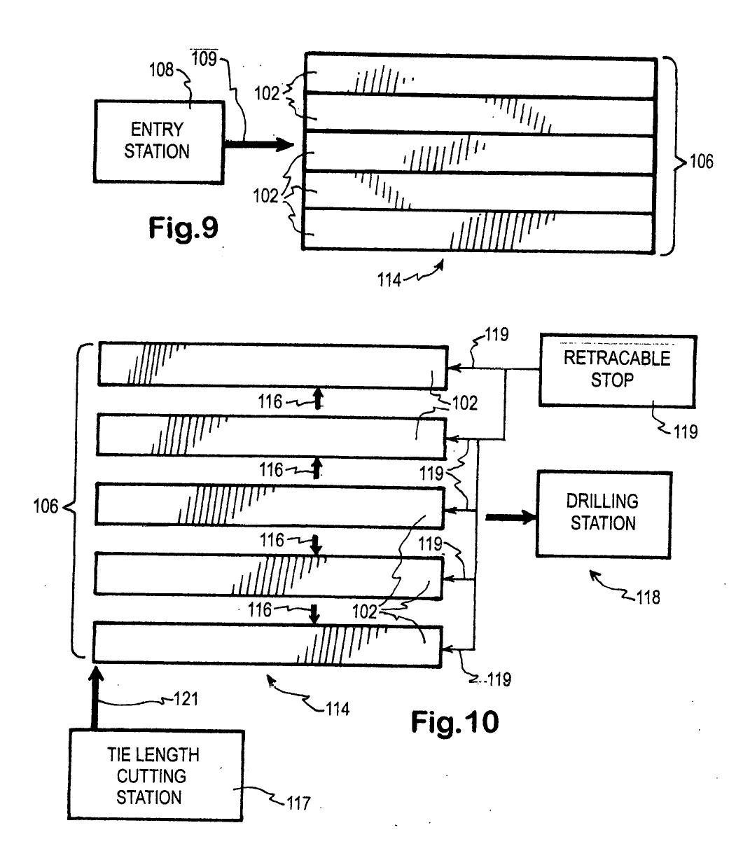

In reference again to FIGS. 3-5 and to FIGS. 9-22, sequential bundles 103 of ties 102, which are delivered to ingress site and thence to the entry station, are positioned so that the length of the ties are parallel to the processing path of the ties through the drilling, plating and spike insertion process.

Each stack or bundle 103 of ties 102 comprise horizontal rows and vertical columns of ties arranged as shown in FIGS. 3 and 4, with straps or bands, if any, removed. Standard tie lengths are typically 8 feet, 9 feet and 10 feet, depending on intended future use. Also, ties with smaller dimensions are sometimes used on tracks in underground mines.

With a stack 103 of ties 102 placed at the entry station, as shown in FIG. 4, the top row 106 of ties 102 is horizontally displaced from the stack 103 by force 107 from the entry station toward a tie separation station, and, thereafter, successive rows 106 of ties 102 are also so displaced, automatically as each bundle 102 is incrementally lifted row-by-row into position by force 112. FIG. 5. The initial position of the one row 106 approaching the tie separation station is shown in FIG. 9, with the ties 102 of the one row 106 being in contiguous side-by-side relation and with the ties 102 extending parallel to the process path.

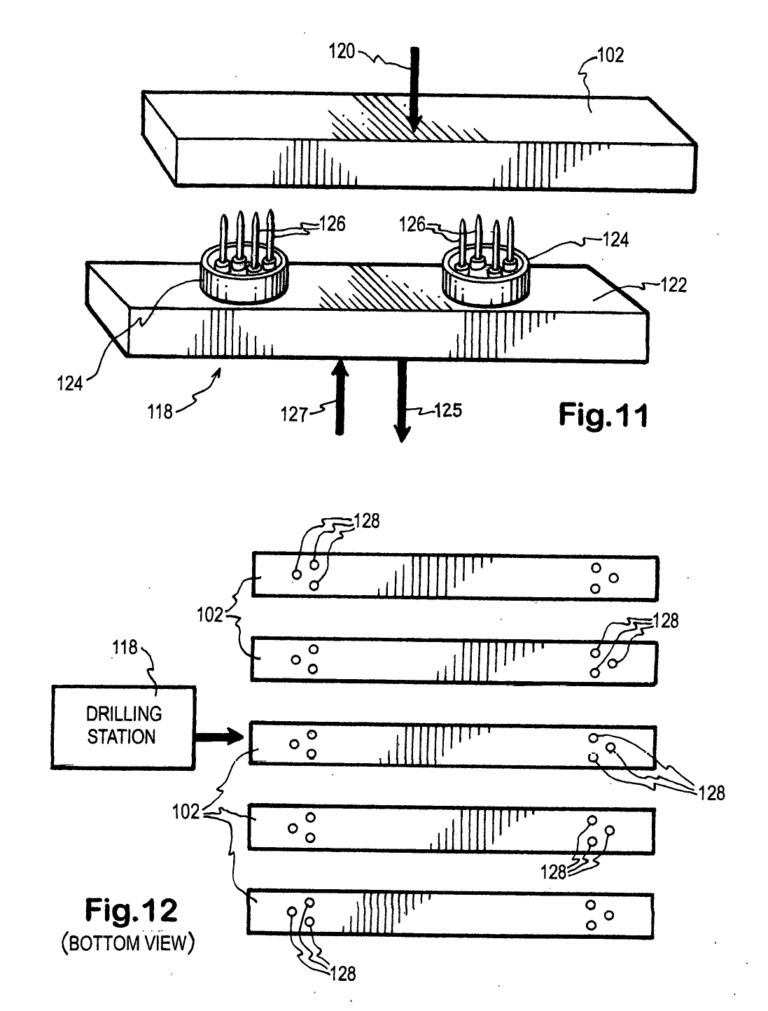

As a row 103 of ties 102 approaches the tie separation station 114, the ties 102 are caused to become automatically essentially uniformly spaced, by forces 116, one from the next so that a spaced and a parallel relationship between the ties 102 (FIG. 10) is created to match the predetermined spaced location of sets of drill heads 124 (FIG. 11). Thus, as shown in FIG. 10, the ties 102 of the one row 106 arriving at a drilling station 118, are in parallel equally space relation, or, in the alternative, are placed in that position at the drilling station 118. Prior to or at the drilling station 118, in circumstances where the ties 102 are not of a predetermined fixed length, the forward ends of the ties are restrained by forces 119, which may comprise one or more retractable stops. FIG. 10. With the front edges of the ties 102 in parallel relation engaging stops 119, a suitable cutting instrument 117 may be used to cut via force 121 each tie 102 of excessive length to a length equal to the desired predetermined length.

With the ties 102 arranged as shown in FIG. 10 at the drilling station 118, drilling occurs as diagrammatically depicted in FIG. 11, only one tie and two sets of drill holes being depicted for ease of illustration. For each tie 102 in the one row 106 at station 118, one or more restraining forces 120 are applied to hold the ties in a stationary, correctly-disposed position. A drilling mount 122 is displaced automatically upwardly by force 127, with drill bits 126 arranged in a pattern and contained in drill heads 124 which selectively rotate the drill bits 126 automatically drilling holes 128 (FIG. 12), which may be blind bores, into each 102 tie to a desired depth at all locations consistent with the locations required for accurate plate placement. It should be noted that the vertical movement of the drilling mount 122, the drill heads 124 and the rotating drill bits 126 is first in an upward direction, under force 127, until the hole drilling is completed, at which time the drill mount 122, the drill heads 124 and the drills bits 126 are collectively retracted by force 125 to the position illustrated in FIG. 11 and drill bit rotation ceases. Thus, the drilling of each tie 102 is in an upward direction and the pattern of holes 128 so created are at the underside of the ties 102. See FIG. 12, which is a bottom view looking up at the drilled ties 102 of the row 106, with the ties 102 in space relation and the drilled ties 102 ready to be displaced from the drilling station 118 to a plating station 129.

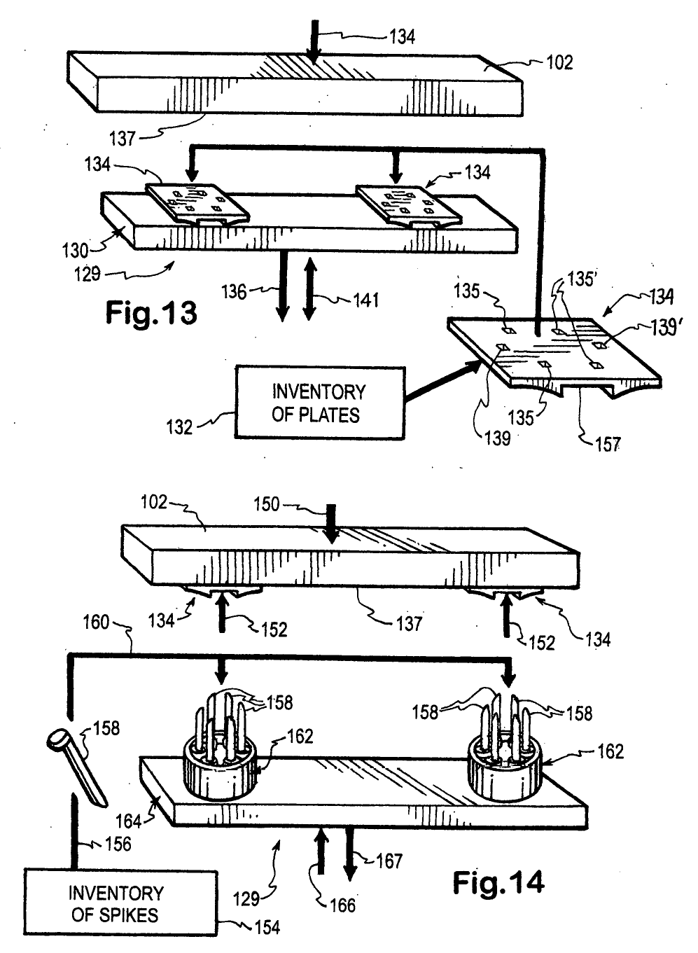

Reference is now made to FIG. 13, which illustrates the manner in which tie plates 134 are processed at the plating station 129 for accurately locating the plates 134 and for inserting spikes 134 through apertures of the plates 134, which plates 134 are at the underside of the ties 102 of the row 106. Only one tie 102 is illustrated in FIG. 13 for ease of presentation. A plate holding mount 130 is provided for each tie 102. Sequential tie plates 134 are automatically processed from an inventory 132 of plates 134 along predetermined paths 135 to the correct gauge locations on the mount 130. The placement on each mount 130 of the two plates 134 is in alignment with the drill holes previously made in the adjacent tie 102, so that the apertures 135, 135′, 139 and 139′ in each tie plate 134 are disposed directly below and in accurate alignment with the two sets of drill holes 128 on the underside of the tie 102. The mount 130 is elevated by force 141 bringing the two tie plates 134 on each mount 130 for each tie 102 into contiguous relation with the underside 137 of each drilled tie 102, to be there retained by forces 152 (FIG. 14). Each plate 134 comprises field and gauge apertures 139 and 139′ and field and gauge apertures 135 and 135′. The mount 130 is later lowered to the position of FIG. 13 by force 136, after insertion of spikes.

The two plates 134 are positioned as illustrated in FIG. 14 and are held in that position by forces 152 so that the apertures 135, 135′, 139 and 139′ in the tie plates 134 are in vertical alignment with the drill holes 128 on the underside 137 of the ties 102. A series of railroad spikes 158 are automatically dispatched from inventory 154 along conveyor pathways 156 and 160 and automatically placed, respectively, in spike holders 162, with the pointed ends of each spike 158 extending upwardly. While six spikes 158 are illustrated in each holder 162, fewer spikes such as three, may be used. The spikes 158 in each holder 162 are arranged so that the tips of the spikes are vertically aligned with the apertures 133, 133′, 139 and 139′ in the adjacent plate 134, which in turn are aligned with the drill holes 128 at the underside of the ties 102. With the plates 134 held by forces 152 correctly on the lower surface of each tie 102 of the row 106, a pressure plate 164, upon which the holders 162 are accurately positioned, at station 129, is elevated by force 166, causing the spikes 158 of each holder 162 to be extended through the aligned apertures in the two plates 134 and into the drill holes 128 in the tie 102. The spike displacement continues until the spikes 158 which solely hold the plates 134 to the ties at plate apertures 139 and 139′ are fully press-fit into the aligned drill holes 128, with the spike heads 161 retained firmly contiguous with each plate 134. The rail-retaining spikes 158, with the heads 161 thereof correctly oriented toward the central channel 157, are only partially inserted into their respective drill holes 128, leaving room for rails 200 to be inserted generally horizontally along the central channels 157 of aligned plates 134 under the heads 161 of the partially inserted spikes 158 which will ultimately hold the rails 200 in place. Thereafter, the pressure-applying mount 164 is retracted by force 167 (FIG. 14) to its at rest position. In this way, all of the ties 102 of row 106 have two plates 134 secured thereto in proper gauge-defining locations at the lower surface of each tie 102.

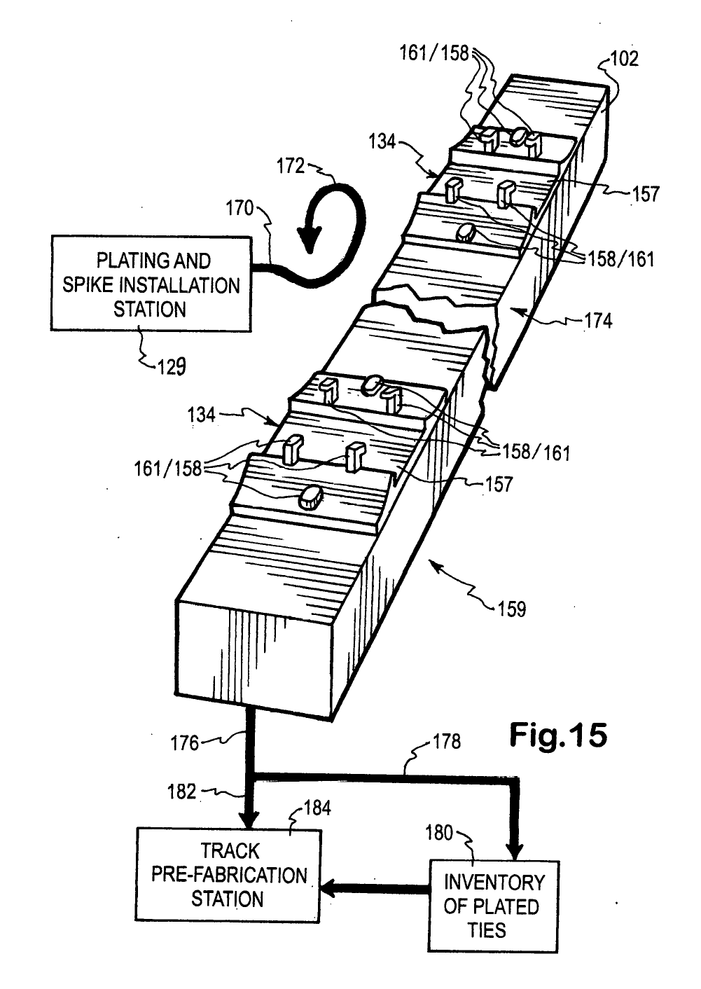

The plated ties 102/134 are, thereafter, displaced, as shown by displacement path 170 in FIG. 15 from the plating and spike installation station 129 to tie inverting and discharge station 159, where each plated tie is automatically inverted, as shown by displacement path 172, leaving each plated tie 102/134 positioned as shown in FIG. 15, with the plates 134 and spikes 158 facing up. Thereafter, the inverted plated ties 102/134 are displaced along a path 176 and, thereafter, along path 178 and/or path 182 to be placed in inventory 180 or immediately delivered to a track pre-fabrication station 184.

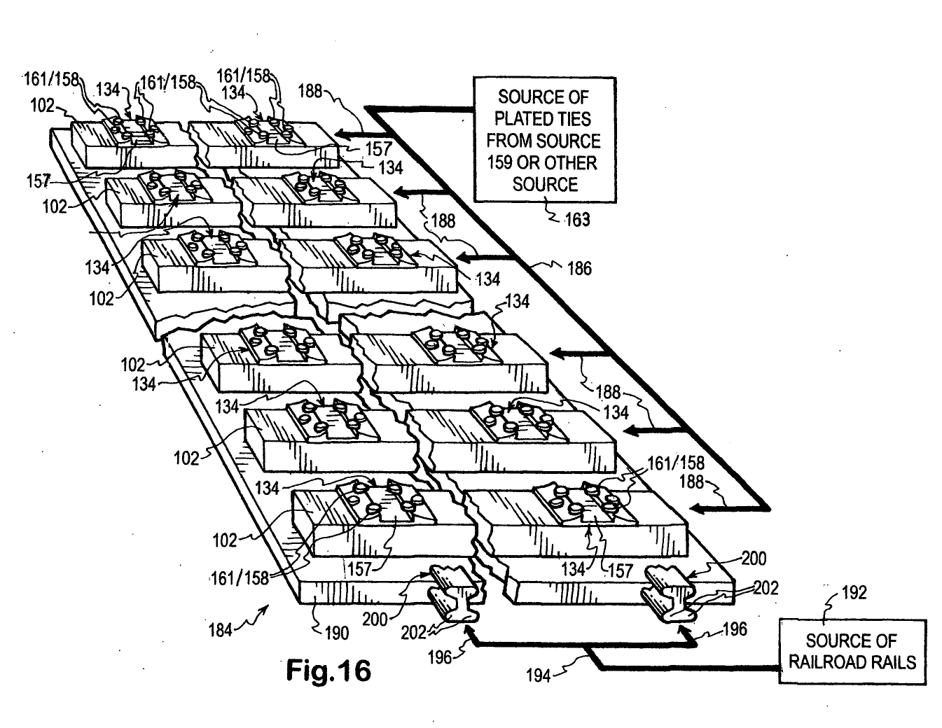

Reference is now made to FIG. 16, which exemplifies one way, in accordance with principles of the present invention, that a section of railroad track is prefabricated at a location remote from the ultimate installation site, whether the installation site comprises a new railroad line or one being repaired. Plated ties 102/134 are delivered from a source 163, which may comprise source 159 and/or one or more other sources, including a source from which plated ties have been constructed in less than a fully automated fashion. The plated ties 102/134 from source 163 are automatically delivered along paths 186 and 188 to accurately spaced locations on a horizontal support 190 at track pre-fabrication station 184. The spacing of the ties shown in FIG. 16 is consistent with the spacing of ties on installed and operating railroad lines. For example, the spacing between ties may be between eight and sixteen inches surface-to-surface, depending on anticipated loads. It is common for the center-to-center tie spacing to be 20 inches. The two plates 134 on each tie 102 are, respectively, precisely aligned with the two rows of plates 134 on all of the other ties 102, so that the two sets of plates form two linear patterns.

Two rails 200, each comprising two oppositely-directed lower flanges 202, are automatically delivered from a source of railroad rails 192 along paths 194 and 196, so as to be aligned with the two linearly aligned sets of plates 134 secured to ties 102 at support 190. The two railroad rails 200 are automatically displaced, as depicted by paths 196, so as so slide under the somewhat elevated heads 161 of the rail-retaining spikes 158 and along the central channels 157 of the aligned sets of plates 134 until the rails 200 rest appropriately on the upper surface of central portions 157 of the associated series of plates 134. It should be understood that one end of each rail may typically extend a given distance beyond the distal tie of the track section, with the other proximal end being located at the midpoint of the proximal tie of the track section, to accommodate installation on a railroad line of successive rail track sections.

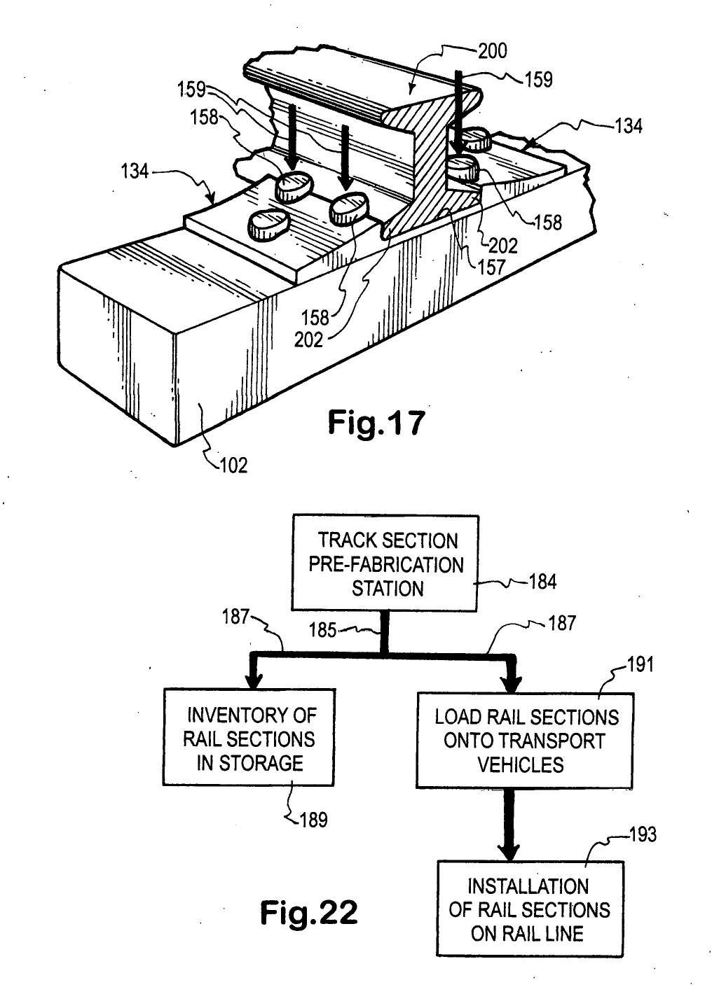

When the rails 200 are in the fully inserted accurate position, the partially inserted rail-retaining spikes 158, directly adjacent to the rails 102, with the eccentric heads 161 above and overlapping the lower flanges 202 of the rails 200 are fully force-inserted into the ties 102. These spikes 158 are automatically forced downward so that the eccentric heads 161 of these spikes 158 become firmly and retainingly contiguous with the adjacent lower flanges 202 of the rails 200, thereby unifying the rails, the plates and the ties. FIG. 17. In some embodiments of the invention, only one plate-retaining spike 158 is inserted against the plate 134 and one rail-engaging spike 158 is inserted against one lower flange 202 of each rail 200, as determined by those skilled in the art.

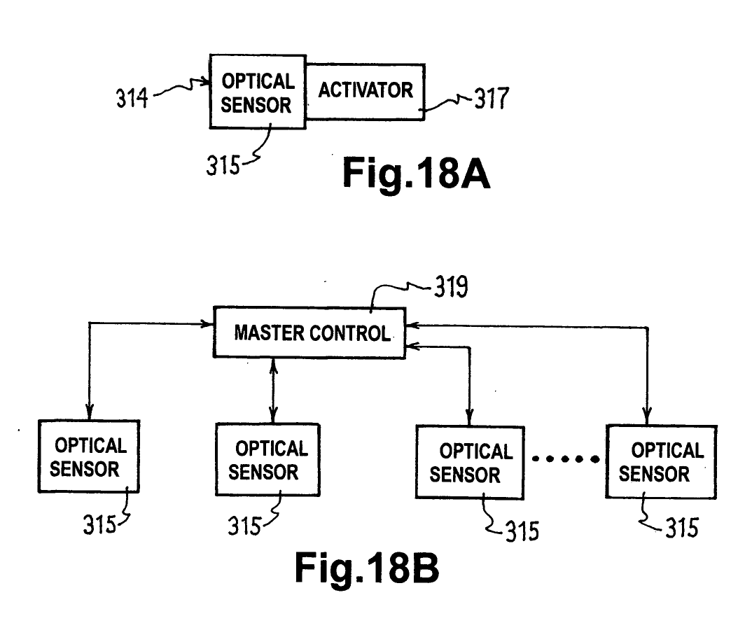

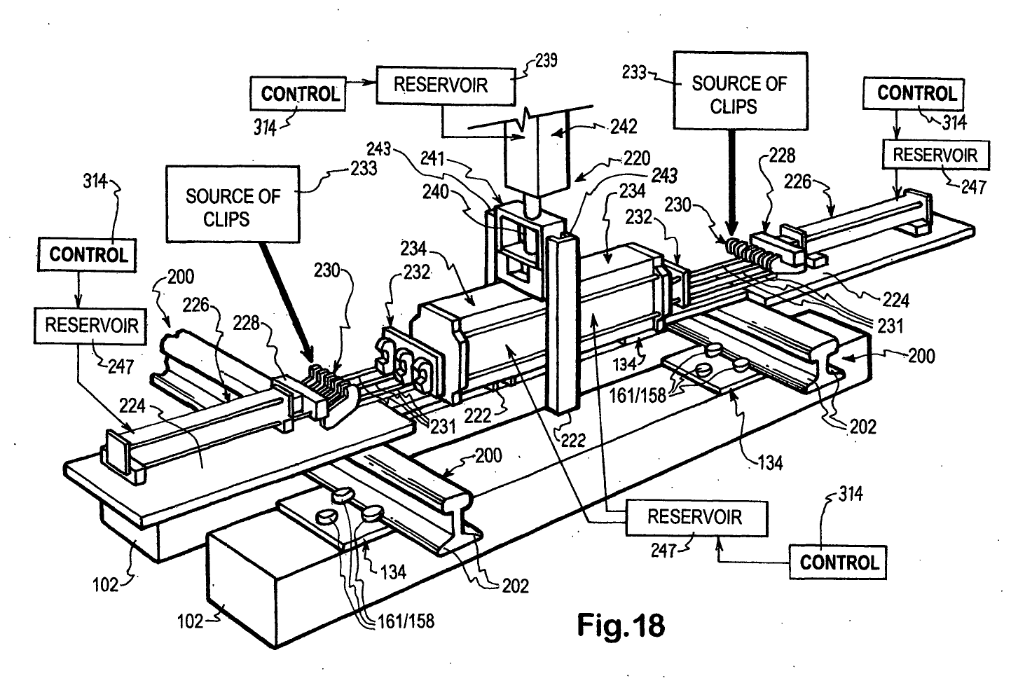

To assure that there is no relative movement between the rails 200 and the ties 102 after they are assembled together, and the rail-retaining spikes 158 are inserted and retained stationarily contiguous with the lower flanges 202 of the rails 200, space-retaining clips or anchors 230 are forced-fit onto the lower flanges 202 of both rails 200, so as to hold firm the entire space between all adjacent ties forming part of the track section. FIGS. 18-21. Presently, two clips 230 are placed between each successive ties 102 at each rail 200. The clips 230 also are automatically supplied from one or more sources 233. FIG. 18.

A cylinder/piston-carrying jig, generally designated 220, is automatically lowered into the position of FIG. 18 so as to be supported upon spaced central legs 222, resting centrally on two successive ties 102. Platforms 224 rest on top of each rail at horizontal platforms 224. This lowering is done by fluid displacement from reservoir 239 to cylinder 242, under command of control 314. FIG. 18. The base of cylinder 242 is rigidly anchored to the frame 300. The jig 220 comprise five cylinder/piston rod displacement mechanisms. The cylinder/piston rod mechanisms may be driven hydraulically or pneumatically in accordance with well-known practices in the art and, therefore, such requires no further description here. The piston rod 240 extending from cylinder 242 reciprocates vertically and the piston rods 225 and 244 of the other four cylinders 226 and 234 reciprocate horizontally by reason of fluid flow from reservoirs 239 and 247, under command of the control 314. FIG. 18. The exposed distal end of the piston rod 240 is connected to an alignment head 241, sized and shaped to slidably engage opposed U-shaped guides 243, comprising the interior of legs 222, thereby limiting the reciprocation of piston rod 240 to vertical displacement. As piston rod 240 is vertically extended downwardly, the two cylinders 234 are likewise linearly displaced downwardly the same distance by displacement of piston rod 240. The two cylinders 226 are stationary, except for horizontal displacement of their associated piston rods.

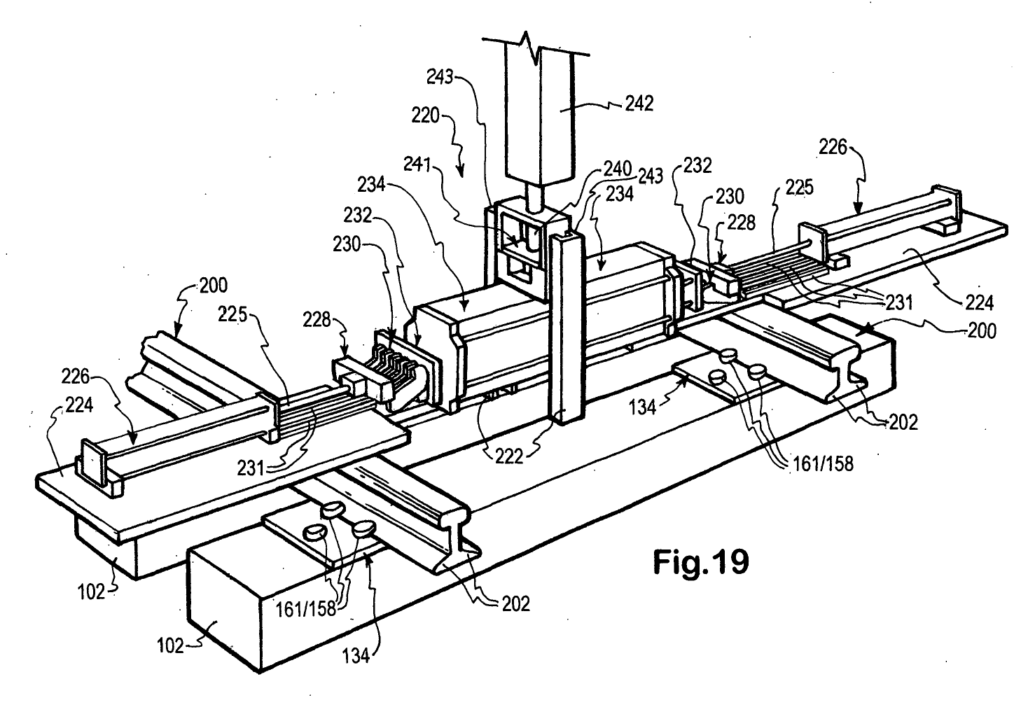

The piston rods 225 extending from cylinders 226 (FIG. 21), each carry a displaceable abutment or ram 228, which temporarily engages and displaces parallel dog-legged-shaped holders 230, each having upwardly-directed rail-retaining lobes. FIG. 19. The clips 230 are disposed in perpendicular relation to the rails 200, when in holders 230.

The abutments or rams 228 are respectively connected to the distal ends of the exposed oppositely-directed piston rods 225 of the associated cylinders 226. Each group of clips 230 is automatically loaded against the abutments or rams 228, so that each clip 230 is initially directly above each of the associated rail 200. FIG. 18. The abutments 228 are then automatically displaced inwardly of the rails 200 by extension of the piston rods 225 toward the center of the jig 220 along parallel guide flanges 231, which define a horizontal path. Compare FIGS. 18 and 19. At this point, the group of clips 230 are respectively transferred to two cradles 232 secured respectively to the piston rods 244 of cylinders 234.

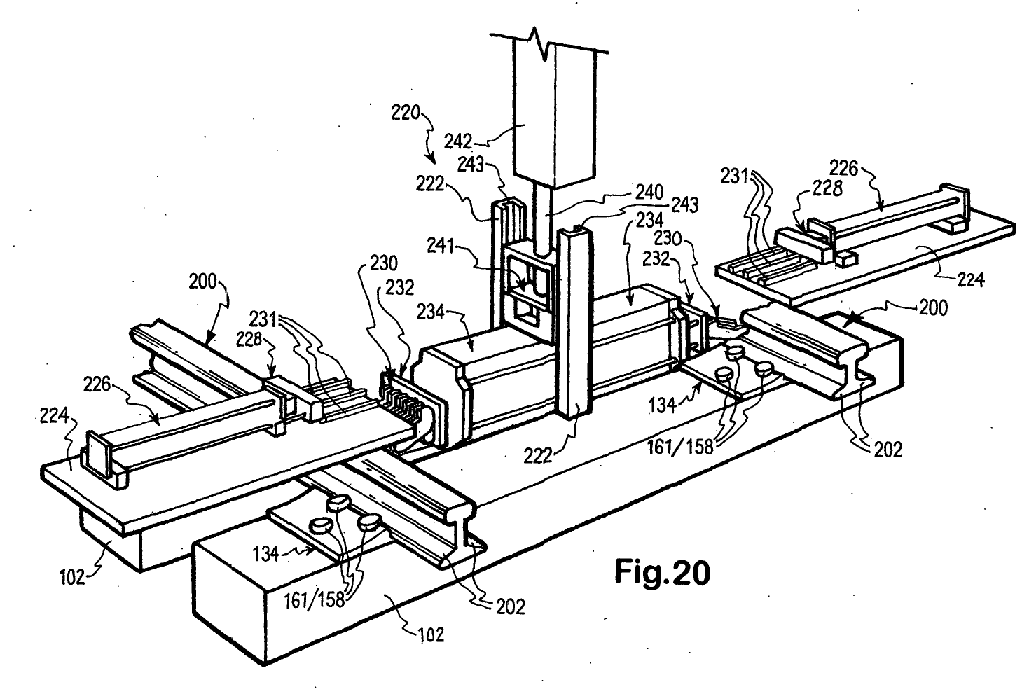

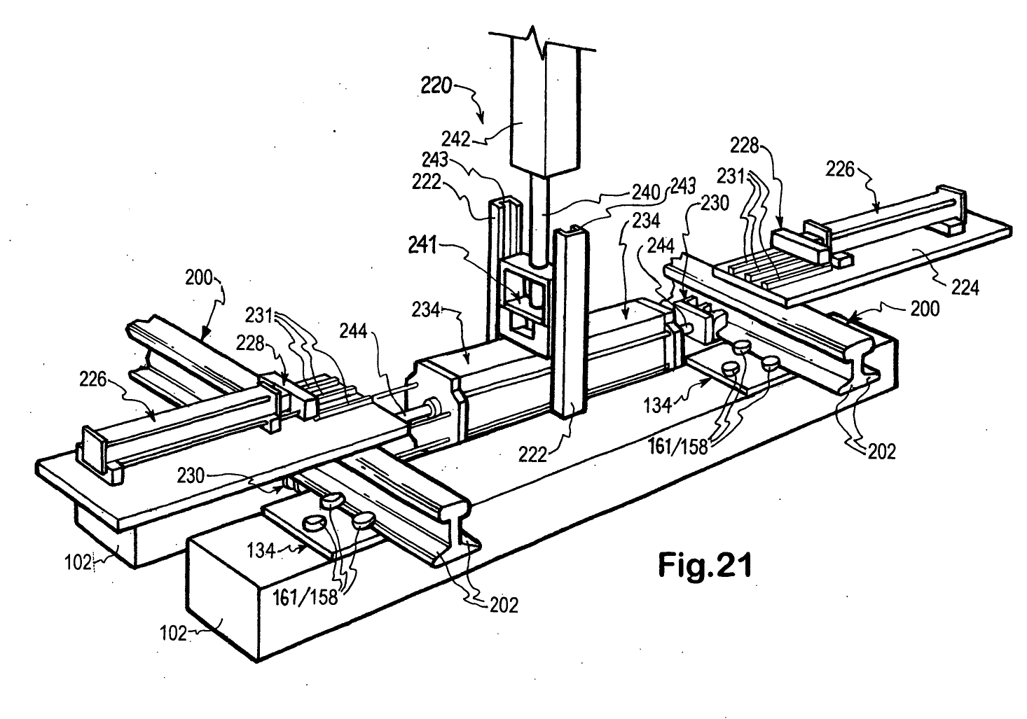

Thereafter, the cradles 232, each carrying a group of clips 230, are lowered, along with the cylinders 234 and piston rods 244, by downward extension of vertical piston rod 240 of the central vertical cylinder 242 from the position of FIG. 19 to the position of FIG. 20. The clips 230 and the cradles 232 are thus placed at a lower elevation to allow outward, essentially horizontal movement thereof perpendicular to and under the rails 200 for installation of the clips 230 on the lower flanges 202 of the rails 200. This is done by extension of piston rods 244 from opposed cylinders 234. FIG. 21.

As the piston rods 244 are extended, the cradles 232 and the clips 230 are displaced toward and under the spaced rails 200. When the clips 230 pass under the rails, the interior and exterior lobes thereof, both of which face upward, are force-fit or snapped over the lower field and gauge flanges 202 of both rails 200, to be there securely retained as stationary spacers holding the rails and the ties immovably together, with the ties spaced precisely as required for the track section as part of an operating rail line.

Next, the piston rods 244 are retracted into the cylinders 234 and the empty carriers 232 and cylinder-piston rod assemblies 234/244 are elevated to their positions of FIG. 18 by retraction of piston rod 240 into cylinder 242. While each group of clips 230 is illustrated as comprising six clips 230, as few as two may be used. With clips inserted on rail flanges 202 and the jig 220 elevated, the rails 220 and the clipped ties may be advanced to repeat the clip installation process, in the manner explained below.

With reference to FIG. 22, once a track section has been fully pre-fabricated at station 184, it is, in the alternative, automatically displaced to an inventory site 189 or immediately loaded onto a transport vehicle, such as a tractor-trailer rig with a flat hauling trailer or a railroad flat car, at loading station 191. Thereafter, the hauling vehicle travels to an installation site 193, where the track section is installed as part of a new or repaired railroad line. It is to be understood that typically a group of completed track sections will be sequentially placed either in inventory 189 or placed in groups in or on one or more transport vehicles for delivery to the installation site 193.

Reference is now made to the second embodiment of the present invention, the processing steps which are illustrated in FIGS. 6, 7 and 8, heretofore described. The essential differences between the first and second embodiments of the present invention, as disclosed herein, is twofold. First, in the second embodiment, the ties are processed perpendicular to the processing path, rather than parallel thereto. Second, in the second embodiment, the drilling, plate placement and spike insertion is from above the ties, rather than below. Top drilling, plate placement and spike insertion may also be used with ties parallel to the processing path. One skilled in the art comprehends from FIGS. 9-15 how, in the second embodiment, ties are plated and delivered to either inventory 189 or to the track prefabrication station 184 and thence to storage 189 and/or an installation site 193 (FIG. 22) after a track section has been assembled.

It is to be understood that utilization of a support frame, generally designated 300, is presently preferred, upon which the structures for processing railroad ties and prefabricated sections of railroad track are supported. It is expected that standard structural members of steel, aluminum or composite materials will be used and such will also use connectors so as to provide a rigid framework of a well-known commercial nature upon which the tie processing equipment is supported. Because the frame 300 may take any number of forms and shapes, which are conventional, no extended explanation thereof for purposes of this description is necessary, it being well within the skill of those in the art to construct a framework 300 of suitable size, shape and makeup.

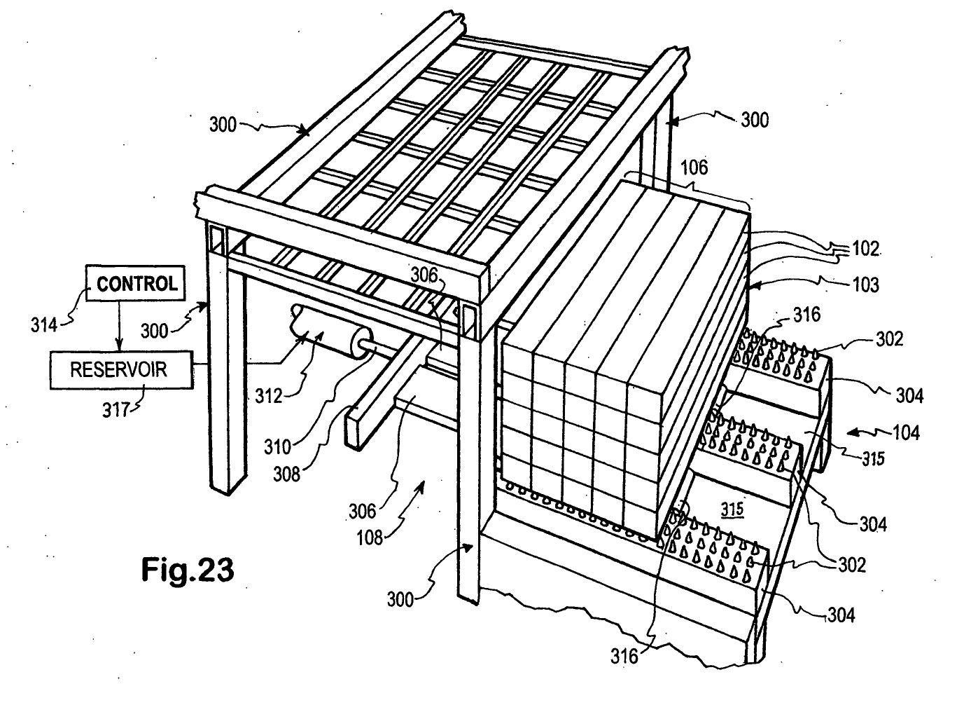

Reference is now made to FIGS. 23-31 to provide further detailed information in respect to the first embodiment of the present invention. A bundle 103 of ties 102 is delivered to the ingress site 104, preferable by use of a forklift in a conventional fashion. In the alternative, a conveyor system may be used to place the bundle 103 of ties 102 at the ingress site 104. Initially, the bundle 103 of ties 102 rests upon knurled or serrated surfaces 302 at the ingress site 104, carried on the top of three spaced beams 304. FIG. 23.

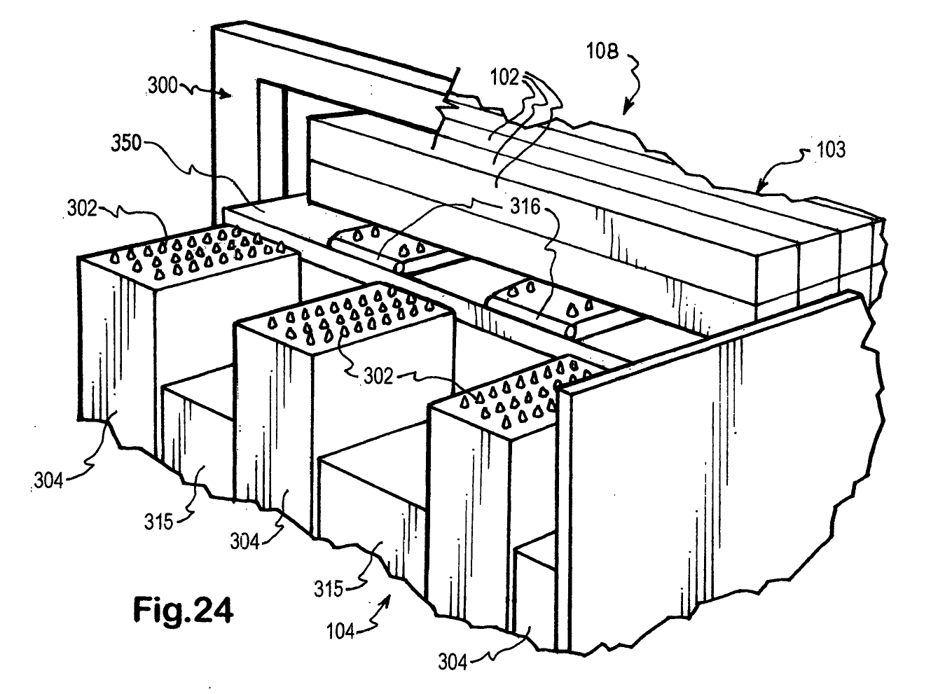

Two narrow flat trays 306, rigidly mounted to a crossbar 308, are displaced by extension and retraction of piston rod 310 from cylinder 312, under command of the control 314. The distal end of the piston rod 310 is rigidly connected to the crossbar 308. The trays 306 carry, at the distal end of each, an idler roller 316 which, as the piston rod 310 is extended and displaces the trays 306 from left to right, adjacent to the serrations 302, as viewed in FIG. 23, the idler rollers 316 roll under the lowest row 106 of the ties 102 and slightly lift the bundle 103. The idler rollers 316 come to rest just beyond the outside tie 102 of the lowest row 106, as illustrated in FIG. 23. This causes the rollers 316 and the trays 306 to slightly lift the entire bundle 103 including the lowest row 106 of ties 102 so as to be free of the serrations 302. At this point, control 314 caused the cylinder 312 to receive fluid from reservoir 317 so that the piston rod 310 is retracted into the cylinder 312, pulling the entire bundle of ties 103 on the trays 316 into the entry station 108. FIG. 24.

With reference to FIG. 24, the bundle 103 of ties 102 is illustrated, in fragmentary perspective, as being fully disposed at the entry station 108. Also shown in FIG. 24 are spacers 315 interposed between the three beams 304, for structural stability.

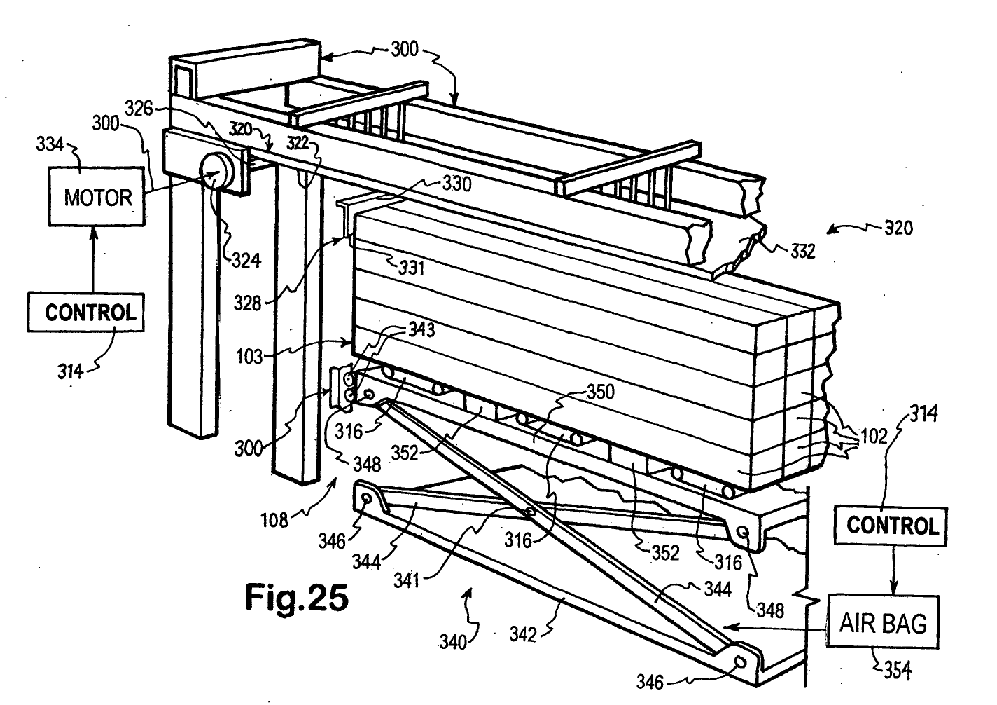

Above the bundle 103 of ties 102 at the entry station 108 is a horizontally displaceable revolving conveyor, general designated 320, which comprises a belt 332. FIG. 25. The belt 332 is power-driven around two pairs of spaced front and rear pulley or sprocket assemblies 324, each carried non-rotably on two spaced shafts 326, one of which comprises a power-driven drive shaft. Mounted on and transverse of and below the conveyor belt 322, as viewed in FIG. 25, is an angle iron 328 rigidly connected at its top horizontal flange 330 to the conveyor belt 322, leaving its second flange 331 extending vertically downward. The dimensions and orientation of flange 331 are such that the flange 331 will engage the proximal ends of the ties 102 comprising the top row 106 of ties 102 at the top of the bundle 103, and bulldoze-displace that row 106 of ties 102 from the entry station 108 toward the tie separation station 114, hereinafter more fully described. The angle-iron 330 moves from left to right to engage the proximal ends of the top row 106 of ties 102 as the lower leg of the conveyor belt 332 moves from left to right, as viewed in FIG. 25. When the belt 332 continues to be power rotated counterclockwise, the angle-iron 328 continues to move from left to right until the row 106 of ties 102 exits the station 108, and then from right to left along the top of a conveyor. The power drive shaft 326 is rotated by motor 334, under command from the control 314.

As shown in FIG. 25, a commercially available scissor-lift, generally designated 340, is positioned in a collapsed position directly beneath the bundle 103 of ties 102 at entry station 108. The scissor lift 340 may, at its base, rest upon any suitable ground or floor-engaging surface upon which lower support 342 is caused to rest. The crossing scissor struts 344 at the lower ends thereof are pivotably joined to base member 342 at pin connectors 346 and at upper pivot ends thereof at pin connections 348 to the structural top member 350 of the scissor lift 340. The two struts 344 are pivotably connected at pin 341. Disposed contiguously above the top support 350 are two transverse tie bundle-supporting beams 352.

The scissor lift 340 is displaced up and down, by inflation and deflation of air bag 354, under the command of the control 314. Side rollers 343, preferably at several locations, rotatably engage a vertical surface of frame 300 to insure that scissor displacement is vertical. In the position of FIG. 25, with the angle-iron flange 331 inactively stationary so as to be at the left of the top row 106 of ties 102, power drive 354 increments the bundle 103 upwardly only until the flange 330 and the top row 106 of ties 102 are horizontally aligned. At this time, with the scissor lift 340 stationary, the motor 334 rotates the conveyor belt 320 so as to move the angle iron 330 from left to right, causing flange 331 to first engage the newly elevated top row 106 of the ties 102 and, thereafter, displace that top row 106 of ties 102 from the entry station 108 toward the tie separation station 114. When this tie row displacement has been completed, motor 334 continues to cause the shaft 326 to rotate thereby further displacing the conveyor belt 320 and the angle iron 330 counterclockwise, until the angle iron is returned to its beginning position.

At this time, the scissors lift 340 is once more activated so that the structural members 350 and 352, along with the bundle of ties are elevated, as explained above, by a vertical distance equal to one row of ties, at which time the air bag 354 is rendered idle, by command of the control 314, and the above-desired process of displacing an additional top row of ties toward the tie separation station 114 follows. Thus, the scissors lift 340 powered by air bag 354, which is part of the scissor's lift, once more lifts the bundle of ties upwardly by a distance of one row of ties. At this point in time, the angle iron 328 is again displaced through a full cycle to its beginning position to displace another row of ties.

When the entire bundle of ties 103 have been so displaced, top-row-by-top-row, toward the tie separation station 114, the scissor lift 340, under command of the control 314, is lowered by full deflation of air bag 354 back to its initial lowest position, preparatory to receiving the next bundle 103 of ties 102.

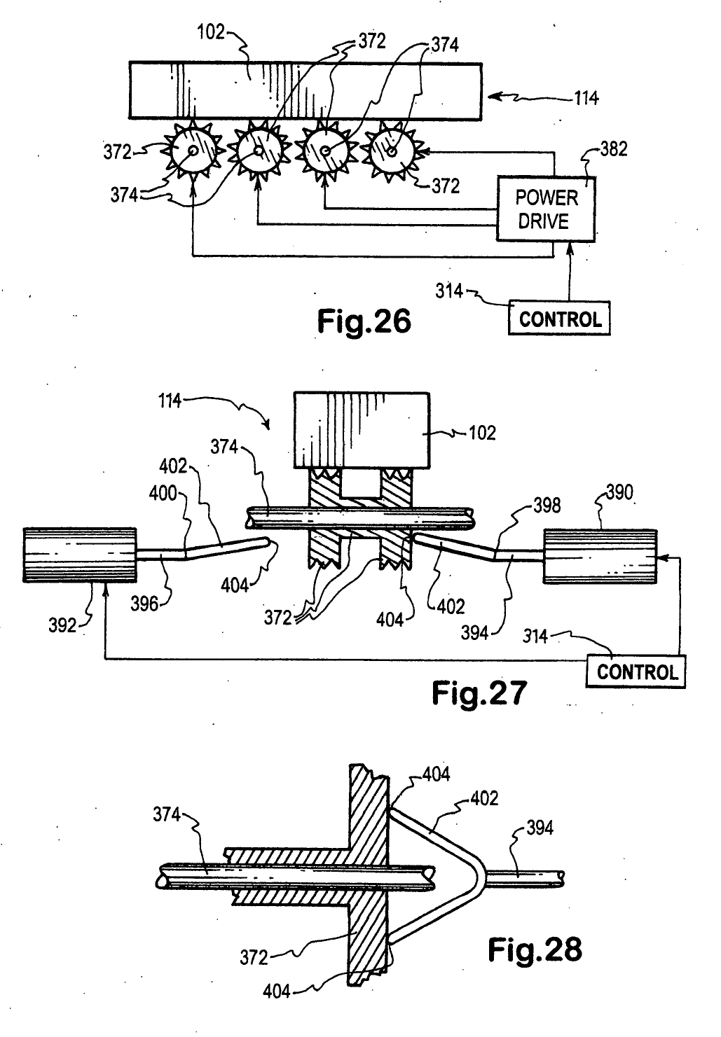

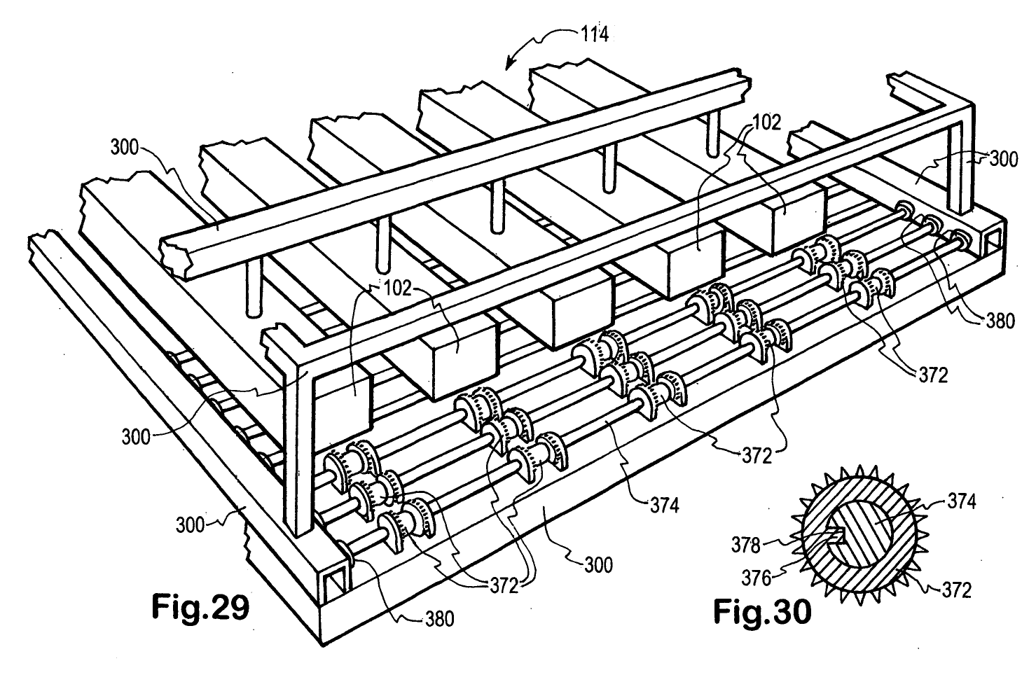

Reference is now made to FIGS. 26-30 to explain one mode of placing the ties of a row in spaced parallel relation at the tie separation station 114. The objective is to essentially move a row 106 of ties 102 from the position shown in FIG. 9 to the position shown in FIG. 10. The position of FIG. 10 is again illustrated in greater detail in FIG. 29.

Once a row 106 of contiguous ties 102 has been dispatched from the entry station 108, as explained above, the respective ties 102 are directly superimposed upon a series of knurled rollers 372. Each knurled roller 372 is non-rotatably joined to an associated shaft 374, there being a number of knurled rollers 372 per shaft 374 equal to the number of ties in the process of being separated. In addition, the knurled rollers 372 are linearly displaceable along their associated shafts, with the exception of the central knurled roller 372 of each shaft 374, which central rollers 372 do not slide.

The relationship between each slideable knurled roller 372 on the associated shafts 374 is shown in FIG. 30. Specifically, the non-rotatable relationship between each knurled roller 372 and its associated shaft 374 is a key/keyway relationship, each knurled roller 372 is shown as providing a key 376 and the associated shaft 374 as providing a mating keyway 378, such that the key/keyway 376/378 relationship is non-rotatable. Each roller 372, excluding the central roller 372, is also slideable along the associated shaft 374. The central knurled roller 372 on each shaft 374 is secured in a fixed position in any suitable way, so it is not linearly displaceable in either direction along the associated shaft 374. The linear displaceability of the knurled rollers 372 of four of the five series of knurled rollers 372 on each shaft 374 comprises the technology by which the ties 102 of a given row 106 are moved into the positions shown in FIG. 29.

The spaced shafts 374 are power driven, each being journaled at their respective ends at 380. One of the journals 380 of each shaft 374 comprises a drive mechanism by which a power drive 382 rotates the five knurled rollers 372 and the associated shaft 374 to displace the row of ties 102 of one row 106 along the processing path after ties 102 leave the entry station 108. The power drive 382 (FIG. 26) is timely turned on and off by command of the control 314.

The control 314 also instructs hydraulic or pneumatic cylinders 390 and 392 (FIG. 27) to extend and retract their respective piston rods 394 and 396 to first displace the four non-central rollers 372 outwardly along their respective shafts 374 predetermined distances. The distal ends 398 and 400 of the piston rods 394 and 396 are respectively rigidly connected to a fork 402. One fork 402, at a distal end thereof, selectively becomes contiguous with, but not connected to one side of the associated knurled roller 372, as depicted in FIG. 27. The other fork 402, is spaced a desired distance from the other side of the associated knurled roller 372. As the row 106 of ties 102 leaves the entry station 108 with the ties 102 in contiguous side-by-side relationship, the series of cylinders 390 transversely displaces the two sets of ties outside the central tie in outward directions by reason of the series of cylinders 390 transversely displace the two sets of inside piston rods 394 and their forks 402 outwardly to displace their associated slidable knurled rollers 372 outwardly a predetermined distance in each case. This sliding movement of the four knurled rollers 372 away from the central tie is for two predetermined distances, more for the two outside rollers 372 and less for the two inside rollers 372, being so displaced to create the spacing shown in FIG. 29. As shown in FIG. 27, the cylinders 392, piston rods 396 and attached forks 402 located away from the four ties being displaced are inactive, with the forks 402, when disabled being spaced an appropriate distance away from their associated knurled roller 372.

When the ties 102 at the separation station 114 are correctly outwardly positioned, as best illustrated at FIG. 29, the spaced ties 102 of the row 106 are then displaced linearly along the processing path by further rotation of the shafts 372, with all cylinders 390 and 392 inactive, causing the knurled rollers 372 to grip against the bottom surface of their associated ties 102 and linearly displace each tie. As a consequence, the ties 102 move, as shown in FIG. 29, from the tie separation station 114 toward the drilling station 118.

Conventional camera oversight may be used to verify that the ties are in the correctly spaced and parallel relationship, as they move from the tie separation station 114 to the drilling station 118.

In further reference to FIG. 27, when the rollers 372 on the shafts 374 have fully displaced the row 106 of contiguous spaced parallel ties 102 to the drilling station 118, so that the ties become free of the knurled rollers 372, the four displaceable knurled rollers 372 at the tie separation station are slidingly moved along their respective shafts 374 back to their original positions so as to be aligned with an incoming row 106 of contiguous side-by-side ties 102. This is done by placing the fork 402 of each piston rod 396 in contact with and then inwardly displace the associated slideable knurled roller 372 to the beginning location on their respective shafts 374. At the same time, the piston rods 394 of the cylinder 390 are retracted along with their associated forks 402 to avoid interference. In this way, the knurled rollers 372 are collectively once again aligned with the respective ties 102 comprising the next incoming row 106 of contiguously side-by-side ties 102.

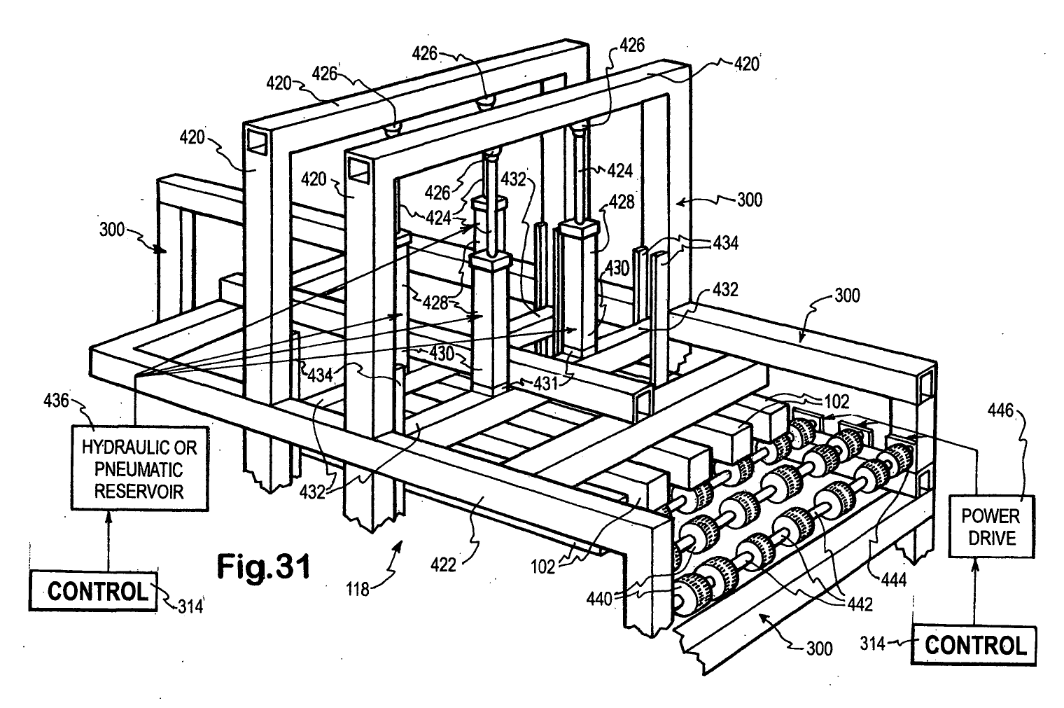

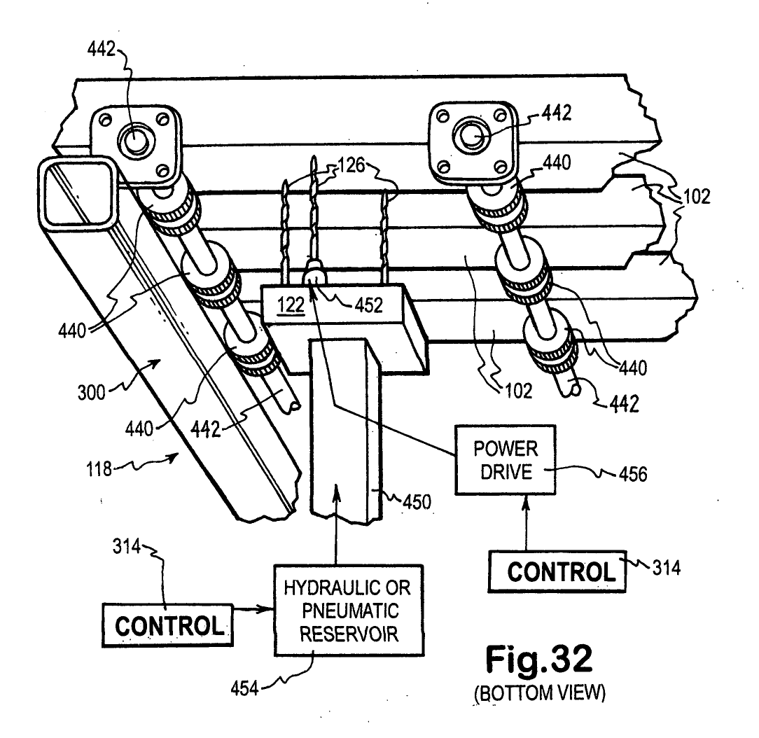

Reference is now made to FIGS. 31 and 32, for details regarding structure and procedure at the drilling station 118, in respect to the first embodiment of the invention. The structural frame 300, at the drilling station 118, is configured to provide, among other things, support and to accommodate the functions which occur at station 118 in respect to a row 106 of spaced ties 102. More specifically, the structural frame 300 comprises two U-shaped frames 420, which are parallel one to the other and perpendicular to the processing path. The vertical legs of frames 420 rest upon and are rigidly connected to two spaced horizontal beams 422. Two vertically displaceable horizontal beams 432 are disposed in the respective vertical planes containing the two frames 420 and also perpendicular to the tie processing path. The spacing of the legs of each U-shaped frame 420 is such that they are located outside the region where ties pass through the drilling station 118, so as to avoid interference.

Suspended from each U-shaped frame 420 are two spaced piston rods 424, each firmly connected at their top distal ends to the associated horizontal portion of the U-shaped frame 420 via connectors 426.

Each piston rod 424 is reciprocated by an associated cylinder 428. The lower end or base of each cylinder 428, at 430, is anchored at a connection plate 431 to one of the reciprocating horizontal beams 432. Thus, there are two spaced beams 432, which move up and down responsive to operation of the four cylinders 428, two for each beam, extending and retracting their associated upwardly-directed piston rods 424 to move the cylinders 428 and beams 432 up and down. The two beams 432, adjacent to their respective ends, engage, at each location, spaced vertical guides 434, so that the beams 432 are accurately moved vertically up and down in the guides 434 by activation and deactivation of the cylinders 428 caused by fluid displacement from hydraulic or pneumatic reservoir 436, under command of control 314.

When the spaced ties 102, received from the tie separation station 114, have fully and accurately arrived at the drilling station 118, as shown in FIG. 31 the beams 432 are in an elevated position. The four cylinders 428 are then activated so as to extend their respective piston rods thereby driving the cylinders 428 and the two beams 432 downward into position-retaining engagement with the top surface of the space ties 102 of one row 106 of ties at station 118. Thus, the row 106 of ties 102 at drilling station 118 is held against movement during the drilling phase at drilling station 118.

The space ties 102 of the row 106 of ties are displaced to, through and beyond the drilling station 118 by a series of knurled rollers 440, each non-rotatably and non-slidably mounted to an associated power-driven shaft 442. Each shaft 442 is journaled at its respective ends 444. One end 444 is equipped with a drive sprocket or the like by which a chain or belt drive, under control of power drive 446, is periodically activated to turn the knurled rollers thereby bringing the ties 102 into the drilling station 114 and later out of the drilling station 114, after the ties have been drilled. The power drive 446 operates under the command of control 314. Each shaft 442, in the embodiment of FIG. 31, carries spaced knurled rollers 440, five in number so as to equal the number of ties at station 118. The knurled rollers 440 are positioned so that a series of rollers 440 is directly under each tie. Thus, the rollers 440 of each shaft 442 form a series of tie displacement mechanisms, which are linearly aligned with the length of each tie 102, with the knurled surface of each roller 440 gripping the bottom surface of the associated tie to move each tie first into the drilling station 118 and, following drilling, out of the drilling station 118 into the plate and spike installation station 129. The knurled rollers 440 may be constructed as are the knurled rollers 372 (FIG. 30).

Reference is made to FIG. 32, which is a bottom fragmentary perspective view looking up at spaced ties 102 properly stationarily positioned at the drilling station 118. It is to be appreciated that while only one set of drills 452 and drill bits 126 are illustrated, there would preferably be similar drill-drill bit assemblies at two locations for several of the ties 102 in the row 106 or, in the alternative, one such assembly for each drill site for one tie. Further, drill mounts 122, drill heads 452 and drill bits 126, as shown in FIG. 32, drill only three holes for one plate location, rather than more, as described above, although six holes per plate could be drilled. So, in the FIG. 31-32 embodiment, one spike 158 will ultimately secure each plate 134 to its tie 102 and two spikes 158 at their heads 161 will ultimately later secure the rail to both the plate 134 and to the tie 102.

The cylinders 428, (FIG. 31), are activated, so that respective piston rods 424 are extended thereby forcing the base of each cylinder 428 downward and also two spaced beams 432 into position-retaining relation with the top surfaces of all of the spaced ties 102 of the row 106 of ties at the drilling station 118. This holds the row of ties 102 firmly in their correctly spaced parallel relationship. At this time, the hydraulic or pneumatic reservoir 454 (FIG. 32), under command of the control 314, causes the piston rod of the cylinder 450 to extend, thereby elevating the drill carrier 122, the drills mounts 452 and the drill bits 126. One end of the piston rod of cylinder 450 is anchored to the frame 300. Power drive 456 causes each drill head 452 to rotate the associated bits 126, under command of the control 314. As a consequence of the described movement, a pattern of three drill holes is made at two spaced locations into each tie 102 for later placement of two plates 134. The drill holes are created at the bottom of each tie, each having an appropriate diameter and appropriate depth. The location and pattern of the drill holes precisely corresponds to apertures in tie plates and determines the gauge of the railroad track on which the ties will later be used.

When the drill holes 128 (FIG. 12) have been created, the control 314 commands the hydraulic or pneumatic reservoir 454 to retract the drill bits 126, the drills mounts 452, the drill carrier 122 and the cylinder 450, thereby moving the drill bits 126 away from the tie to the FIG. 32 position, at which time power drive 456, under command of the control 314, causes the drill mounts 452 to discontinue rotation of the drills bits 126.

When all of the ties 102 of the spaced row 106 at drilling station 118 have been drilled in the manner described above or a variation thereof, the control 314 commands the power drive 446 (FIG. 31) to rotate the shafts 442, at the station 118, causing the knurled rollers 440, which are non-rotatably connected to their respective shafts 442, to rotate, with the knurls thereof gripping the bottom of the spaced ties 102 thereby displacing the drilled ties 102 forward along the processing path and out of station 118 and toward the plating and spike installation station 129, while retaining the spaced parallel relationship between the drilled ties 102.

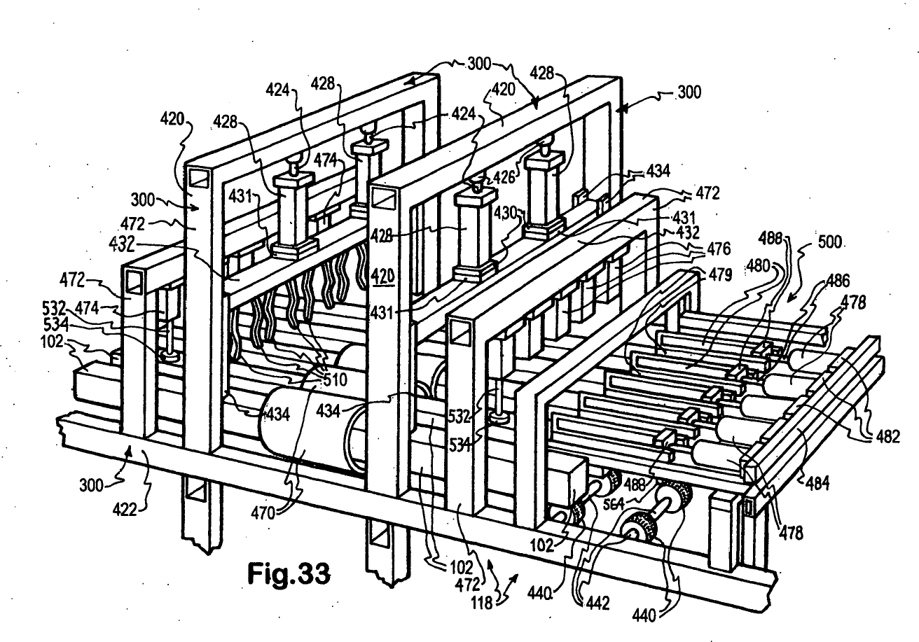

Reference is now made to FIGS. 33-39, which depicts structure located at the drilling station 118 to obtain maximum precision on an automated basis to ensure that the drilling of the ties is with exceptional accuracy. Certain of the structure found in FIGS. 33-38 is essentially the same as that found in FIG. 31-32, described above. These structural elements include two spaced U-shaped structural supports 420, the cylinder/piston rod assemblies 428/424, the mounting plates 431 and the cross beams 432. Shown in FIG. 33 are some of the drive shafts 442 to which knurled rollers 440 are non-rotatably connected, by which the ties 102 of one row 106 are first displaced into the drilling station 118 and, thereafter, following drilling, from the drilling station 118 to the plate and spike installation station 129.

Each spaced tie 102 arriving at the drilling station 118 passes through a cylindrical open ended barrel 470 to aid in accurately placing the ties at the drilling station 118, properly aligned and parallel spaced relation, as explained in greater detail below. At the ingress portion and at the egress portion of the drilling station 118, a transverse U-shaped frame 472 is located, supported by spaced beams 422, which are parallel to the processing path, supports the U-shaped structural members 420. Both supports 472 are in vertical planes.

A series of cylinder assemblies 474 extend vertically downward from the horizontal portion of the U-shaped frame 472 at the ingress portion of the drilling station 118, extending perpendicular to the processing path. Similarly, a plurality of cylinder assemblies 476 are disposed and extend vertically downward from the horizontal portion of distal U-shaped frame 472 near the egress portion of the drilling station 118, also perpendicular to the processing path. The function of the cylinder assemblies 474 and 476 will be explained in greater detail hereinafter.

A set of horizontally disposed cylinders 478 equal in number to the number of ties 102 in the row 106, are positioned at and somewhat beyond the distal ends of the ties 102, as shown in FIG. 33. Slots or channels 479, aligned with the cylinder 478, are defined by parallel flanges 480. One cylinder 478 is disposed at the distal end of each slot 480. The base 482 of each cylinder assembly 478 is anchored to a fixed transverse structural beam 484, while the piston rod 486 of each cylinder 476 rigidly carries a guide 488, for linear displacement in its associated channel 479. A greater explanation of the cylinders 478 and piston rods 486 is presented hereinafter.

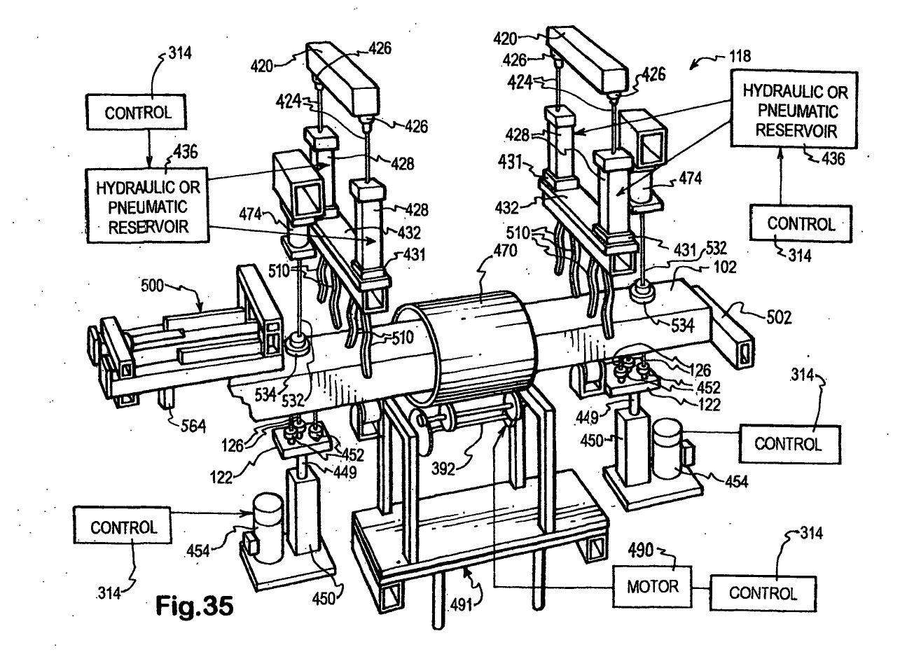

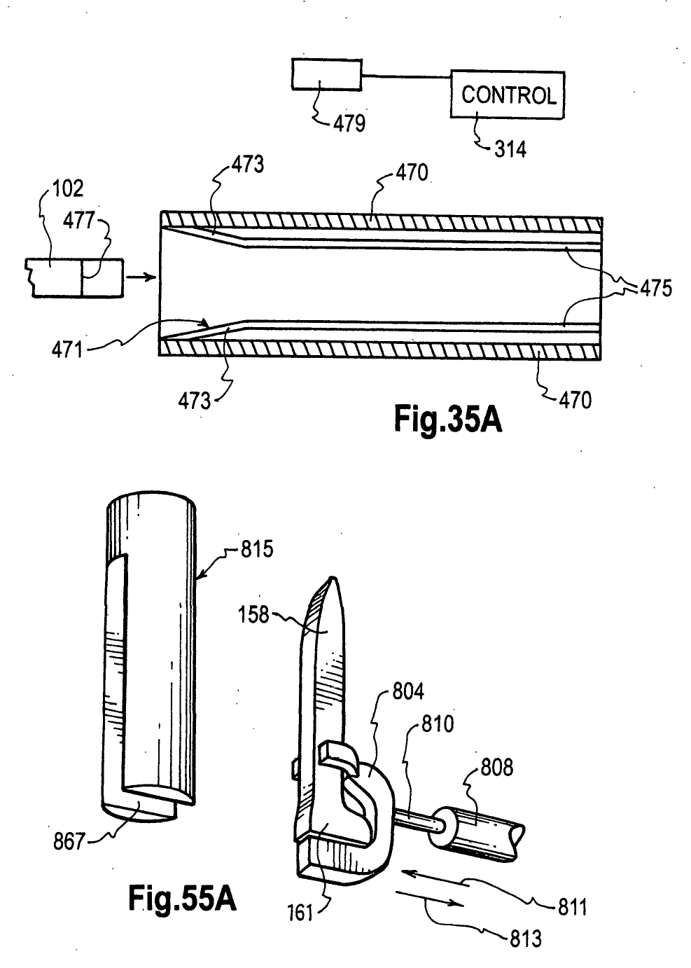

In reference to FIG. 35A, an internal box, generally designated 471 is illustrated. The box 471 comprises tapered entry walls 473, which center each ingress tie 102 within the barrel 470 as the tie is displaced from left to right, as viewed in FIG. 35A. The tapered walls 473 merge integrally with parallel side walls 475, which are spaced one from the other by a distance slightly greater than the width of the tie 102. As is standard, each tie 102 has a kerf slot 477 at each end, typically comprising a transverse saw cut in the tie, located on the order of 14.75 to 21.125 inches from the adjacent tie end, depending on the length of the tie. Each saw kerf 477 is typically ¼ of one inch in depth and not more than ¼ of one inch in width.

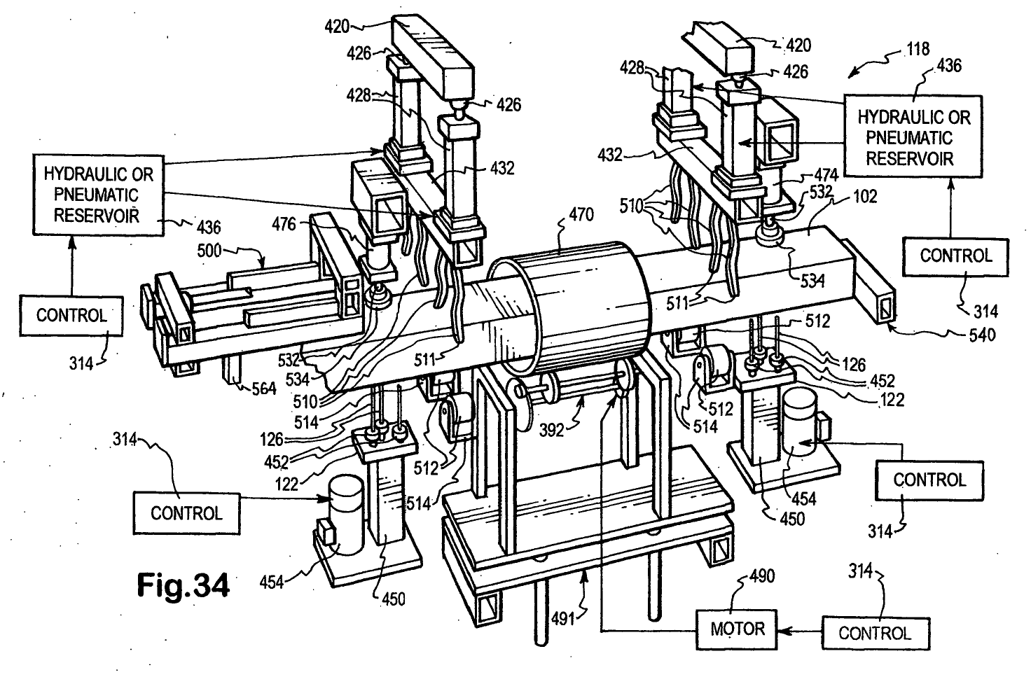

Once the ingress tie 102 is centered in the barrel 470, the leading saw kerf 477 is detected by a kerf sensor 479 which causes the control 314 to halt tie displacement and causes the barrel displacement mechanism to rotate and lift the barrel 470 and the associated centered tie utilizing motor 490 (FIG. 34), until the tie is correctly positioned and aligned with the downstreams processing path. Barrel displacement mechanism 492 and motor 490 are supported upon a frame 491. The sensor 479 is preferably model LES 36 HI, manufactured by Leuze Electronic.

The raising and rotating of the barrel and the tie in the barrel inverts both by 180 degrees thereby placing the saw kerf 477 on the bottom, where drilling will later occur.

As best shown in FIGS. 34-36, a mechanism, generally designated 500, is provided for assisting in longitudinally aligning the ties 102 at the drilling station 118. A distal end of one tie 102 is cause to engage a stop mechanism 540, as explained in greater detail hereinafter.

Five sets of vertically-displaceable spreadable alignment forks 510, each comprising two downwardly-directed bifurcated fingers 511, each of which depends from and is rigidly secured at the upper end to the lower surface of one of two cross beams 432. Thus, there is one fork 510 comprising bifurcated cantilevered fingers 511, located in aligned relation at each side of each beam 432, at two separate locations, as best seen in FIG. 34. With the cylinders 428 deactivated and the piston rods 424 thereof retracted, as seen in FIG. 34, the split fingers 511 of each fork 510 are elevated above and only slightly to the outside of the associated tie 102. Each bifurcated finger 511 is respectively disposed directly above a finger-spreading roller 512. Each roller 512 is an idler roller rotatably carried on a shaft which turns in respect to a U-shaped bracket 514, which is anchored in fixed relation to the frame 300.

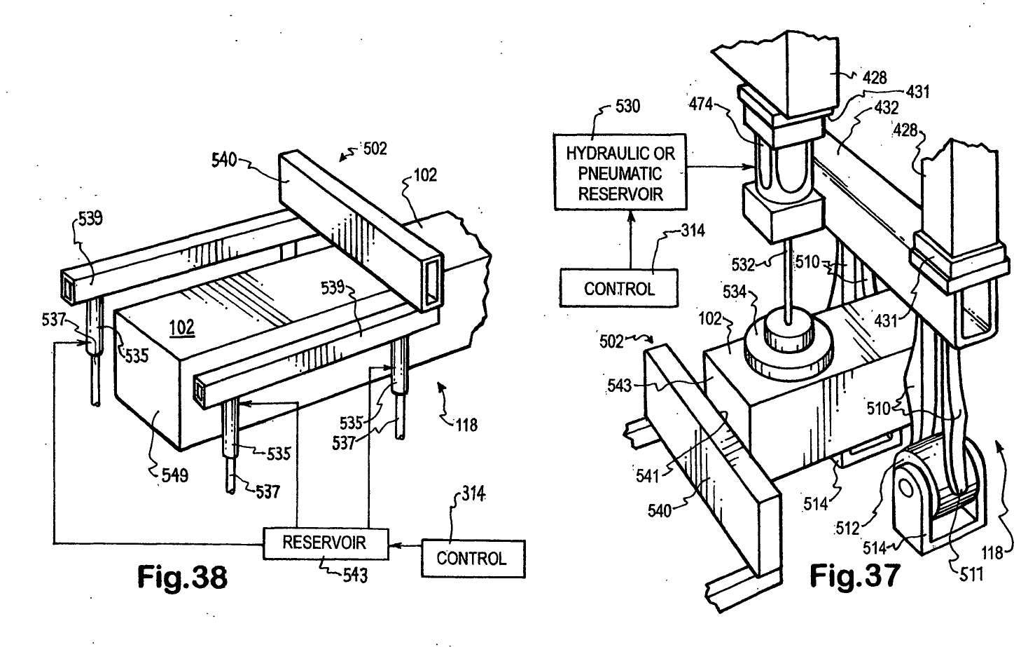

The split fingers 511 of each fork 510 are designed to ensure that the associated tie is not skewed, but is precisely transversely and longitudinally positioned at the drilling site 114, prior to drilling. To ensure this accuracy, the cylinders 428 are activated by reservoirs 436 causing the piston rods 424 to extend. Because the U-shaped supports 420 are fixed in position, the extension of piston rods 424 cause the associated cylinders 428 to move downward, thereby moving the cross beams 432 down also. As the cylinders 428 move downward, the split fingers 511 of each fork 510 engage the associated roller 512 on opposite sides of the tie 102. Each roller 512 is sized and positioned so that the split fingers 511 of the associated fork 510 engage the associated roller 510 in such a way as to spread the two fingers 511 around the roller 512, as best shown in FIG. 37. The interior finger 511 of each fork 510 is shaped so that when each set of bifurcated fingers is spread, as illustrated in FIG. 37, the interior finger 511 firmly engages one side of the tie so that all four interior fingers 511 collectively force the tie 102 into the desired alignment, prior to drilling. Each set of bifurcated fingers 511 remain in the spread position by reason of engagement with the associated roller 512, as illustrated in FIG. 37, during the drilling process.

At this point in time, command from the control 314 activates a hydraulic or pneumatic reservoir 530 (FIG. 37) to activate all of the cylinders 474 and 476. Each cylinder 474 and 476 is associated with a piston rod 532, at the distal end of which, in each case, is located a compression pad 534. Thus, the pads 534 are forcibly superimposed upon the top surface of the associated tie 102 to retain the aligned position of the tie 102, during the drilling step.

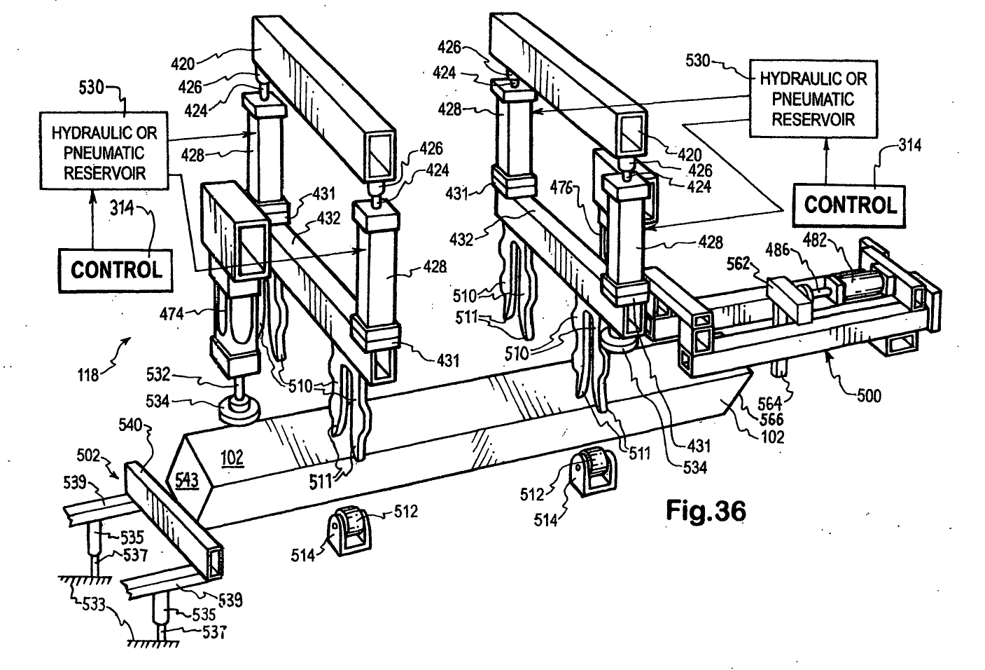

At the same time, a stop 540 is positioned in abutting relation with the associated tie 102 at the proximal end of each tie at the drilling station 118 so that the proximal ends of all ties are disposed in a common transverse plane. FIGS. 36 and 37. This is done by displacement of beams 539 (FIGS. 36 and 38) by operation of cylinders 535 and their piston rods 537, anchored to the frame, using fluid from reservoir 543, under command of the control 314.

When the ties 102 at the drilling station 118 have been drilled preparatory to receiving plates 134 and spikes 158, the stop 540 for each tie is elevated by fluid from reservoir 543 moving the cylinders 535 and piston rods 537 from the position of FIG. 37 to that of FIG. 38, to allow the knurled rollers 440 to displace the row of drilled ties to the plate and spike installation station 128, without interference.

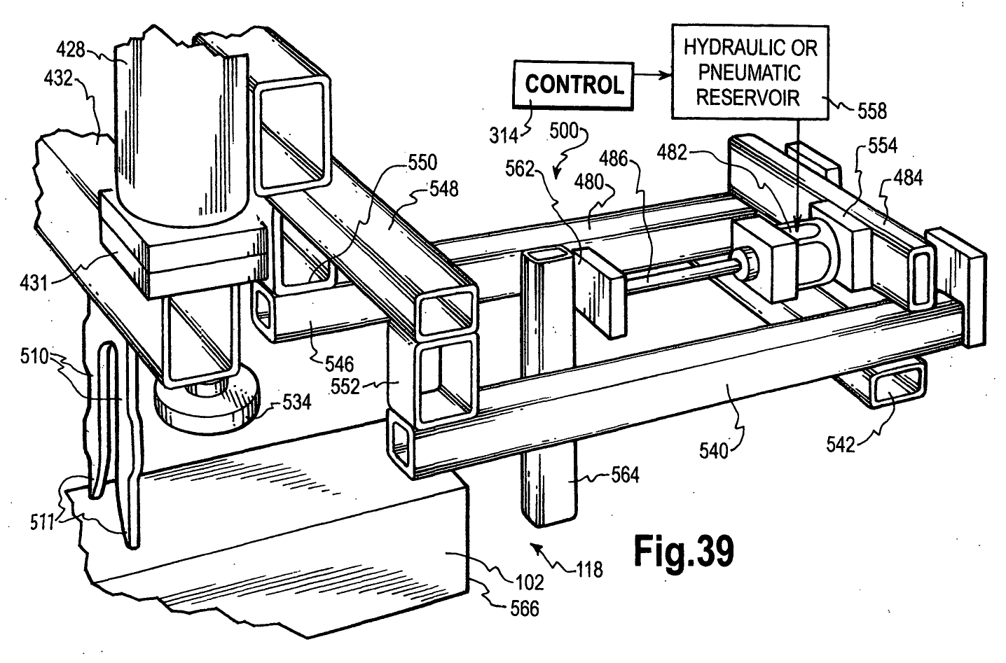

Reference is now made to FIG. 39. Near the distal end of each tie 102, at the drilling station 118, is disposed a rack, generally designated 500. The rack 500 comprises a structural frame comprising stationary beams 540, 484, 542 and 546, all rigidly secured together and suspended from a cross beam 548 from which vertical columns 550 and 552 integrally extend downward. The base 554 of the associated cylinder 482 is integrally joined in stationary relation to beam 484, the cylinder 482 being serviced by fluid from a hydraulic or pneumatic reservoir 558, when activated and deactivated under command of the control 314. Extending in the direction of the tie 102 from the cylinder 482 is a piston rod 486, the distal end of which is integrally connected to a lineal guide 562, which reciprocates as the piston rod 486 is reciprocated by activation and deactivation of cylinder 484. The guide 562 is displaced in its channel 479 (FIG. 33) in a back and forth linear fashion integrally carrying with it downwardly directed stop 564. When the piston rod 486 is extended, the guide 562 advances the downwardly extended stop 564 into contiguous forceful engagement with the adjacent end of the associated tie 102. If the associated tie 102 is spaced from the fixed stop 540 (FIG. 37) in its down position, the displaceable stop 564 will linearly displace the associated tie 102 until distal end of the associated tie 102 contiguously engages the stationary stop 540, at interface 541, as seen in FIG. 37. Thus, each tie 102 at the drilling station 118 is caused to have length alignment so that the distal ends 566 and the proximal ends 543 of each tie 102 are aligned in two spaced vertical planes, which are perpendicular to the lengths of the ties. In this way, drilling is precise at two locations on each tie, which later accurately define the gauge when plate placement occurs. When the drilling is complete, the stops 540 and 564 are removed from the path of ties 102. The stop 540 is elevated along with beams 539 to the position of FIG. 38 by extension of piston rods 539 from associated cylinders 535, the distal ends of the piston rods 537 being attached to the frame 300.

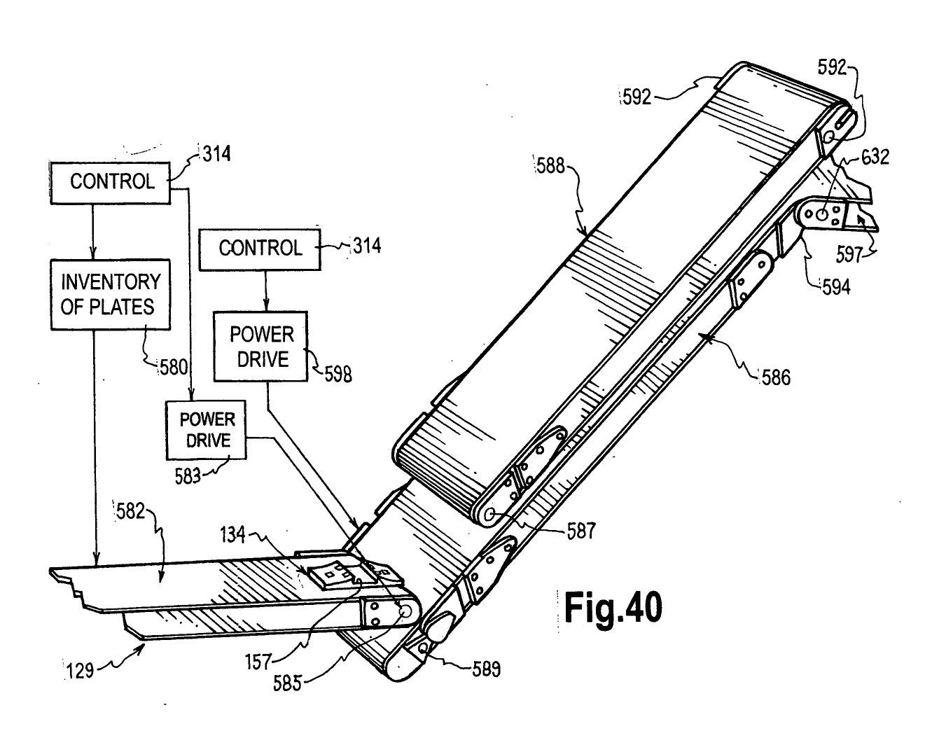

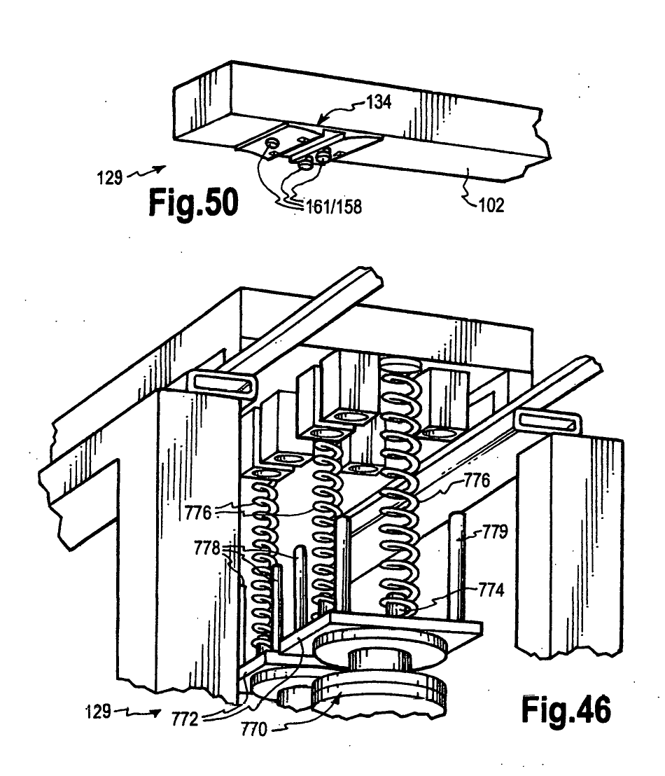

Reference is now made to FIGS. 40-50, which relate to one way in which tie plates 134 are processed and applied to the underside of ties 102 at the plate and spike installation station 129.

As shown in FIG. 40, from an inventory 580 of plates 134, the plates are successively dispatched, under command of control 314, one after the other to a generally horizontal receiving belt conveyor 582. Each plate 134 received at the top of conveyor 582 is of upright orientation, with the central channel 157 face up. The conveyor 582 is driven by a power drive 583 at drive shaft 585, under command of the control 314. Each plate 134, when discharged from the distal end of the conveyor 582, is deposited upon the top surface of an inclined belt conveyor, generally designated 586.

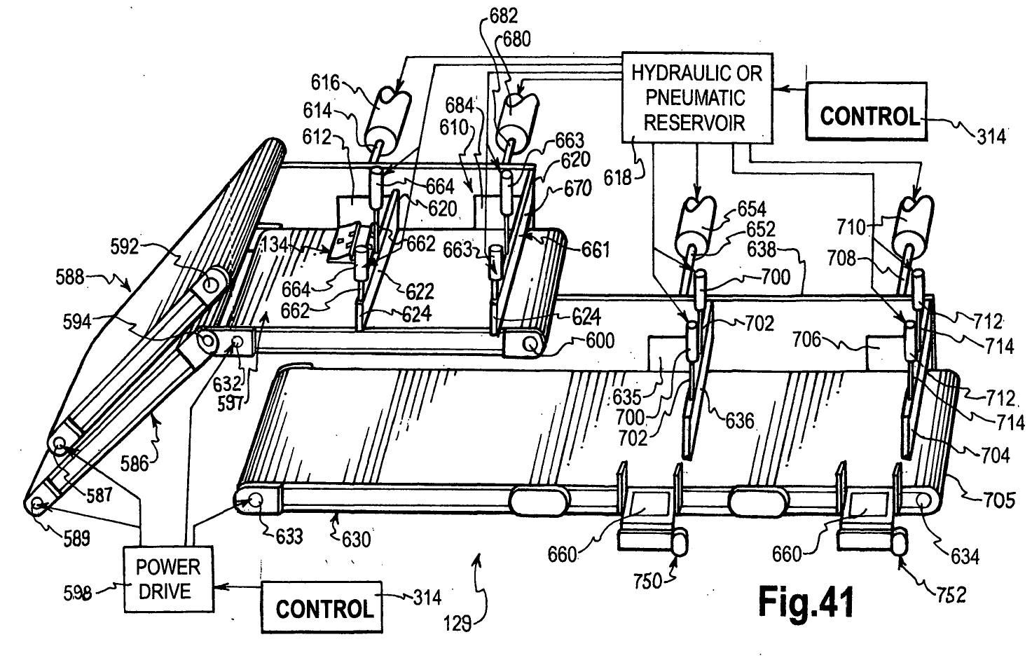

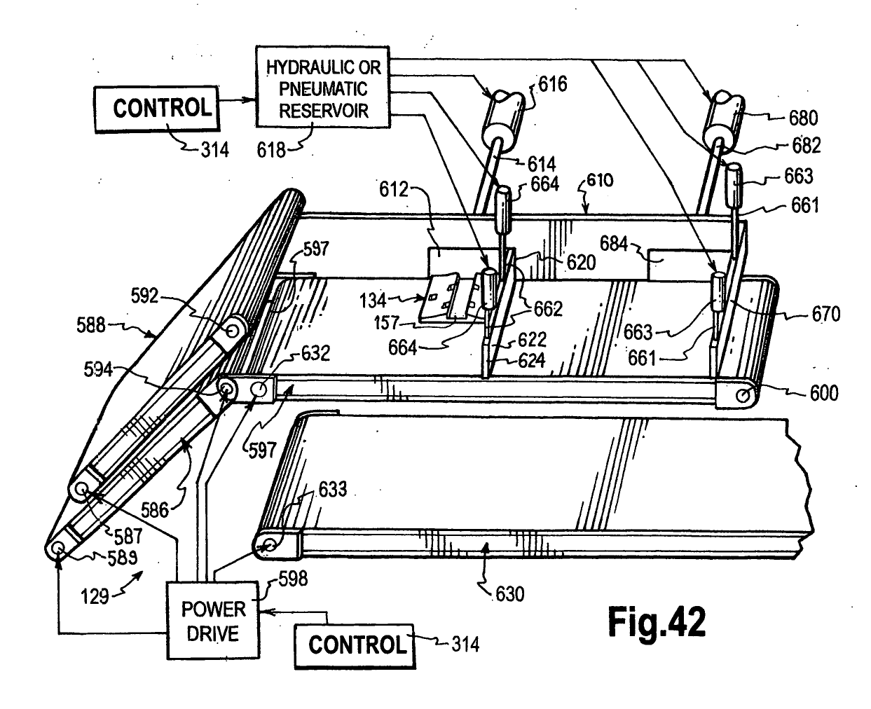

Each plate 134 deposited upon the top surface of inclined belt conveyor 586 moves upward via drive shaft 589 displaced by power drive 598, under command of the control 314, so that the plate 134 is in contiguous contact not only with the top surface of conveyor 586 but also with the bottom surface of a second inclined belt conveyor 588. Conveyors 586 and 588 are parallel and, therefore, equally inclined. Top conveyor 588 is also driven by power drive 598 via drive shaft 587, under command of control 314, so as to be synchronized with conveyor 586, driven by drive shaft 589, as well. The two inclined but spaced and parallel conveyors 586 and 588 hold each plate 134 engaged between them so that no plate 134 slides downwardly or becomes skewed during the plate-conveying process. Conveyors 586 and 588 are equipped with idler rollers 592 and 594, respectively. When a plate 134 reaches the upper distal end of conveyor 586, the plate 134 is discharged onto a generally horizontal belt conveyor 597, which, as shown in FIG. 41, is power driven by motor 598 via drive shaft 632, under command of the control 314. The distal end of the conveyor 597 is equipped with an idler roller 600, accommodating rotation of the conveyor 597 causing the top portion of the conveyor 597 to move from left to right, as viewed in FIGS. 41 and 42.

At one side edge of the conveyor 597 and slightly above the conveyor 597 is an edge guide, generally designated 610, along which upright plates 134 sequentially slide during displacement, whereby each plate 134 is precisely orientated for further displacement along two processing paths. FIG. 42 shows one plate 134 having moved to its correct temporarily position on the top of conveyor 597 against a transverse vertical reciprocable guide-stop 622, preparatory to the plate being ejected from the belt of conveyor 597.

Recessed into the edge-guide 610 adjacent to a transverse stop-guide plate 622 are two recessed push blades 612 and 684, such that, as shown in FIG. 42, one edge of successive tie plates 134 is caused to be contiguous with the distal surface of first the push blade 612 and second the push blade 684. The push blade 612 is integrally connected to a piston rod 614, which is extended from and is retracted into an opening in edge guide 610 by a two way cylinder 616, responsive to fluid flow to and from fluid reservoir 618. One end 620 of a traverse guide-stop 622 is disposed near the push blade 612, so that when the tie plate 134 moves along the edge-guide 610 under force of the conveyor 597, the tie plate 134 will stop in the position shown in FIG. 42, even though displacement of conveyor 597 may or may not continue. At this point, under command of the control 314, the fluid reservoir 618 activates the cylinder 616 causing the piston rod 614 to extend thereby extending the push blade 612. As a consequence, the adjacent tie plate 134 moves transverse of the conveyor 597 along the stop-guide 622, from top to bottom as shown in FIG. 42, resulting in the tie plate 134 being transversely discharged onto another horizontally oriented belt conveyor, generally designated 630. Conveyor 630 is shown as being in a plane slightly lower than the plane containing conveyor 597.

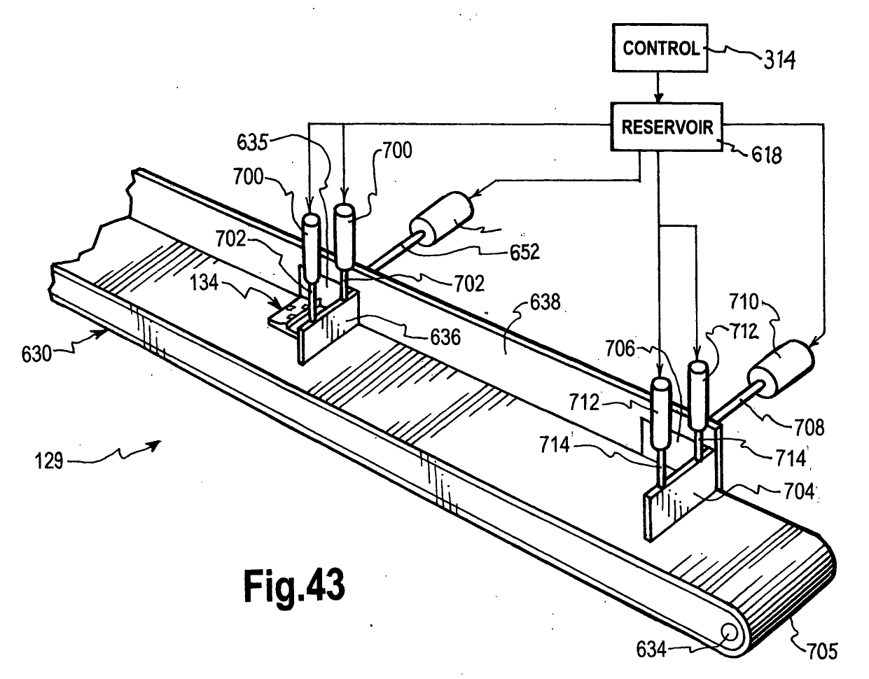

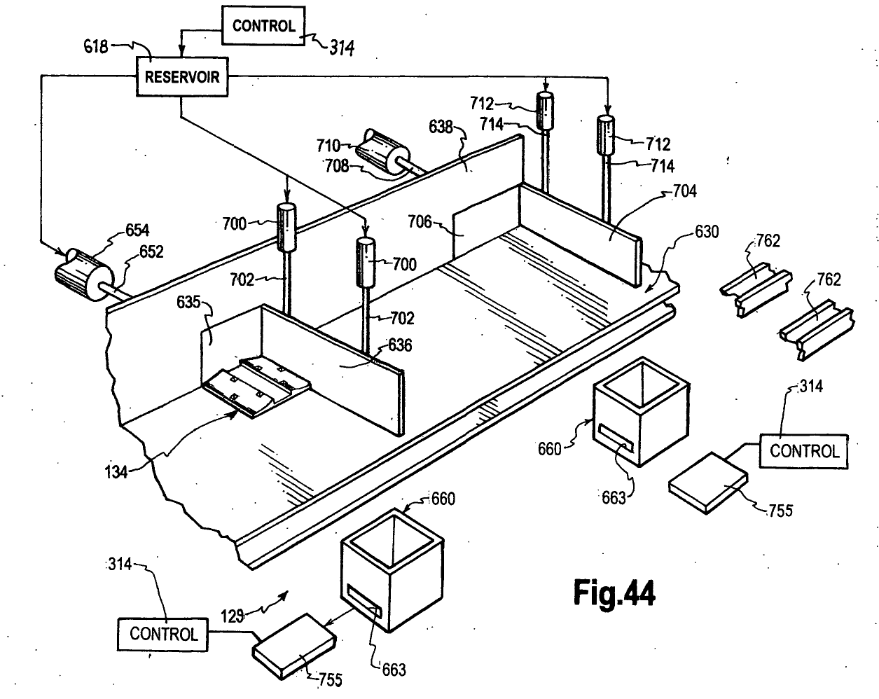

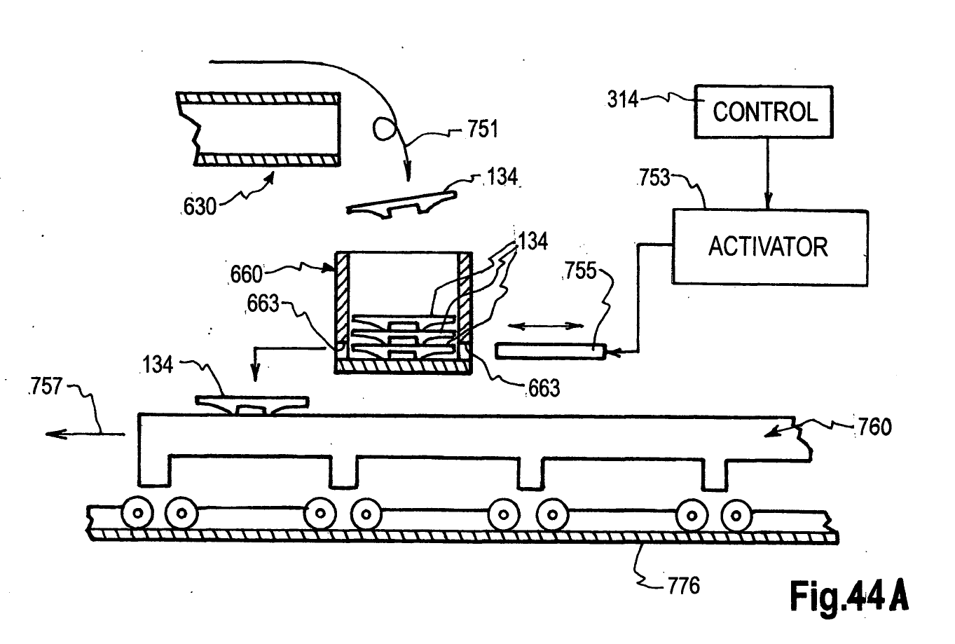

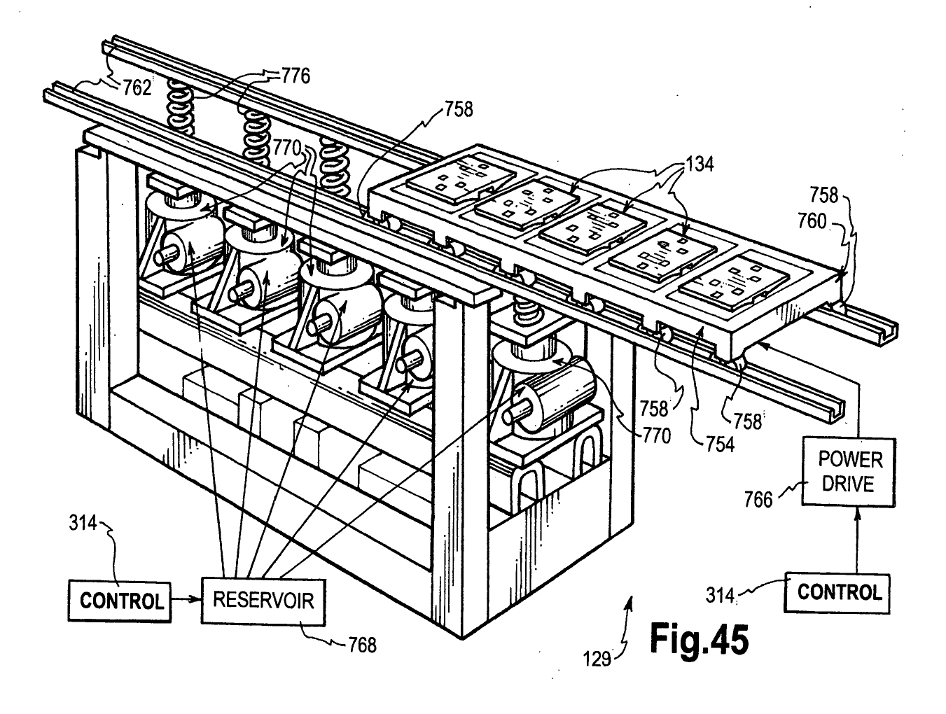

Conveyor 630 is displaced by power drive 598, under command of the control 314, a power drive shaft 633 being provided for that purpose. The other end of the conveyor 630 comprises an idler shaft 634. FIG. 41. The plate 134 on the top surface of conveyor 630 is thus displaced from left to right, as seen in FIG. 42, until its travel is suspended by tie plate engagement with a transverse guide-stop 636, even though rotation of conveyor 630 may or may not continue. FIGS. 43 and 44. The tie plate 134 is guided into position against guide-stop 636 along a stationary edge guide plate 638 located at one edge of and slightly above conveyor 630. In this position, one edge of the tie plate 134 rests against a reciprocable push blade 635, which is recessed into edge guide plate 638. The tie plate 134 thus becomes contiguous with the push blade 635 and the stop-guide plate 636. Fluid from reservoir 618 (FIG. 41) is displaced, under command of control 314, to cause the piston rod 652 (FIGS. 43 and 44) to extend from cylinder 654. The piston rod 652 is integrally united at its distal end with the push plate 635, such that the push plate 635 is caused to move transverse of the conveyor 630 adjacent to stop guide 636 discharging the plate 134 in one of two receptacles 660 when the piston rod 652 is extended. FIGS. 41 and 44.

The immediately foregoing description relates to a first tie plate 134 to reach the conveyor 597 and thence conveyor 630. Since tie plates must be provided at two locations on each tie, the present system provides for placement in spaced receptacles 660 of two spaced tie plates 134.

To place a second tie plate in a second receptacle 660, the piston rods 662 are retracted into their respective cylinders 664. FIG. 42. The distal ends of the piston rods 662 are integrally connected to the top of the stop-guide 622, so that the stop-guide 622 is lifted by retraction of the piston rods 662 a distance ample for a tie plate 134 to pass on conveyor 597 under the elevated stop-guide 662 and along edge-guide 610. At this point, piston rod 614 is retracted into its cylinder 616, thereby placing the push plate 612 into its recessed location in edge-guide 610.

With stop-guide 622 elevated, the next tie plate 134 moving upon the top surface of conveyor 597 and sliding along edge-guide 610, encounters a second transverse stop-guide plate 670.

The control 314 activates cylinder 680, causing its piston rod 682 to extend. At the distal end of piston rod 682 is integrally connected a recessed push blade 684, which is extended by extension of the piston rod 682, thereby transversely displacing the tie plate 134 along transverse stop-guide 670. This transfers the tie plate 134 from the conveyor belt 597 onto conveyor belt 630.

With the conveyor belt 630 activated for rotation by the power drive 598 (FIGS. 41 and 42), under command of the control 314, the top surface of the conveyor 630 is displaced from left to right, as viewed in FIGS. 41 and 42, causing each tie plate 134 to move from left to right on the conveyor 630. The cylinder 654 (FIGS. 43 and 44) is activated so as to retract the piston rod 652 and the integral push plate 635 and the cylinders 700 are retract their respective piston rods 702 thereby lifting stop-guide plate 636, which is integrally connected at the top thereof to the distal ends of the piston rods 702. The elevated position of stop-guide plate is thus sufficient to allow the tie plate 134 on the conveyor 630 to pass freely under the elevated stop-guide plate 636. Thus, the second tie plate 134 on the top surface of the conveyor 630 is moved along guide 638 to engage a transverse stop-guide 704, disposed adjacent to the distal end 705 of the conveyor 630.

As this occurs, one edge of the second tie plate 134, being so displaced, moves contiguously along one surface of the side guide 638 until guide-stop 704 is contacted. In this position, a push plate 706 is disposed in a recess in the guide 638, via retraction of piston rod 708 into cylinder 710, the distal end of the piston rod 708 being integrally attached to the push blade 706. The cylinders 712 are activated so that their respective piston rods 714 are extended, holding the stop-guide 704 in its down position. The piston rods 714 are integrally connected, at their respective distal ends, to the top of the transversely-disposed stop-guide plate 704, so that stop-guide plate 704 stops the second tie plate 134, when the stop-guide 704 is in its down position thereby preventing the plate 134 from moving farther along the conveyor 630 beyond the stop-guide plate 704.

At this point, under command of the control 314, fluid from the reservoir 618 (FIG. 41) activates cylinder 710, thereby extending its piston rod 708, which in turn extends the push plate 706, thereby displacing the second tie plate 134 transverse of the conveyor 630 along the stop-guide 704. The plate 134 is thus delivered to the top of a second receptical 660, channel 157 up.

In further reference to FIGS. 41 and 42, it is to be appreciated that the piston rods 661 of cylinders 663 are integrally connected, at their distal ends, to the stop-guide plate 670. During operation, the piston rods 661 will be extended by fluid from reservoir 650, under command of the control 314, and will remain in that lowered position except, under atypical circumstances when the stop-guide 670 may be lifted for purposes other than plate displacement. Because the incoming plates 134 on conveyor 597 all exit to the side onto the top surface of conveyor 630, and no plate is discharged linearly from the distal end of the conveyor 597, there is no ordinary need for the barrier 670 to be elevated. The same is essentially true of the cylinders 712 and their associated piston rods 714. Piston rods 714 will ordinarily be extended so that the barrier 704 is, at all times during operation, in the down position illustrated in FIGS. 41 and 42.

It is to be appreciated that the stop-guides 622, 670, 636 and 704 will be slightly above the top of the conveyors 597 and 630, respectively, so as to not interfere with the rotation of the belts of conveyors 597 and 630.

In reference to FIGS. 43, 44 and 44A, two tie plates 134 are respectively successively engaged by stop-guides 636 and 704, with the plates oriented with the ridges thereof up. The spaced tie plates 134 are respectively, although sequentially, stacked in two recepticals or magazines 660 discharge, from which is, controlled by release mechanisms 753. The tie plates 134 are each inverted as they are transversely discharged from conveyor 630, as shown at arrow line 751 in FIG. 44A. Consequentially, each tie plate 134 inverts so that the channel 157 is down and falls by force of gravity into the associated magazine 660, where the plates 134 are vertically stacked, and thence discharged onto a wheeled cart or shuttle 754 (FIG. 45).

With one magazine 660 full of stacked tie plates 134, top down, as shown in FIG. 44A, the wheel-mounted shuttle or tray 760 is incrementally displaced along rails 776 driven by power drive 766 (FIG. 45) until positioned to accurately and sequentially receive inverted plates 134 from the one magazine 660. Each 660 magazine is equipped with a reciprocating bottom push plate 755, and through slots 663 in magazines 660. The push plate 755 is reciprocated by any suitable activator 753, under command of control 314. When one plate 134 is pushed out by push plate 755, it falls by gravity accurately onto the top of the shuttle 760. The shuttle is then incrementally displaced, as shown by arrow 757 in FIG. 44A, until positioned to accurately receive the next plate 134 from the magazine 660. One shuttle 754 is used for each magazine 660.

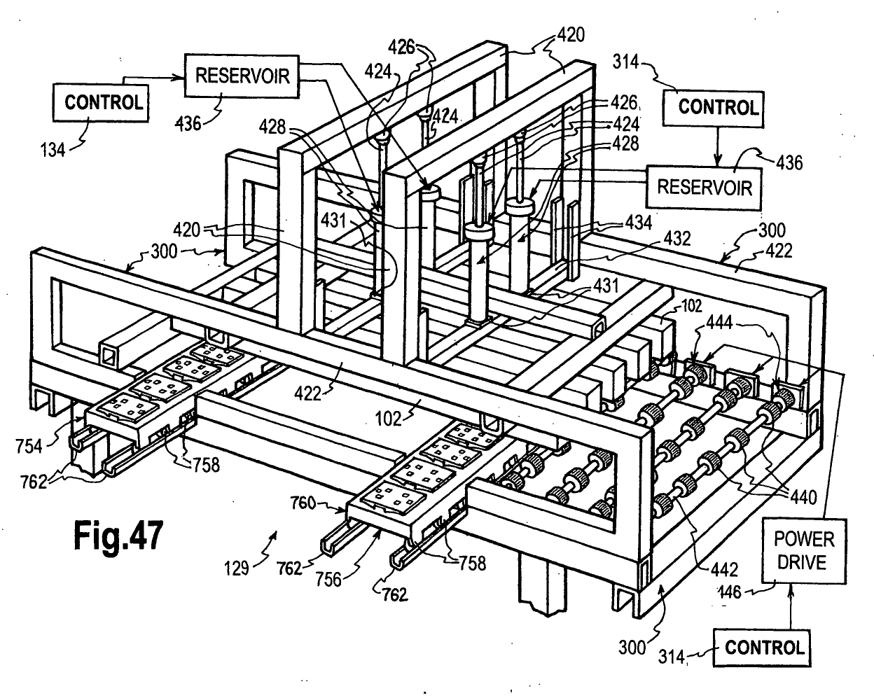

With reference to FIGS. 45-50, two mobile trays or shuttles 754 and 756 assist in placing two tie plates 134 on each tie 102 at the plate and spike installation station 129. The spaced trays or shuttles 754 and 756 (FIG. 47) accommodate plates equal in number to ties being processed at the plating and spike installation station 128. The trays or shuttles 754 and 756 each roll on idler wheels 758 and each comprise a peripheral rectangular support frame 760. The series of wheels 758 on each side of each tray 754 and 756 move linearly to and fro in spaced U-shaped tracks 762. The two tracks 762 associated with each tray 754 and 756 are spaced so that the trays shuttles 754 and 756 reciprocate linearly along the associated U-shaped tracks 762. The ties are spaced to insure correct placement of tie plates 134 on the underside of each tie 102 in a row 106 of ties. This establishes, with great accuracy, the gauge spacing of the inverted tie plates 134 on the two trays or shuttles 754 and 756, with the spaced plates 134 on each tray 554 and 556 being later lifted into contact with the undersurface of the ties 102, as explained hereinafter, into accurate contiguous relation with the lower surface of each tie in row 106 at station 129.

Each spaced tray or shuttle 754 and 756 is displaced by power drive 766, under command of the control 314, the spacing between plates 134 on each tray or shuttle 754 and 756 being equal to the spacing between the ties 102 at station 129. FIG. 45. The power drive 766, when activated, under command of control 314, causes the trays or shuttles 754 and 756 to move fully into their respective tie plate installation positions at station 129. The trays or shuttles 754 and 756 are emptied by reason of the tie plates 134 thereon being elevated from the positions shown in FIG. 45 to positions contiguous with the lower surface of the ties 102, respectively, in the manner explained below.

The trays or shuttles 754 and 756 remain in the plate installation position mentioned above until and while the tie plates 134 thereon are elevated and spikes 158 are later installed through apertures in the tie plates 134, the spikes 158 being pressed into the respective ties at the previously created drill holes, in the ties 102, as explained herein in greater detail. After the spikes 158 are installed and the plate-to-tie-holding mechanisms withdrawn, trays or shuttles 754 and 756 are retracted by power drive 766 for repeated use with the next set of ties 102 at the station 129. An installed tie plate 134, with spikes extending there through is shown in FIG. 50.

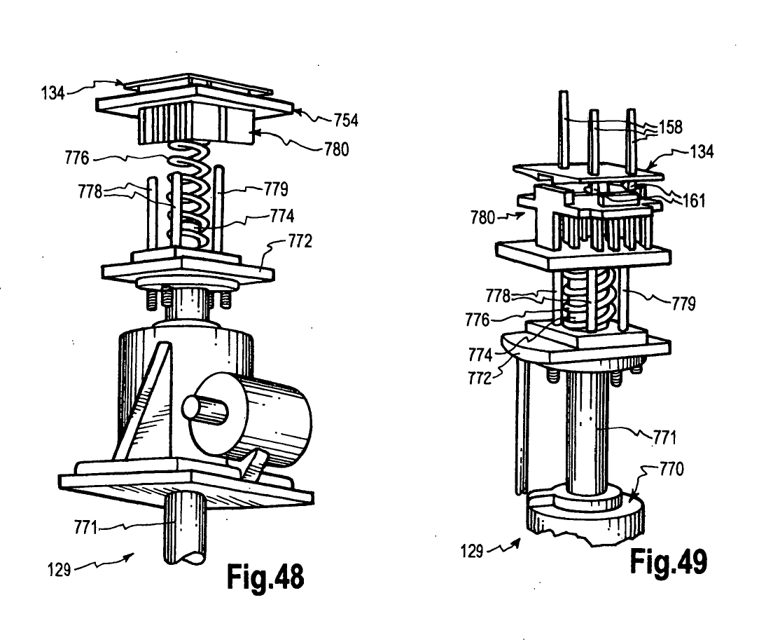

The two trays or shuttles 754 and 756, each fully loaded with inverted plates 134, are fully linearly inserted along tracks 762 and, with the railroad ties 102 correctly positioned at station 129, under command of the control 314, fluid from the reservoir 768 (FIG. 45), activates hydraulic or pneumatic cylinders 770. Each cylinder 770 has a piston rod 771 (FIG. 49) holding, at the distal end thereof, an upwardly extending spring 776 carried by a base plate 772 integrally mounted on the distal end of each piston rod 771. FIGS. 48 and 49. Thus, when the piston rods 771 of the cylinders 770 are extended, the base plates 772 are elevated, together with the associated springs 776. Each base plate 772 comprises a relatively short cylindrical stud 774 extending vertically upward, sized and shaped, in each case, to closely receive the lower end of its associated compression spring 776. Each compression spring 776 is, therefore, sized so as to fit snuggly over its associated stud 774, as best shown in FIGS. 48 and 49.

Each displacement head 772 also integrally carries three vertical rods 778 and 779, which are longer than the associated stud 774 and are positioned to correspond precisely with three of the apertures in the plate 134 to be lifted by the associated spring 776. Rod 779 is slightly longer than rods 778.

All of the cylinders 770 are activated simultaneously by fluid from reservoir 768, (FIG. 45) under command of the control 314, so that each spring 776 lifts an associated tie plate 134 with which the respective springs are aligned, from the associated tray or shuttle 754/756 upward firmly against the lower surface of the associated tie 102.

At the top distal end of each spring 776 is carried a spike-receiving header, generally designated 780. FIGS. 48-49. As explained hereinafter in greater detail, spikes 158 at each location are delivered to the associated spike-receiving head 780, without interference with any of the springs 776, and are successively positioned, with their respective spike heads 161 down and in alignment with three of the apertures in the associated plate 134 (although more spikes could be used up to a total of six equal to the number of apertures in the plate 134). This position of the spikes 158 is shown in FIG. 49, with the spikes 158 extending through plate apertures, with the tie 102 removed for purpose of clarity. The heads 161 of the spikes 158 are aligned with the rods 778 and 779, tip up, so that, as the plate 134 becomes contiguous with the lower surface of the associated tie 102, the spikes 158 pass through aligned apertures in the associated plate 134, with the plate against the lower surface of the tie 102, and, thereafter, the spikes are forced by the extension of piston rods 771 and spike rods 778 and 779 so that the spikes 158 are forced into drill holes in the tie 102. Note, from FIG. 49, that two of the spikes 158 are rail-engaging spikes and are initially located in a lower orientation on a head 780 by engagement with rods 778, with the other plate-holding spike 158, at its upper tip, and at its lower head somewhat more elevated by engagement with rod 779. Thus, plate-holding spike 158, by extension of the piston rod 771 becomes fully inserted and the head 161 thereof firmly contiguous with the tie plate 134, while the other two spikes 158 are inserted only partway into the tie, with the eccentric heads 161 thereof facing the central channel 157, leaving room for later insertion of the lower flange 202 of a rail 200 under the eccentric heads 161 of the partially inserted spikes 158, once the ties 102 have received their plates 134 and the ties 102 have been inverted.

FIG. 47, illustrates the same tie hold-down assembly as shown and explained in connection with FIG. 31 and is so numbered. This assembly is used to hold the ties 102 stationary at the station 129, by applying a downward force on the upper surface of the ties 102, in the same manner as explained above in conjunction with station 118. Because the pressure-applying assembly at station 129 is essentially identical to that of station 118, no further description is deemed necessary. Further, in respect to FIG. 47, when the spaced ties 102 of one row 106 are displaced to and from the plating and spike installation station 129, such occurs by controlled rotation of knurled rollers 440, which are non-rotatably and non-slideably mounted on drive shafts 442, but otherwise in the same manner as described above in respect to station 118.

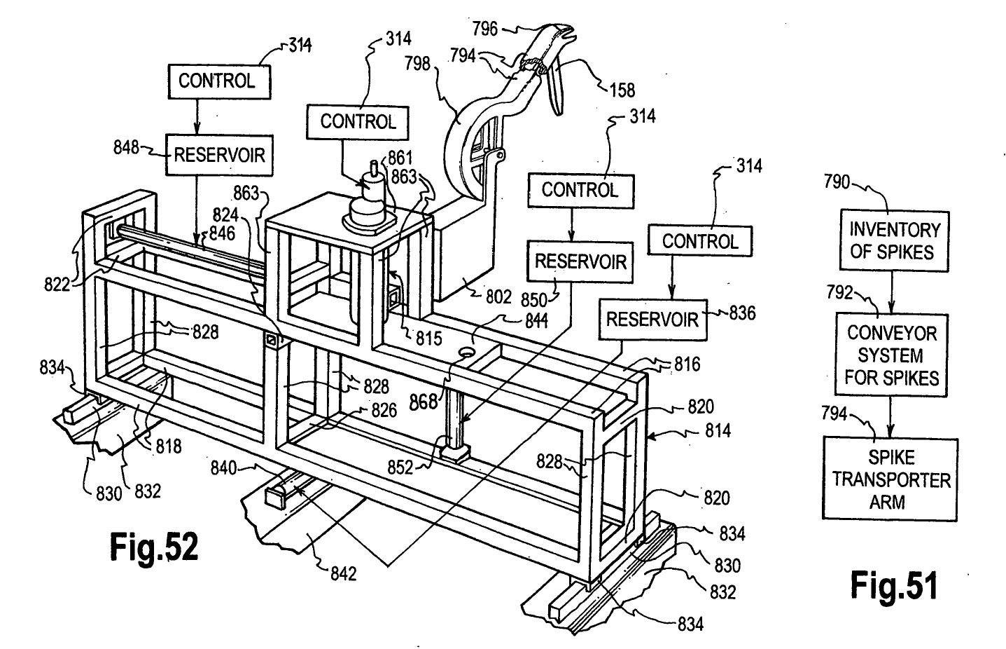

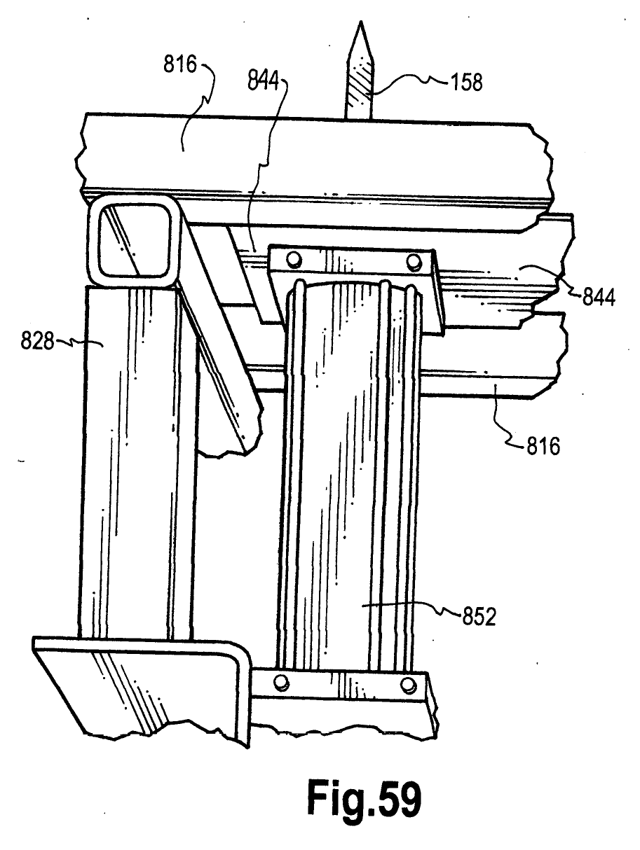

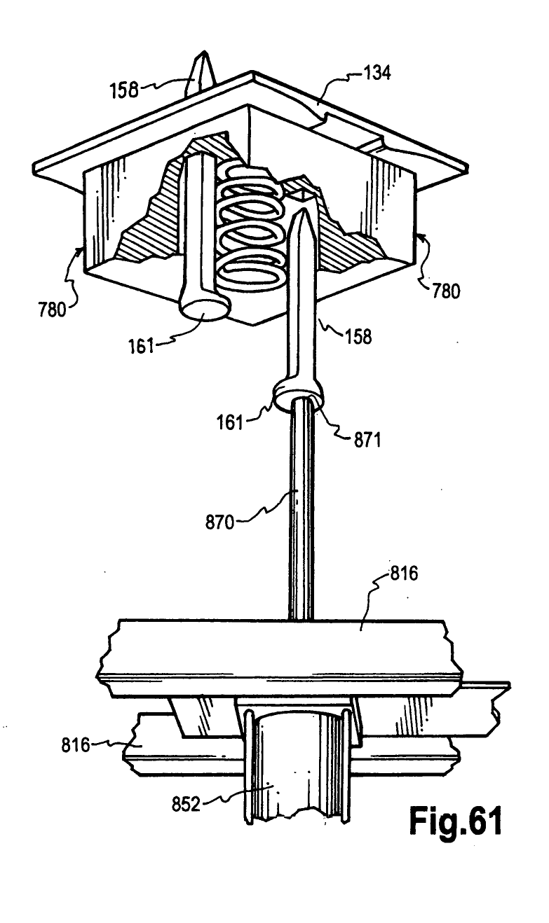

Reference is now made to FIGS. 51-61, which are directed to the processing of spikes 158 from inventory 790, followed by insertion of spikes 158 at two plate locations through apertures in spaced tie plates 134 into drill holes in a tie 102 accurately located at the plating and spike installation station 129. Initially, spikes 158 from inventory 790 (FIG. 51) are sequentially delivered to a conveyor system 792. It is preferred that the conveyor system 792 comprise one which is essentially the same or patterned after the plate-conveying system comprised of conveyors 597 and 630, shown and heretofore described in conjunction with FIGS. 40-44. The spikes 158 exiting from conveyor system 792 are sequentially received at a spike transporter arm 794, shown diagrammatically in FIG. 51 and physically in FIG. 52.

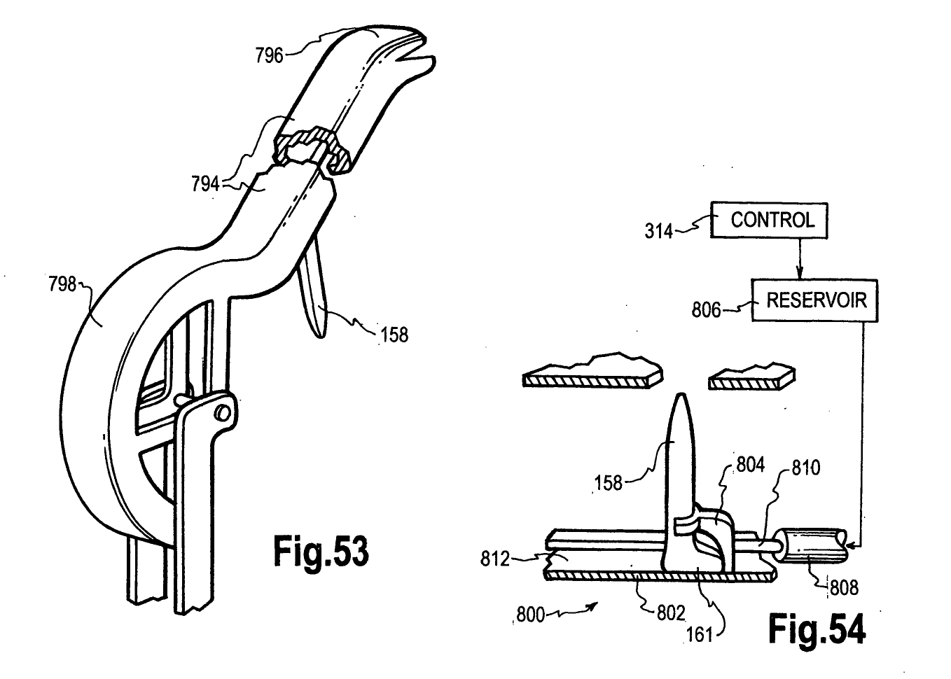

Sequentially, the spikes 158, at the heads 161, are successively displaced into the interior of an inclined arm 794, at bifurcated distal end 796. FIG. 52. The slope of the arm 794 and the interior configuration thereof allow the heads 161 of the consecutive spikes 158 to slide down an interior chute of the arm 794 and become inverted at a circular passageway, which is defined by arc 798. FIG. 53 shows one spike 158 as having traveled downward part way along the inclined arm 794 toward the semicircular spike-inverting pathway structure or arc 798. As a consequence, each spike 158, with the tip now up and the eccentric head 161 down, sequentially comes to rest as shown in FIG. 54, on a reciprocating tie delivery structure, generally designated 800, specifically engaging a carriage 804 for linear displacement along a transport surface 812 of spike-receiving structure 802. Note, the position of the eccentric head 161 of the spike 158 in FIG. 54 extends toward the rear, generally parallel to the displacement path.

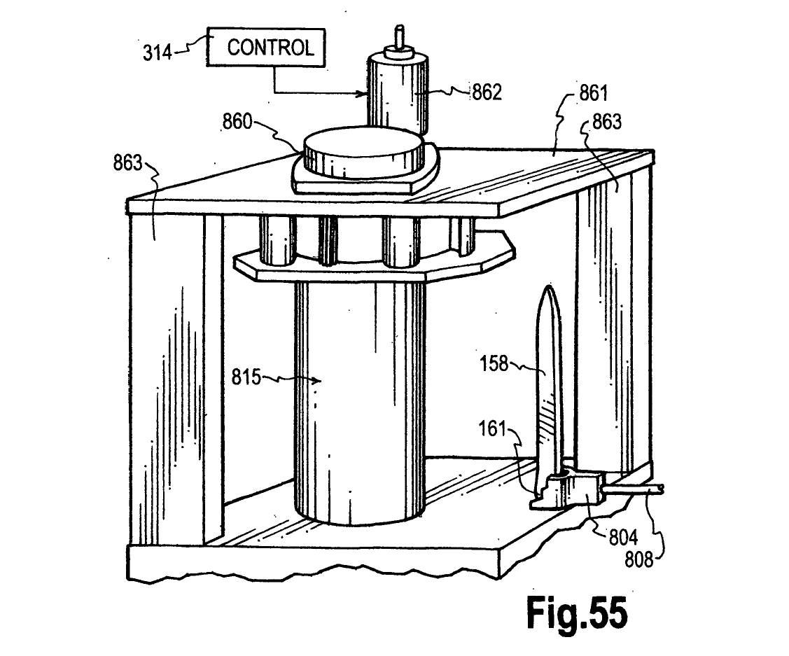

In the position shown in FIG. 54, the spike carriage 804 is shown as being sized and shaped so as to support and displace each spike 158 by reason of fluid displacement from a reservoir 806, under command of the control 314, to a two way cylinder 808 to thereby extend piston rod 810, together with carrier 804 and spike 158. The distal end of piston rod 810 is integrally attached to the carrier 804. Later, as explained in detail below, the reciprocating carrier 804, as the piston rod 810 is extended, is displaced along surface 812 toward a spike-receiving revolving cylindrally-shaped housing, generally designated 815. FIGS. 55-58. Once a spike is delivered to spike-rotating cylinder 815, carrier 804 and piston rod 810 are retracted by deactivation of cylinder 808.

With reference to FIG. 52, the spike-receiving cylindrical housing 815, the spike transporter arm 794, the spike insertion structure 800, and other structure, yet to be explained, are mounted on a displaceable but rigid box-shaped structural framework, generally designated 814. The framework 814 comprises two upper beams 816, which are parallel, but spaced from each other, and two lower parallel, but spaced beams 818. The upper beams 816 and the lower beams 818 are disposed in two parallel vertical planes. The beams 816 and 818 are integrally cross connected by end beams 820 and 822, as well as central upper and lower cross beams 824 and 826. Vertical columns 828, at each end, complete the framework 814. The structural members of the framework 814 are rigidly secured together so that the framework 814 moves as a unit, as explained hereinafter in greater detail.

At opposite ends, the framework 814 is mounted on two parallel spaced tracks 830, each mounted in the same horizontal plane on spaced beams 832, so as to be perpendicular to the length of the framework 814. At the underside of each end of the framework 814, toward the lower corners thereof, are a pair of downward directed U-shaped guides 834, which are aligned to allow the framework 814 to move rectilinearly along the two spaced tracks 830. This rectilinear displacement along tracks 830 is caused by fluid displacement from reservoir 836, under command of control 314, delivered to a fluid cylinder 840. FIG. 52.

The cylinder 840 is attached to a central stationary beam 842, at the top surface thereof, with the piston rod of the cylinder 840 rigidly connected, at its distal end, to the framework 814, allowing for to-and-fro displacement of the framework 814 to position the framework 814 in different positions to effectively and accurately place spikes 158 from revolving cylinder 815 into tie 102 through apertures in tie plate 134, as explained further below.

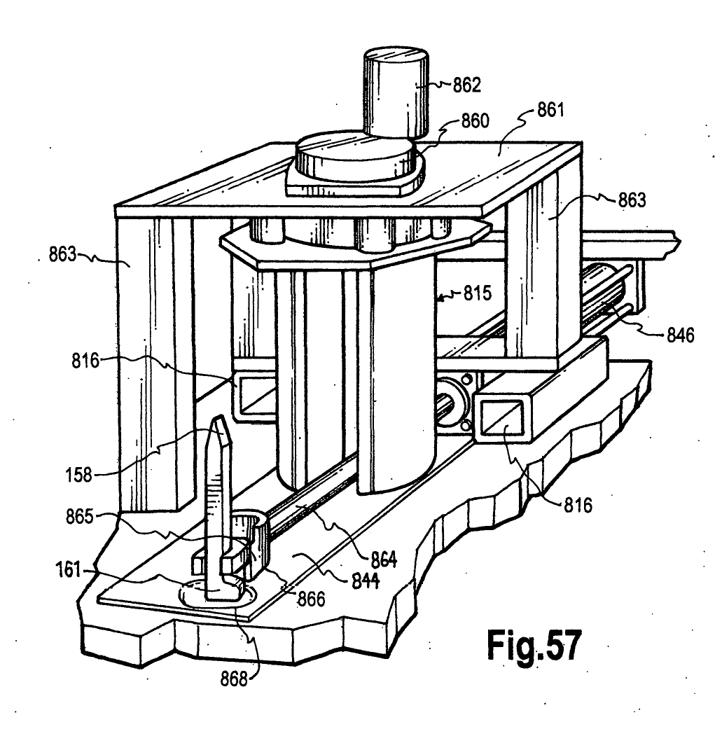

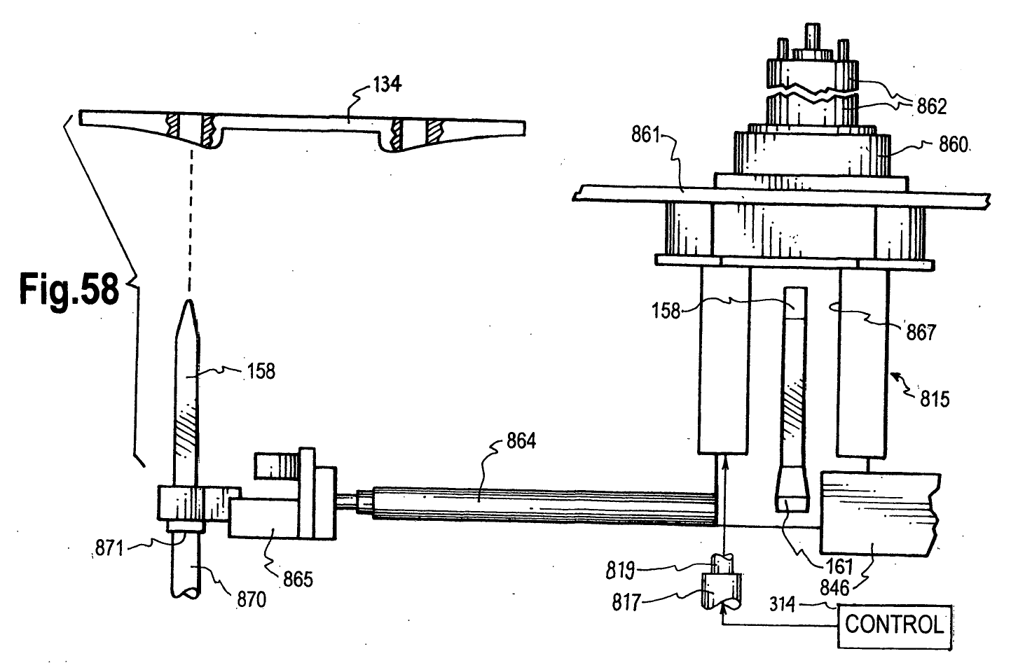

The top surface of beam 842 is in the same horizontal plane as the top surfaces of beams 832. Each spike 158 discharged from revolving cylinder 815 sequentially move linearly away from the cylinder 815 essentially parallel to beams 816. More specifically, the cylinder 815 causes each spike 158 to be sequentially issued therefrom onto a reciprocal tray 844. The cylinder 846 (FIG. 57) is located at one end of the spike tray 844 and the piston rod 864 thereof is connected to one end of tray 844 so that when the cylinder 846 is activated in one direction with fluid from reservoir 848, under control of the computer 314, this causes the associated piston rod 864 and the tray 844 advance forward (and later in reverse) from left-to-right, when viewed as in FIG. 52. Integral with the piston rod 864 (FIG. 57), at its distal end, is a cradle 865, which releasably holds each successively discharged spike 158, during the above-mentioned displacement. When the tray 844 is extended to its correct spike-insertion position, fluid from reservoir 850 activates cylinder 852 to extend the piston rod 870 thereof upward. FIGS. 51, 56 and 59-61. The piston rod 870 is elongated, the distal end of which contiguously engages the head 161 of spike 158, while the head of the spike 158 rests in recess 868 on the extended tray 844. FIGS. 57 and 58. This drives that spike 158 upwardly through an aperture in the tie plate 134 into the superimposed tie 102, as explained in greater detail hereinafter.

In continued reference to FIGS. 55-58, the revolving cylinder 815 is rotatably connected to gear box 860, which is driven by a motor 862. Motor 862 selectively rotates the cylinder 815, under command of control 314. The motor 862 is reversible and accommodates, in a slot or compartment 867, the loading of spikes 158 sequentially and then to incrementally reverse rotation to allow sequentially discharge of the spikes 158 onto the tray 844 and into the cradle 865 for displacement to the respective sites to be elevated above the aperture 868 of the tray 844 in the adjacent tie plate 134 and into the superimposed tie 102.

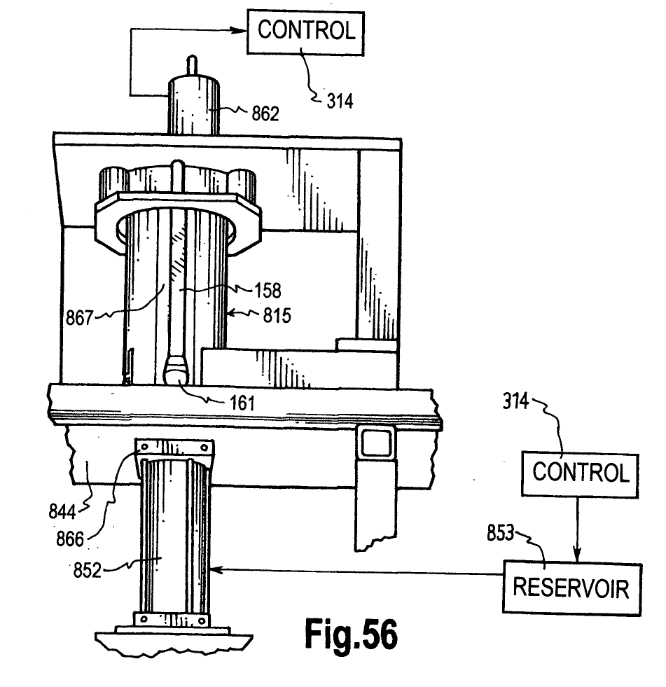

FIG. 55 shows the delivery of a spike 158, held in carriage 804, responsive to the extension of piston rod 810 to and into one of the chambers 867 (FIG. 56) in the spike-receiving revolving cylinder 815. One spike 158 is shown in one of the chambers 867 of the cylinder 815 in FIG. 56.

Reference is made to FIG. 55A, which, in perspective, illustrates delivery of a spike 158, with its head facing rearward parallel to the spike displacement path 811. Once the spike is positioned in the slot 867 of the rotating cylinder 815, the holder 804 is retracted along path 813 along with piston rod 810. Thus, the spike 158 temporarily rests on tray 844 in slot 867. FIG. 56.

Motor 862 and gear box 860 are activated so that the cylinder 815 and the spike 158 in slot 867 are jointly rotated through essentially 90°, thereby positioning the spike head 161 perpendicular to the spike displacement path so that the head 161 is correctly oriented for proper insertion through a plate aperture into a drill hole in the tie. FIG. 56.

When the spike 158 is to be discharged from slot 867 of cylinder 815 control actuates cylinder 817 causing piston rod 819 to extend thereby lifting the cylinder 815 a distance sufficient to avoid interference between the cylinder and the head 161 of the spike 158 as the spike 158 is discharged from the cylinder 815. FIG. 58. Once the spike 158 is discharged from the slot 867, control 314 cause the cylinder 815 to retract the piston rod 819 to lower the cylinder 815 into its initial position.

FIG. 56 also shows that the upper end 866 of cylinder 852 is integrally connected to the bottom of the spike displacement tray 844 below the recess 868 and, therefore, moves back and forth as the tray 844 moves back and forth. The piston rod 870, extending from the cylinder 852, extends upward is caused to pass through an aperture in a recessed portion 868 of tray 844, as explained in greater detail hereinafter. FIGS. 58, 60 and 61.

In reference to FIG. 57, the piston rod 864 of cylinder 846 is shown extended, with spike-carrying head 865 integrally carried at the distal end of the piston rod 864. Head 865 receives from cylinder 815 each spike 158 in sequence, the head 161 of which rests on the tray 844 in recess 868 and cradled in carrier 865. FIG. 57. The recess 868 has a central aperture therein allowing the piston rod 870, to move upwardly through the central aperture to first engage the head 161 of the spike 158 in the recess 868 and then elevated the spike 158 upward through an aperture in the associated tie plate 134 and thence into a drill hole in the elevated tie 102, the tie being positioned above the plate 134. FIGS. 58-61. The distal end 871 of the rod 870 maybe magnetized to hold each spike 158 at the top thereof as the spike 158 is elevated by the rod 870.

Once a spike 158 has been installed through an aligned aperture in a tie plate 134 into the body of the tie 102, the rod 870 is retracted, as is the rod 864, into their respective initial positions, preparatory to receiving an additional spike 158, head 161 down and properly oriented, from the revolving cylinder 815. To correctly position the next spike, the cylinder 840 (FIG. 52) is activated, shifting the framework 814 along rails 830 so that the cylinder 846 is directly in line with the next aperture in the mentioned tie plate to accommodate accurate placement of the next spike 158. The control 314 determines the lineal distance each spike 158 and the spike-displacement assembly must travel to be directly under the specific tie plate aperture where the next spike 134 is to be inserted.

The revolving cylinder 815, the gear box 860 and the motor 862 are mounted upon a support plate 861, carried upon columns 863, which are connected to and transfer their respective loads to the framework 814.

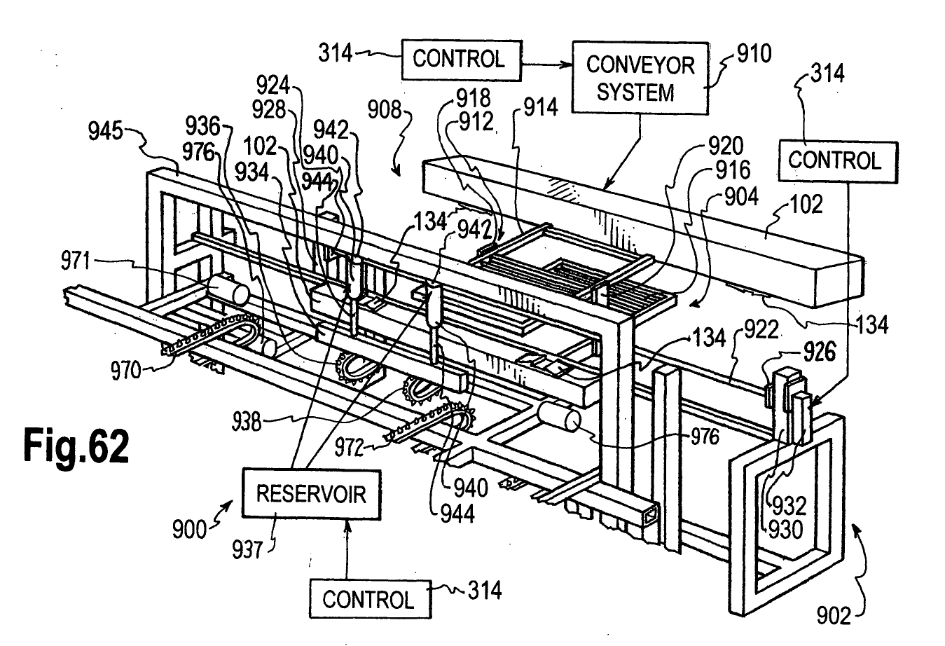

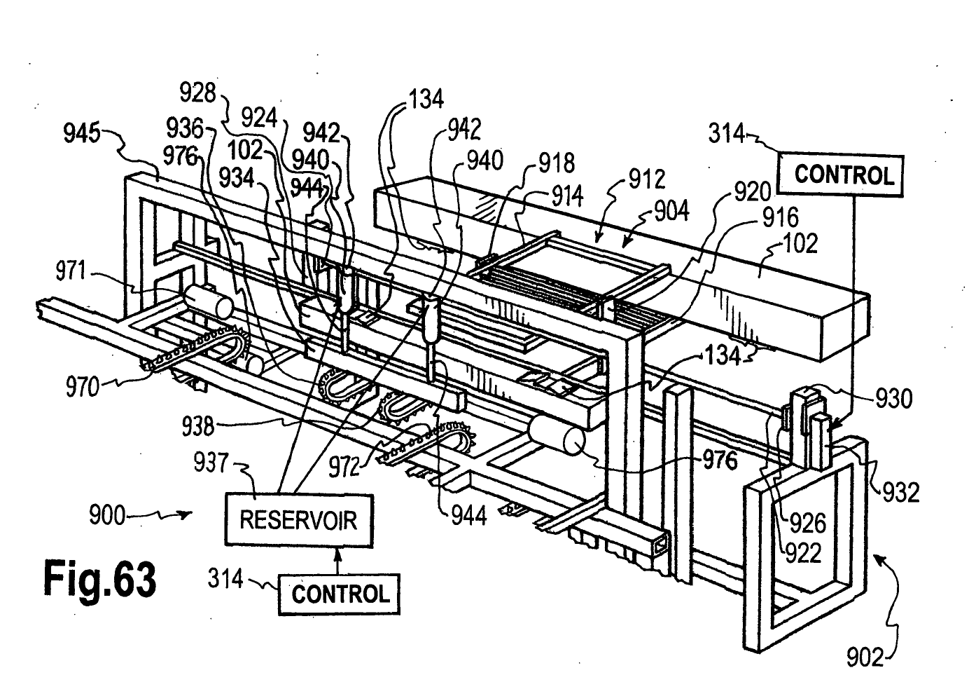

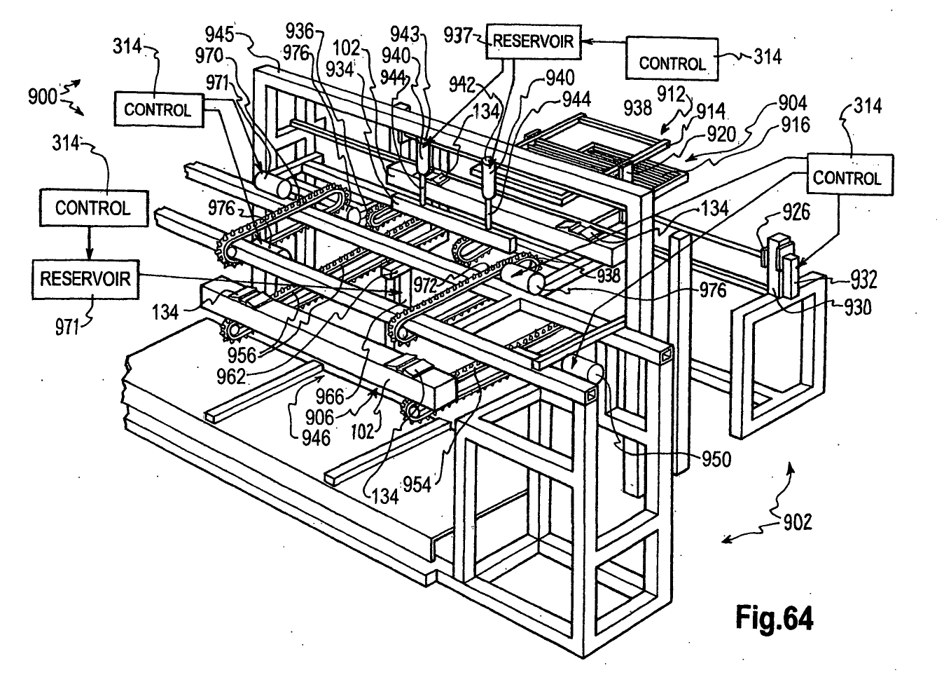

Reference is now made to FIGS. 62-65 and 65A-65C, which illustrate structure by which plated ties exiting the plating and spike installation 129 may be processed at a tie inverting and plated tie stacking station, generally designated 900. The station 900 is defined by a large ridged framework 902 comprising rigidly interconnected beams and columns, which support and accommodate the function of a tie inversion mechanism, generally designated 904 (FIG. 62), and a tie row forming station, generally designated 906 (FIG. 64). The frame 902 can be constructed in any number of structurally-adequate ways, all for the purpose of providing support, as mentioned above.

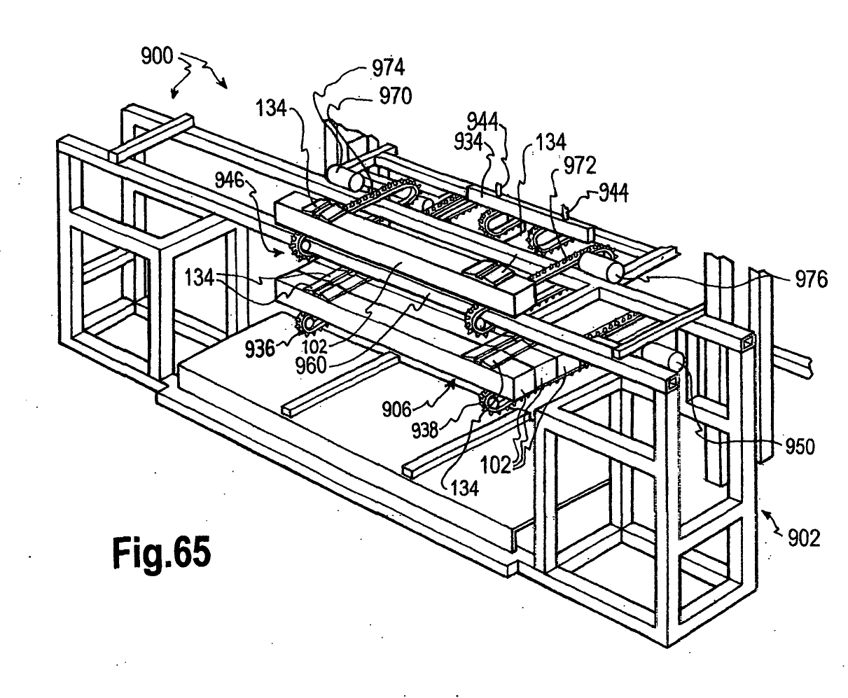

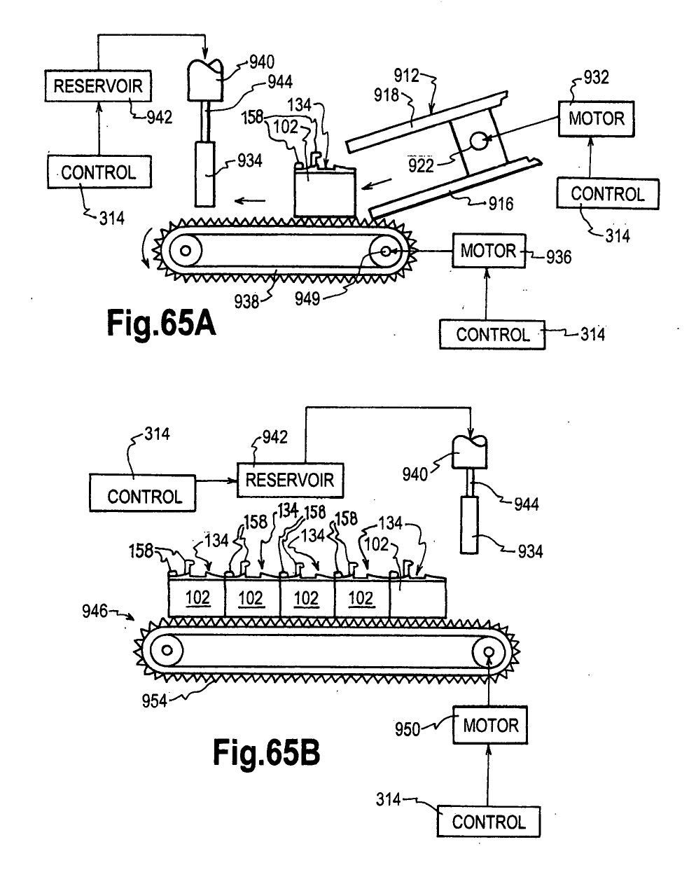

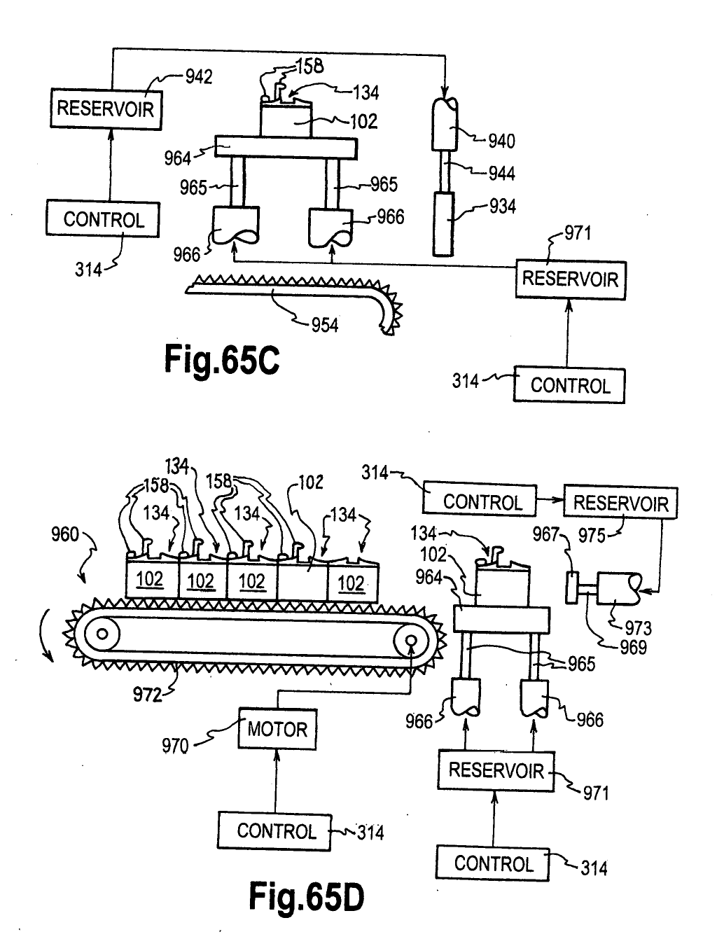

Ties 102, each with two plates 134 held by spikes 158 at the lower surface are displaced by a conveyor system 910 (FIG. 62) to a plated tie ingress site 908, under command of the control 314. Such ties 102 are conveyed, one at a time, to the ingress site 908, as shown in FIG. 62. Adjacent to the tie delivery site 908 is disposed a rack, generally designated 912. The rack 912 comprises a jaw-like mechanism comprising upper and lower rectangular frames 914 and 916, spaced one from another by a vertical distance somewhat greater than the height of the tie 102 to be received between the two frames 914 and 916. The width of the rack 912 is less than the two plates 134 on the tie 102. The two frames 914 and 916 are connected on each side by integral gusset plates 918 and 920. Thus, when the two frames 914 and 916 move, they move together. A drive shaft 922 is positioned for rotation at journaled ends 924 and 926, the journals being mounted on columns 928 and 930. Columns 928 and 930 comprise part of the framework 902. The shaft 922 is also non-rotatably connected to the gusset plates 918 and 920. Accordingly, when a reversible motor 932 causes the shaft 922 to rotate, under command of control 314, the shaft 922 and the tie-receiving rack 912 rotate counterclockwise, when viewed from the right in FIG. 62, carrying the inserted plated tie 102 located between the rack frames 916 and 918 through slightly more than 180 degrees of rotation. This inverts the tie 102 in a counterclockwise direction, as viewed in FIG. 62, and the tie 102 is discharged from the rack 912 by force of gravity. See FIG. 65A. The plates 134 on the inverted tie 102 are now facing upward. The tie 102 thus inverted travels with conveyors 936 and 938 until it abuts stop 934, at which time the conveyors 936 and 938 stop, under command of the control 314.

When it is desired that the tie 102 engaging the stop 934 comprise part of a lower row or tier 906 of ties 102 on the framework 902, two hydraulic cylinders 940 comprise piston rods 934 are activated with fluid from reservoir 942, under command of the control 314, so that the stop 934 is lifted a sufficient vertical distance to allow the tie 102 to pass under the elevated stop 934. More specifically, the cylinders 940 comprise piston rods 944, which are connected at their respective distal ends 942 to the stop 934 and the base 942 of each cylinder 940 is connected to a stationary cross-bar 945 of the framework 902 in rigid relation. The piston rods 944 are extended and retracted by fluid operation of the cylinders 940. Because the distal ends of the piston rods 944 are integrally joined to the top of the stop 934, when the piston rods 944 are retracted, the stop 934 is elevated and when the piston rods 944 are extended, the stop 934 is lowered into the position shown in FIGS. 64 and 65A.

The transverse stop 934 is disposed directly adjacent to each incoming tie 102 once the tie has been discharged from the rack 912. The pair of motor-driven knurled or spiked conveyors 936 and 938 are displaced by activation of a power drive 949 via motors 938, under command of the control 314, bringing the incoming plated tie 102 into contact with the stop 934 with the plates 134 on the top surface thereof up. When the stop is lifted by retraction of piston rods 944, the first tie 102 is displaced onto spaced knurled conveyors 954 and 956 to a lower row forming site 946. Knurled conveyors 954 and 956 are selectively displaced by motors 950 and 952, under command from control 314.

The orientation of incoming ties 102 is in the same horizontal plane as the ties being grouped as a row on a lower tier 946 of the framework 902, adjacent to tie row exit site. FIG. 64. When the stop 934 is elevated, as explained above, motors 950 and 952 are activated, under command of control 314, to rotate spaced knurled conveyors 954 and 956 to sequentially and incrementally displace each tie 102 into position to form the lower tier of ties 946. See FIG. 65B. Three ties 102 comprising a partial row at the lower tier 946 are shown in FIG. 65.

The next plated tie 102 is processed at the station 900 to a second tier 960 of plated ties 102, located in space relation above the first tier 946 of plated ties, with the plates up at both tiers. This is done by stopping an incoming tie 102 at the stop 934 and lifting the stop 934, in the manner explained above. Momentary activated conveyors 936 and 938 place the second tie 102 to a position above short beams 962 and 964. Thereafter, the tie 102 is elevated, using the two short beams 962 and 964. Beams 962 and 964 are respectively mounted at the distal ends of piston rods 965 extending from four hydraulic cylinders 966, two for each beam 962 and 964. The piston rods 965 which are directed upwardly. The base of each cylinder 966 is rigidly attached to frame 902. Accordingly, when the piston rods are extended, the cylinders 966 remain stationary. When the beams 962 and 964 are elevated, the top surface of each beam 962 and 964 engages the bottom surface of the second tie 102. This lifts the tie 102 upward so that it becomes horizontally aligned with the second upper tier 960. This position is shown in FIG. 65D. A tie push blade 967 is integrally connected to the distal end of a piston rod 969. The piston rod 969 extends and retracts by fluid activation of cylinder 973 from a reservoir 975, by command from control 975.

With the second tie 102 positioned as shown in FIG. 65C, the push blade 967 is advanced by extension of piston rod 969 to push the tie 102 from the two short beams 962 and 964 onto the top of knurled or spiked conveyors 970 and 972. Incremental rotation of conveyors 970 and 972 by motor 971, under command of control 314, will ultimately result in a contiguous row of ties on conveyors 970 and 972 at upper tier 960.

When the push blade 967 has so displaced a tie 102 onto conveyors 970 and 972 the push blade 967 is retracted into the position of FIG. 65D and the two short beams 962 and 964 are lower to their initial positions.

This process continues until there is a full row of plated ties 134/102, plates up, at both tie tiers 946 and 960, at which time, the rows of ties may be removed by a fork lift and stacked for future use, or in the alternative, dispatched to an automated railroad track prefabrication station by fork lift or on a conveyor. In lieu of delivering plated ties 102 alternatively to tier sites 946 and 960, an entire row of ties may be placed at one tier site before placement of plated ties at the second tier site.

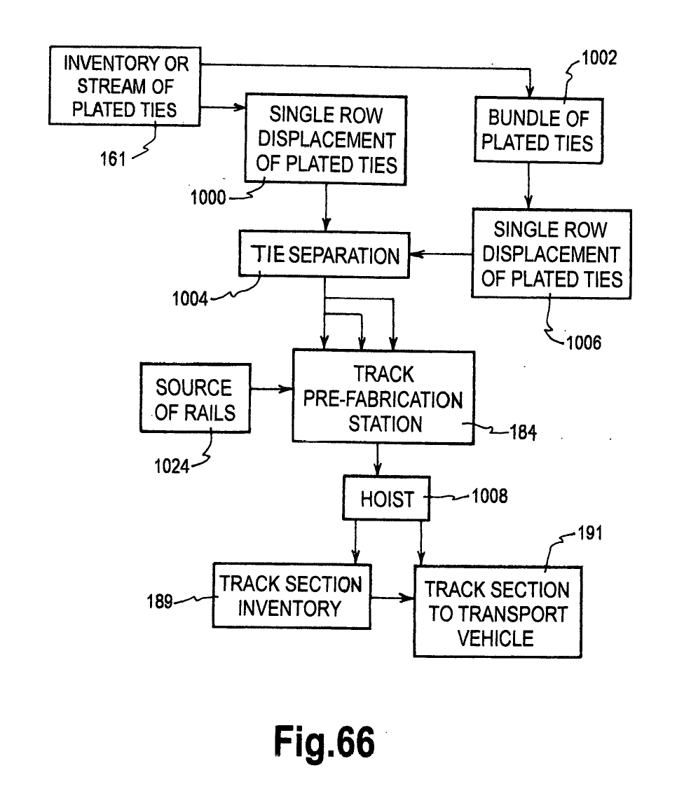

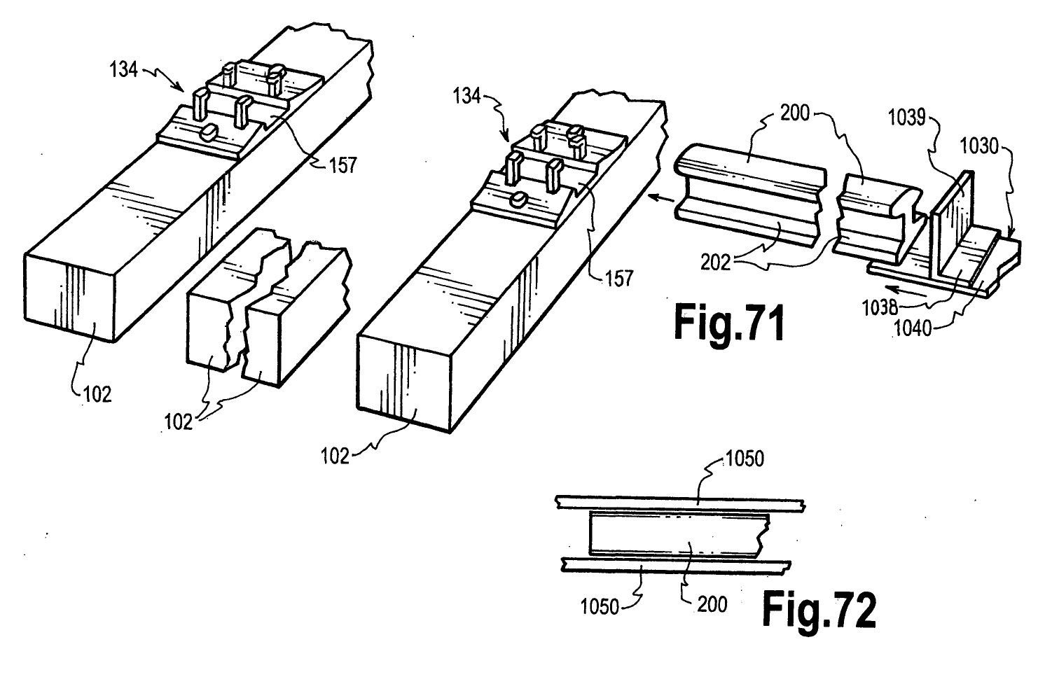

Reference is now made to FIGS. 66-74 in respect to the creation of a section of railroad track at the track prefabrication station 184. Plated railroad ties 102/134, with two plates 134 facing upwardly, are delivered from an inventory 161 or other source sequentially to a track section ingress site, where the ties, if not delivered from site 1000 in single rows, are displaced into single row configurations at sites 1002 and 1006. The ties 102 of each row are separated at site 1004 into spaced parallel ties 102. FIG. 66. The spaced ties 102 are next displaced into the track-forming area of the track prefabrication station 184 so as to preserve the parallel spaced relationship of the ties 102, where the spacial relationship equals the distance required between ties on an operative railroad line. Two spaced rails 200, each transversely aligned with one row of tie plates 134 spike-attached to the series of ties 102, are displaced from inventory 1024 (FIGS. 66 and 71) and conveyed along the central channels 157 of the respectively aligned plates 134 until accurately and correctly positioned, after which the rail spikes 158, previously partially inserted through apertures in the tie plates into the ties are fully inserted into their rail-retaining position.

Once the track section is completed, consisting of a desired number of plated ties and two secured rails 200, the track section is removed from the track prefabrication station 184 using a hoist 1008, such as a crane, a forklift or some other type of track section transport mechanism. At this point, the track section so removed from station 184 is either placed in inventory 189 or immediately loaded on to a transport vehicle 191 for delivery to an installation site comprising either a new railroad line or a railroad line being repaired. FIG. 66.

If a bundle 1002 of plated ties 134-102 is dispatched from inventory 161, rows 106 of the ties 102 may be sequentially displaced from site 10002 using the system heretofore described in respect to FIG. 25.

Thus, either way, a single row of ties becomes dispatched at tie separation site 1004, where the rows of side-by-side ties 102 may be separated utilizing the system heretofore described in respect to FIGS. 26-30.

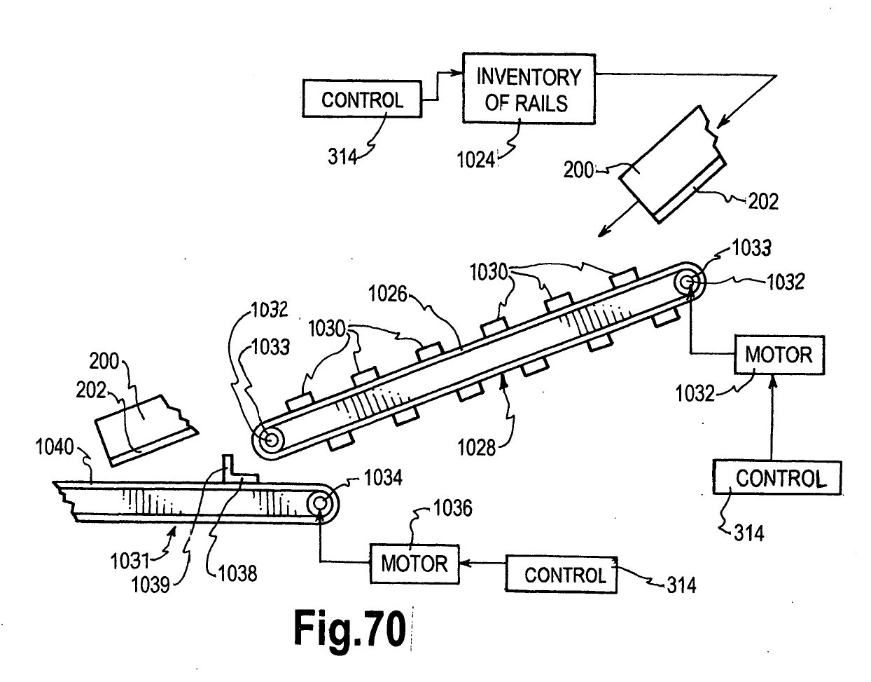

As is apparent from FIG. 66, more than one row 106 of separated parallel ties from site 1004 are preferable dispatched to station 184, because the track sections will typically comprise a plurality of separated parallel rows of ties. The displacement of ties from tie separation site 1004 to station 184 of parallel spaced ties emanating from site 1004 results in the displaced, separated ties arriving at station 184, preferable using the system shown and described in connection with FIGS. 29-30 for which no further description is required for an understanding on the part of one skilled in the art. At station 184, the separated ties 102 are displaced into position on knurled rolls 440. FIG. 70.

At the track-prefabrication station 184, it is important that the spacing between the parallel ties be equal to the spacing between ties on a railroad line and that the length alignment of the ends of the spaced parallel ties at station 184 be disposed in two spaced parallel vertical planes. This may be done using the spacing and alignment mechanisms disclosed in conjunction with FIGS. 33-36, especially where the rail spikes are fully driven before the placement of clips 230 takes place. However, by placing the clips 230 in the manner described in respect to FIGS. 18-21, before the rail spikes are fully inserted into the ties, provides sufficient parallel tie accuracy at the station 184. Again, the description found in conjunction with FIGS. 18-21 is incorporated herein by reference. Once the clips 230 have been installed on each rail between each adjacent ties, the rail spikes 158 may be fully inserted into the ties 102 so that the bottom flange 202 of each rail 200 is tightly secured to its associated tie plates 134, which in turn is firmly secured to the associated tie itself.

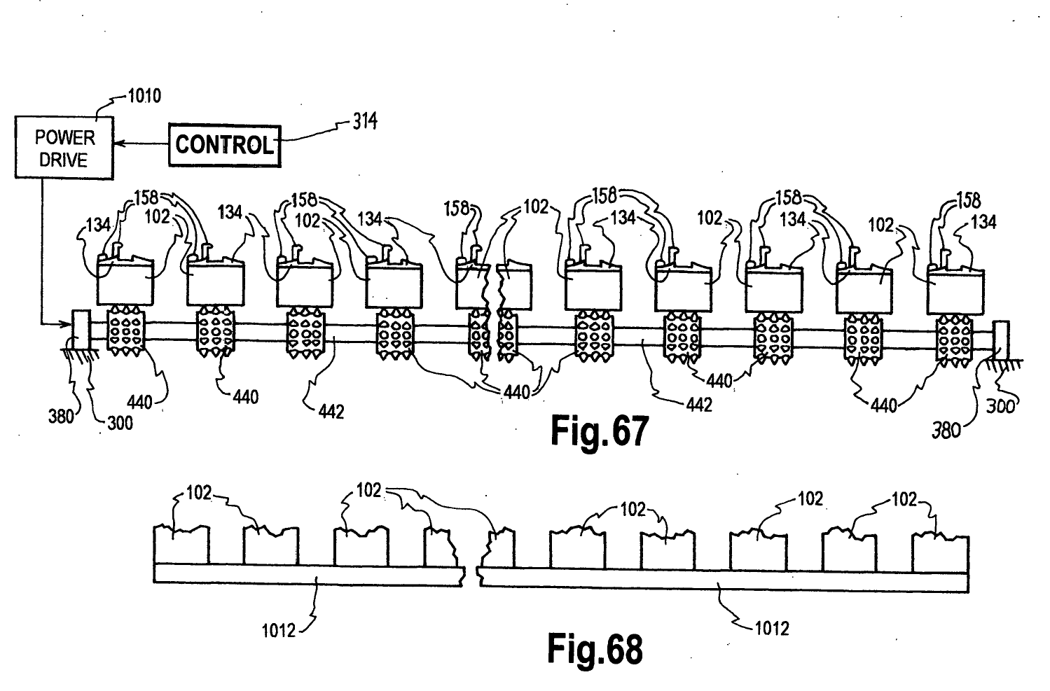

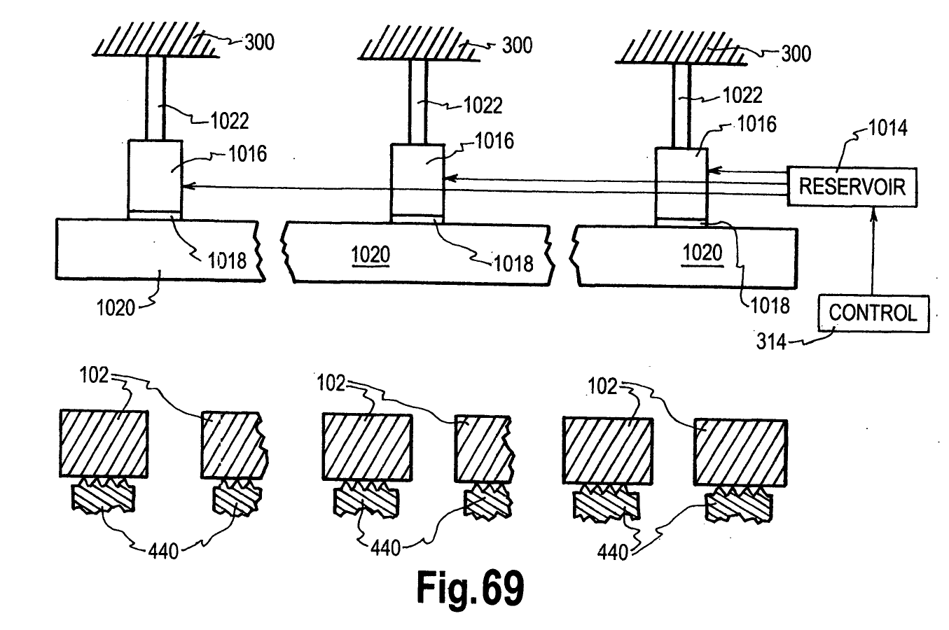

In reference to FIG. 67, a plurality of parallel spaced ties 102 are depicted with installed tie plates 134 secured to the top surface of each tie 102. The ties shown in FIG. 67 are displaced into their track assembly positions by a series of knurled or otherwise surface-abrasive rollers 440 non-rotatably and non-slideably attached to a series of power driven shafts 442, selectively rotated by power drive 1010, under command of control 314. Each shaft 442 is journaled at both ends 380, one end of which is power driven by drive 1010. When the shafts 442 are selectively rotated by drive 1010, the knurled rollers grip the underside of the parallel spaced ties 102 and displace those ties into station 184, until the leading end of each tie 102 is firmly contiguous with a stationary stop 1012. FIG. 68. At this time, under command of the control 314, the power drive 1010 discontinues rotation of the shafts 442, leaving the ties in the position illustrated in FIG. 68.

With the ties 102 at station 184 positioned as shown in the plan view of FIG. 68, under command of the control 314, a reservoir 1014 activates a plurality of cylinders 1016. FIG. 69. The base of each cylinder 1016 is attached at a mounting plate 1018 to the top of a force-applying beam 1020. Each cylinder 1016 is equipped with a piston rod 1022, the distal end of which is rigidly anchored in stationary relation to the frame 300. Thus, when the cylinders 1016 are activated by fluid from reservoir 1014 so as to extend the piston rods 1022, the cylinders 1016 and the pressure-applying beam 1020 move collectively downward until the top surface of each tie 102 at the station 184 is forceably engaged by beam 1020 to prevent the ties 102 from moving as two rails 200 are inserted along the series of aligned tie plates 134 found at two spaced locations on the top of the ties at station 184. In this position, the space between adjacent ties at station 184 remains the specification distance required for spacing between ties on a railroad line.

In reference to FIG. 70, adjacent to the station 184 is located an inventory 1024 of rails 200, which, under command of the control 314, dispenses parallel rails, two at a time. This dispensing of parallel rails 200 is illustrated as being inclined to the horizontal so that such displacement is aided by force of gravity, causing each pair of rails 200 so issued from inventory 1024 to engage and become located adjacent to the top surface 1026 of a belt conveyor 1028. The belt 1026 is rotated counterclockwise as viewed in FIG. 70. A plurality of abrasive bars 1030 are integrally connected to the belt 1026 and moved therewith to grip the underside of the two flanges 202 of each rail 200, causing each pair of rails to be displaced along the conveyor 1028, with the rails 200 being discharged from the inclined conveyor 1028 onto a generally horizontal conveyor 1031.

The conveyor 1028 is mounted upon shafts 1032 comprising sprockets or pulleys at each end, with the upper sprocket or roller 1033 being selectively driven by motor 1032, under command of the control 314. Likewise, conveyor 1031 comprises journaled shafts 1034 at each end with one being selectively driven by motor 1036, under command of the control 314.

Once the pair of spaced rails have been discharged from conveyor 1028 onto conveyor 1031, the trailing end of each rail is engaged by a vertical leg 1039 of an angle iron 1038, which is disposed transverse of the conveyor 1031. FIGS. 71 and 72. The horizontal leg of the angle iron 1038 is rigidly attached to the belt 1040 of the conveyor 1031 so the vertical leg extends into the air for half of its rotation. Thus, the conveyor 1031 pushes the two parallel spaced rails 200 at their proximal ends toward the track prefabrication station 184.

Continued displacement of the conveyor 1031, with the push blade 1038 integrally transversely connected to the belt 1040, pushes the two parallel rails 200 fully into the station 184, each rail 200 being aligned with and ultimately resting upon the two series of tie plates 134 at the station 184. This alignment is such that the push blade 1038 pushes the two rails 200 along the two sets of plate channels 157, until the rails are properly superimposed on channels 157 along the two series of tie plates 134, at which time the motor 1036 discontinues rail displacement. During this interval, the cylinders 1016 and piston rods 1022 hold the beam 1020 firmly across the top surfaces of all ties 102 at the station 184 to prevent misalignment of the ties 102. FIG. 69.

As the two rails 200 are so displaced into station 184, parallel guides 1050, disposed on each side of each incoming rail 200 ensure lineal displacement of the rails 200. FIG. 72.

Once the rails 200 are correctly positioned at station 184, the control 314 causes both the motors 1032 and 1036 to discontinue rotation until such time as the track section being assembled at station 184 is removed as a completed track section from the station 184.

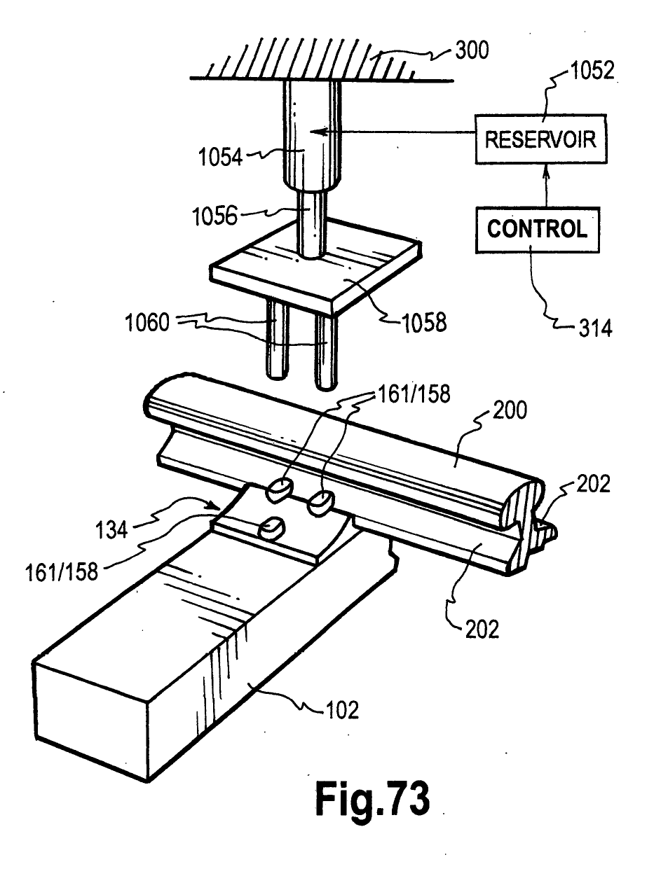

Reference is made to FIG. 73. With the rails 200 properly superimposed on the tie plates 134, under command of the control 314, fluid from reservoir 1052 is delivered to each of a series of cylinders 1054, the base of each being anchored to frame 300, to extend the associated piston rods 1056. The distal end of each piston rod 1056 is integrally and stationarily joined to a plate 1058, from which two rods extend downwardly. When each piston rod 1056 is so extended, the associated plate 1058 and the associated rods 1060 move downwardly. The rods 1060 are located so as to be vertically above the heads 161 of the two partially inserted rail spikes 158. Accordingly, when the distal ends of the rods 1060 forcibly engage the partially inserted rail spikes 158, the rail spikes are pushed into a fully inserted position, with the eccentric heads 161 firmly engaging the adjacent top surface of the adjacent bottom flange 202 of the associated rail 200, as shown in FIG. 73.

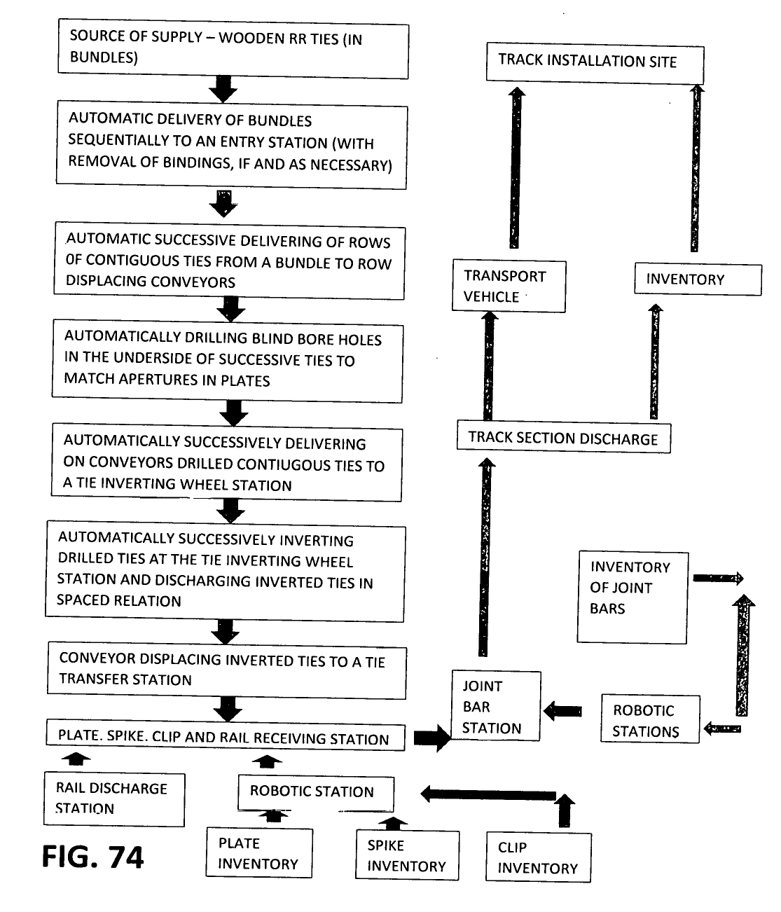

Reference is now made to FIG. 74, which illustrates a further embodiment of the present invention, wherein a source of supply of wooden railroad ties in bundles is provided. The bundles are transported, one-after-another to an entry station for ties. If the bundles are banned together, the binding are removed.

Once a bundle is disposed at the entry station, the rows of ties on the top of the bundle are successively displaced from the bundle, with the ties in side by side contiguous relation onto spaced conveyors, which are incremental driven consistent with drilling, plating, spiking and clipping requirements. The rows of ties so displaced in succession onto spaced conveyors are disposed perpendicular to the processing path.

The contiguous row of ties is moved by the spaced conveyor to a drilling station, where six blind bore holes at two spaced sites on the ties are drilled from beneath in an upward direction. At the time of drilling, the tie at the drilling station is caused to be spaced from the other ties of the row so as to accommodate holding the tie stationary as drilling takes place. The two arrays of blind bore drilled holes are accurately located so as to respectively receive a tie plate over each blind bore drill holes to accurately define the gauge of a track section, as hereinafter more fully disclosed. The drilling of each tie at the drilling station is presently preferred to be one tie at a time.

When the entire contiguous row of ties has been drilled, as described above, the spaced ties travel on the two spaced conveyors to a tie inversion station, where a rotating wheel receives the ties are discharged from the wheel one-after-another, so that each tie is rotated and inverted through essentially 180 degrees so that the blind bore drill holes face upwardly. Furthermore, as the inverted ties are discharged from the inversion wheel by centrifugal force aided by gravity, the ties so discharged remain spaced one from another a desired distance.

The spaced conveyors, thereafter, displace the spaced ties, blind bore drill holes up, to a tie transfer station. For each tie, the spaced conveyors are stopped, the ties are individually transversely displaced from the spaced conveyors onto a plate, spike, clip and rail-receiving station for the purpose of refabricating a section of railroad track.

Two spaced rails, disposed at a rail discharge station are positioned at that station so as to be spaced one from another at the desired gauge, using vertically-oriented rollers engaging the gauge flange of both railroad rails and outside stationary vertically-extending bars constraining against displacement of the rails except for parallel lineal movement. The bottom of the lower flange section of each rail is contiguously engaged by drive rollers, each of which is sloped downwardly toward the gauge side at an angle equal to the slope of the channel in the tie plates. Thus, when the rails are later displaced over installed tie plates on ties, as explained hereinafter, both the rail and the channel of the plates are at the same angle or slope. The rails are incrementally displaced in parallel relation by the motor-driven lower rollers, as required for placement on plated ties used to form a railroad track section.

For each tie, displaced from the tie transfer station to the plate, spike, clip and rail-receiving station, robots are provided which obtain, respectfully, plates from inventory, spikes from inventory and clips from inventory. The plates are accurately robotically positioned directly over the upwardly directed blind bore drill holes at two sites on each tie. Preferably, at least three spikes are robotically delivered to locations directly above the tie plate apertures and the spikes are then displaced downwardly through the tie plate apertures into the blind bore drill holes in the ties so as to secure the plate, in each case, to the tie and to secure the two rails, which have been advanced over the tie plates into firm retained relationship. Two spaced tie retaining clips are robotically placed on the lower flanges of each rail between adjacent ties so that the spacing between these ties is both established and retained as track sections are created and are transported to an installation site.

In addition, joint bars from inventory are robotically delivered to the distal end of the two track section rails, where one is bolt-secured to each rail so as to extend beyond the rail. The joint bar extension beyond both rails accommodates bolting of one track section to another track section in the field, at an installation site.

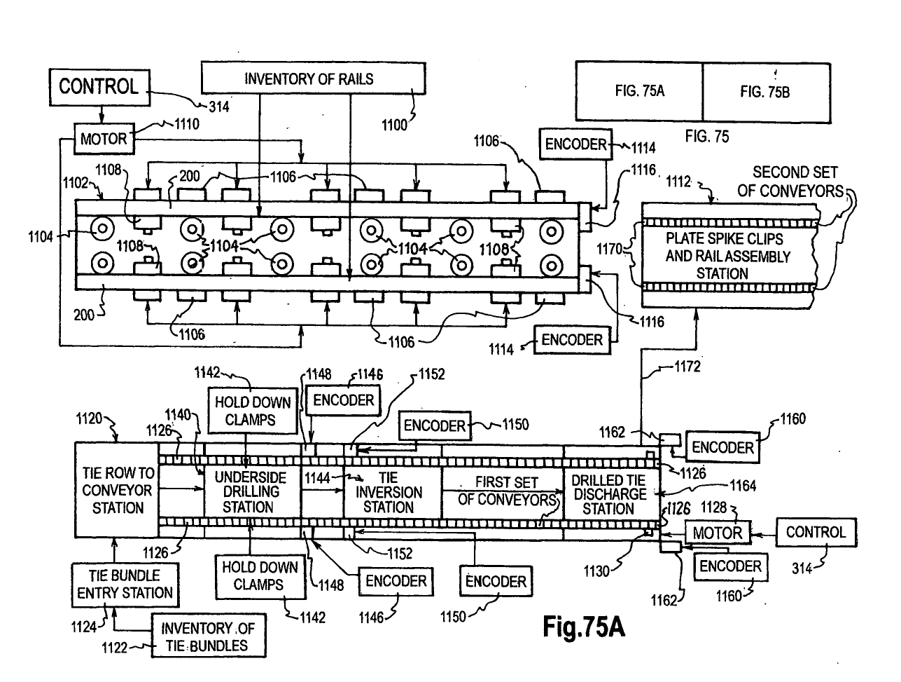

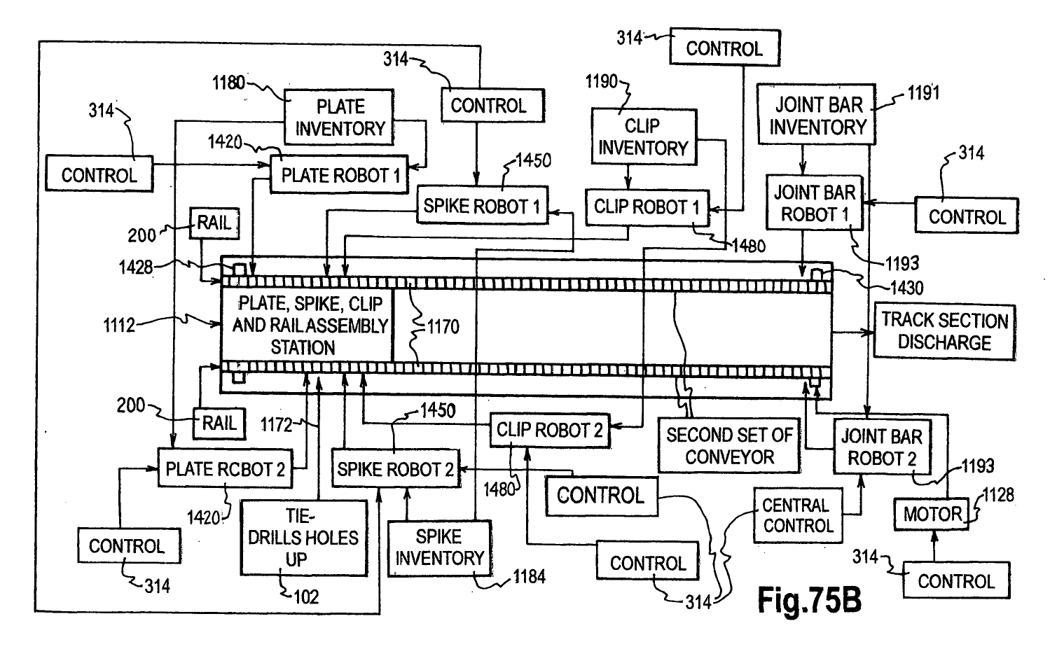

For further descriptive information in respect to FIG. 74, reference is now made to FIGS. 75, 75A and 75B. From an inventory 1100 of railroad rails, two individual rails 200 are dispatched to a rail entry station 1102. This may be done in any suitable way, such as utilization of a fork lift for each rail 200. The two rails 200 are positioned in space relation at the rail entry station 1102, as shown diagrammatically in FIG. 75A. The rails 200 are placed and retained in spaced parallel relation at station 1102, held against lateral movement inwardly by spaced vertical rollers 1104 and lateral outward movement by spaced vertical guides 1106. Both the rollers 1104 and the guides 1106 remain fixed at station 1102, except for rotation of rollers 1104. Thus, as the two rails 102 are displaced from left to right, as shown in FIG. 75A, the field edge of the rails slide along vertical guides 1106 and cause rollers 1104 to rotate by reason of engagement with the rail gauge flange, as the rails are so displaced.

Each rail at station 1002 is supported upon a series of rollers 1108, each of which is contiguous with the bottom surface of the flange of the associated rail. Rotation of rollers 1108 is by motor 1110, under command of the control 314, which causes the rollers 1108 to power rotate. Since the rails 1102 rest contiguously upon the rollers 1108, rotation of the rollers 1108 displaces the rails 1102 from left to right, as viewed in FIG. 75A. As explained herein in greater detail, the rotation of rollers 1108 is incremental, meaning that the rollers 1108 are rotated by motor 1110 for only a short time, allowing the rails 102 to leave the station 1102 in steps.

The surface of each roller 1108 is slightly sloped or at an angle in respect to the horizontal, that angle equaling the slope of the channel 157 of the railroad plates 134 on which the rails ultimately are placed. To be clear, the slope of the shafts upon which the rollers 1108 turn and the rollers 1108 themselves are inclined from the field side to the gauge side, in other words inwardly toward the center between rails 102.

The destiny of the rails 102, by reason of the above-mentioned incremental displacement, is to be successively positioned on top of tie plates, with the plates spike secured to ties, and to which clips are added, as explained hereinafter in greater detail.

The incremental advancement of the rails 102 at and from station 1102 is controlled by two commercially available optical encoders 1114, which sense the movement and location of the rails 200, at any given point in time, and cause associated pop up stops 1116 to elevate at the appropriate point in time to stop displacement of the rails, thereby assuring the correct positioning of the rails 200 at the end of any incremental advancement. At the same time, under command of the control 314, the motor 1110 is disabled, consistent with rail stoppage, to be re-enabled once an additional incremental displacement of the rails 200 is appropriate.

With further reference to FIG. 75A, adjacent to the station 1102 is a tie row-to-conveyer station 1120. Bundles of ties from inventory 1122 are sequentially transported to a tie bundle entry station 1124, from which rows of ties from the bundle are displaced to station 1120. Tie bundles may be of any suitable size for example, three rows of five ties each.

Once a row of ties is disposed at station 1120, the entire row is located on and incrementally displace along a first set of spaced parallel conveyors 1126. The displacement of each successive row of ties, with the ties contiguous one with another, is incremental, with the ties being disposed perpendicular to the displacement path defined by the spaced conveyors 1126. Preferably, the conveyors 1126 comprise log chain conveyors, where the ties rest directly on the top of the links comprising the chains, without the need for knurled or serrated chain surfaces.

The incremental displacement of transversely-disposed ties on conveyors 1126 is controlled by motor 1128, under command of control 314. The conveyors 1126 are displaced around a distal power driven shaft 1130, with a proximal idler shaft accommodating rotation of the two conveyors 1126 at the proximal end. Thus, the motor 1128, under control 314, will periodically rotate the drive shaft 1130, stopping the shaft 1130 and the conveyors 1126, at precision stationary points, as explained herein in greater detail.

The motor 1128 is disabled and the conveyors 1126 are caused to stop near an underside drilling station 1140. At this location, the ties of the lead row of ties is spaced from the other ties of the row, to accommodate holding the tie accurately stationary during drilling in an upward direction. Each tie sequentially drilled from the bottom up is caused to be so separated from the remainder of the ties of the row. Twelve blind bore drill holes are drilled in the lower surface of each tie, six at two spaced locations, i.e. precisely where two tie plates will ultimately go. The depth of the blind bore drill holes may be determined by those skilled in the art, five inches typically being suitable. As the ties 102 are sequentially upwardly drilled at station 1140, several hold down clamps 1142 accurately retain the ties in a stationary position to produce the twelve blind bore drilled holes, six at each of the above mentioned two locations. Upward drilling is advantageous in that gravity tends to empty drill shavings from the blind bores, the weight of the tie tends to help hold the tie in place, and emptied drill shavings may be easily disposed of, for example on a separate conveyor under the drill station. After the first tie of the row is so drilled, the motor 1128 incrementally advances the conveyors 1126 and the next tie in the row is spaced from the row and drilled in like manner at station 1140. Thus, when all of the ties of the row at station 1140 have been drilled in like manner, the motor 1128 further increments the conveyors 1126, bringing the row of spaced ties forward to a tie inversion station 1144.

With further reference to FIG. 75A, the stop and go displacement of the row of ties on conveyors 1126 to station 1140 and, thereafter, on an incremental basis within the station 1140, is controlled by two optical encoders 1146, which respectively enable and disable pop-up stops 1148. This is done under command of the control 314, in coordination with the enablement and disablement of motor 1128, which displaces conveyors 1126.

When the row of spaced ties arrive at tie inversion station 1144, such is detected by encoders 1150 causing stops 1152 to be enabled appropriately bringing the conveyors 1126 and the row of ties resting thereupon to an accurate stop. At tie inversion station 1144, an inversion wheel, hereinafter explained in greater detail, receives and, rotates the ties sequentially in a distal direction, causing the drilled bottom surface of each tie to become the top surface. This places the blind bore drill holes facing upwardly, rather than downwardly. The ties are separately and sequentially so inverted at the station 1144 and are discharged from the inversion wheel in spaced relation, each discharged tie resting upon the top of conveyors 1120, as the conveyors are caused to be incrementally displaced by motor 1128, under command of the control 314. As the spaced row of ties arrives near the distal end of the conveyors 1126 at the drilled tie discharge station 1164, such is detected by optical encoders 1160, which activates pop-up stops 1160 thereby bringing the spaced chain conveyors 1126 to a stop.

The encoders 1114, 1146, 1150 and 1160 may comprise Model H20, manufactured by BEI Sensors.

Thereafter, ties are displaced lengthwise (transverse to conveyors 1126) in succession from the drilled tie discharge station 1164 to a plate, spike, clip and rail assembly station 1112, so as to rest upon a second set of log chain conveyors 1170, at the proximal end thereof, for purposes later to be explained. This displacement is diagrammatically illustrated at line 1172 in FIG. 75A.

With specific reference to FIG. 75B, as mentioned before, the rails 200 are sequentially delivered to the plate, spike, clip and rail assembly station 1112 from station 1102, so as to rest upon previously placed spike-secured plates on the top of each tie at the proximal end of two spaced chain conveyors 1170. That is to say, a tie, with drill holes up, must first be delivered to station 1112, plated, and partially spiked before the rails 102 are incrementally brought forward along the channels 157 of the two plates 134, with the lower flange of both rails sloped downwardly toward the gauge side consistent with the slope of the channels of the plates. The rail-securing spikes are initially only partially inserted through plate apertures into the drill holes, while the plate-securing spikes are fully inserted through plate apertures into the drill holes in the ties.

Once a tie, with drill holes up, has been received at station 1112 perpendicular to the space conveyors 1170, two plates from inventory 1180 are magnetically retrieved by two plate robots 1182, one on each side, under command of control 314, and accurately placed in superimposed relationship over the two sets of six blind bore drill holes exposed at the upper surface of the tie 102 at station 1120.

Thereafter, spikes from inventory 1184 are magnetically retrieved by spike robots 1186, under command of control 314, typically in groups of three. These three spikes are magnetically carried in correct space relation by robots 1186, so as to be first positioned over three of the apertures in each plate 134 and thereafter forced inserted by robots 1186 through the plate apertures into the aligned blind bore drill holes until the rail-retaining spikes are partially inserted and the plate-retained spikes are fully inserted. Of course, more than three spikes may be inserted at each plate location, as determined by those skilled in the art. Where three are used, two are rail-retaining spikes, one on each side of the associated lower rail flange and one is a plate-retaining spike, holding the plate firmly against the tie. After the rails are correctly positioned on the two plates, the rail-retaining spikes are fully inserted by spike robots 1186.

Tie spacer clips are retrieved from inventory 1190 by two robots 1192, under command of control 314, and are transversely force inserted on the lower flanges of both rails, as hereinafter more fully explained, to accurately and correctly establish the spacing between ties of the track section being assembled. In this embodiment, it is presently preferred that two clips, placed accurately in space relation, will establish and retain the spacing between ties after being force-fit around the lower flange of each rail, as hereinafter more fully explained.

Once a tie has been plated and spiked, as well as receiving the two rails and correctly spaced clips, that tie is advanced by conveyor 1170 powered by motor 1128, under command of control 314, a distance equal to the spacing between ties required for a section of railroad track. At the same time, the rails are displaced through the same distance by rollers 1108 powered by the motor 1110, under command of control 314. This sequence continues, tie-after-tie. Thus, as one completed tie is plated and spiked so as to be firmly associated with both the tie and the rail, the rails and the associated ties are incrementally moved forward by the space required between ties. At this point another tie is perpendicularly inserted along path 1172 into station 1112 and the process is repeated.

Ultimately, sufficient ties have been so processed and the rails have been so advanced that a section of track has been completed and rests upon conveyors 1170. Typically, such a track section may comprise 40 feet of track, weighing on the order of 1,100 pounds. This allows for facile removal of the track section from the conveyors 1170 for placement in inventory or on a transport vehicle and from thence to a track installation site. Typically, at one end of the track section, the rails may extend 25 inches beyond the last tic.

But before a track section is removed, a joint bar for coupling rail sections together is delivered to and fastened to the distal end of the rails comprising the track. Also, joint bars may be coupled between rails at intermediate portions of the track section, as determined by those skilled in the art.

More specifically, from inventory 1191 two joint bars at a time are removed by joint bar robots 1193, under command of control 314. FIG. 75B. The joint bars may be 32 inches long and pre-drilled, as are the distal end of each rail. Each joint bar may have reinforcing ribs. This is done magnetically. The joint bars are positioned at the distal end of each rail, the rails and the bar joints, respectively, providing align apertures for receiving correctly-sized machine bolts, at at least two rail locations, to secure the joint bars and the rails together. The joint bars, once installed, extend beyond the distal end of the two rails and will have at least two additional apertures in the extension through which machine bolts may be later placed to connect and hold two adjacent track sections together at an installation site.

Once a track section has been removed from the conveyors 1170, using suitable lifting device and either placed in inventory or on a transport vehicle, the process of forming the next track section begins.

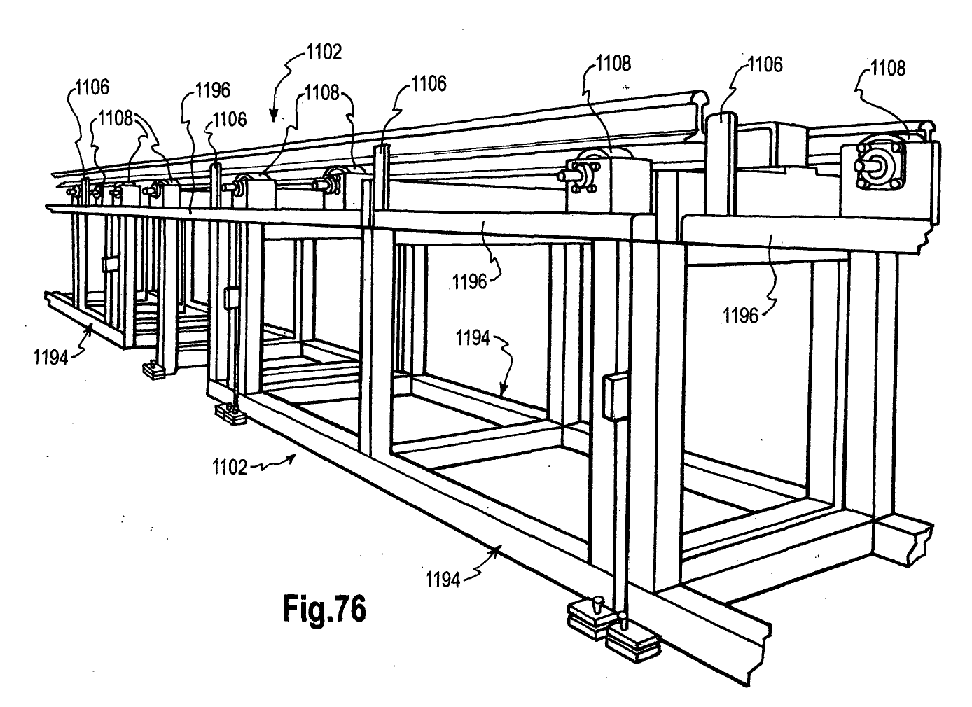

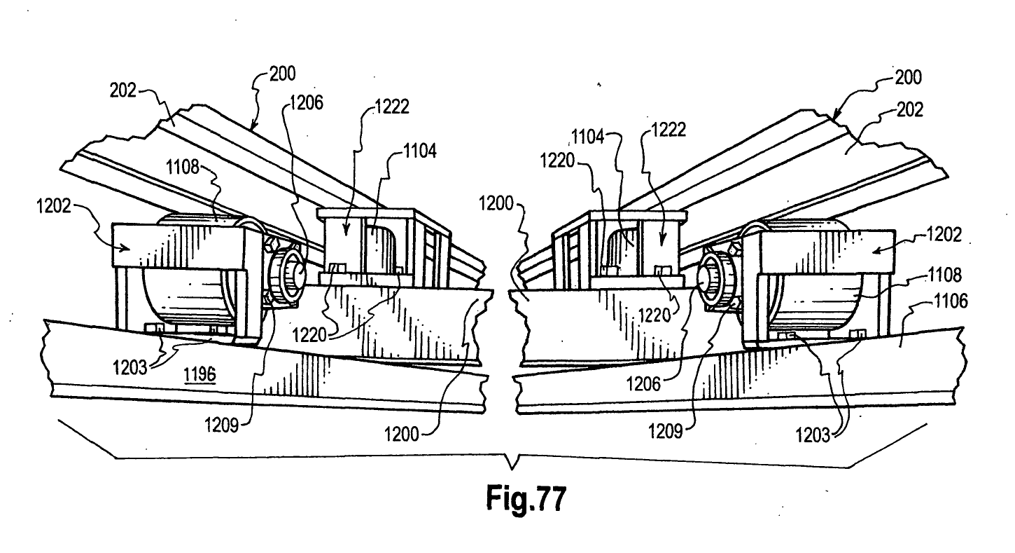

Reference is now made to FIGS. 76-78 for purposes of providing an enlarged disclosure concerning the rail discharge station 1102. As shown in FIG. 76, the rail discharge station 1102 provides an elevated site which extends generally in a horizontal direction. The rail discharge station 1102 is supported by a sectionalized structural support, generally designated 1194. Since the structural support 1194 may comprise any number of configurations, no extended detail description of the support sections 1194 is deemed necessary. However, collectively, the support sections 1194 provide two parallel sets of horizontal beams 1196, which support the two rails 200 and the rail-displacement mechanisms, as explained below. The previously-mentioned vertically guides 1106 are originally mounted at their lower ends to the outside surface of the horizontal beams 1196, as by welding, and rollers 1108 are supported and held in place by the horizontal beams 1196. Each pair of rollers 1104 is supported on cross beams 1200, at an elevation above the rollers 1108. The rollers 1104 are supported by beams 1196, as best shown in FIG. 77.

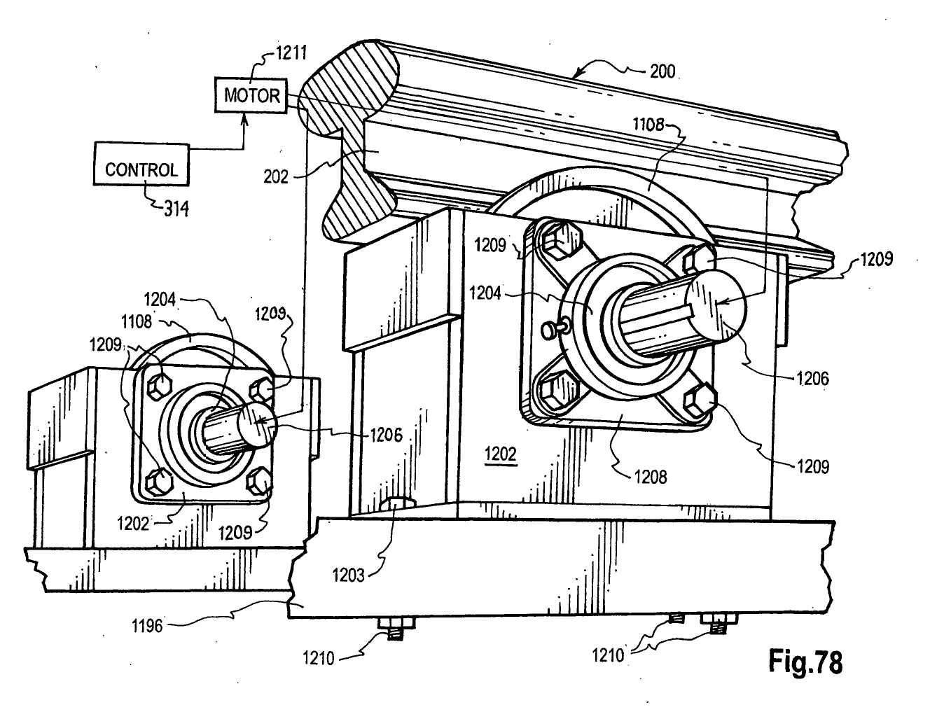

Each rail-displacement roller 1108 is journaled to a steel support bracket 1202, each roller 1108 being rotationally supported by its steel bracket 1202 and rigidly mounted to the top surface of the associated horizontal beam 1196. Each roller 1108 is supported by two spaced bearings 1204, carried in parallel relation by the associated bracket 1202, a shaft 1206 rotationally extending through the two bearings 1204. Each shaft 1206 is non-rotatably joined to its associated roller 1108 in a key/keyway relationship, with each shaft 1206 journaled for turning in bearings 1204. More specifically, each bearing is non-rotatably positioned within a mounting plate 1208 secured by bolts 1209 to each associated plate attached to bracket 1202, as best shown in FIG. 78.

Each shaft 1206 is mounted so as to be slightly sloped downwardly from field to gauge at an angle equal to the slope existing on channel 157 of each plate 134. Typically, depending upon the type of plate, the slope may be between 1:30 and 1:40.

As shown in FIG. 78, each bracket 1202 is secured by bolts 1203/1210 to its associated horizontal beam 1196. As can be seen best in FIGS. 77 and 78, each roller 1108 is contiguous with the lower flange 202 of the associated rail 200.

A series of cross beams 1200 rest upon and are rigidly secured at each end thereof to the space longitudinal beams 1196, as best shown in FIG. 77. Each cross beam 1200 is located slightly forward of each pair (one on each side) of rollers 1108 and each cross beam 1200 is in bolt-mounted relation at 1220 to a bracket 1222, one bracket 1222 being rigidly carried at both ends of each cross beam 1200. Each bracket 1222 is comprised of welded steel components within each bracket 1222. Each roller 1104 is journal for vertical rotation by engagement with the adjacent gauge side of the lower flange 202 of the associated rail 200, so that as the associated rail 200 is displaced in a distal direction, the rollers 1104 rotate as idlers thereby preserving the orientation of the lineally displaced rails 200.

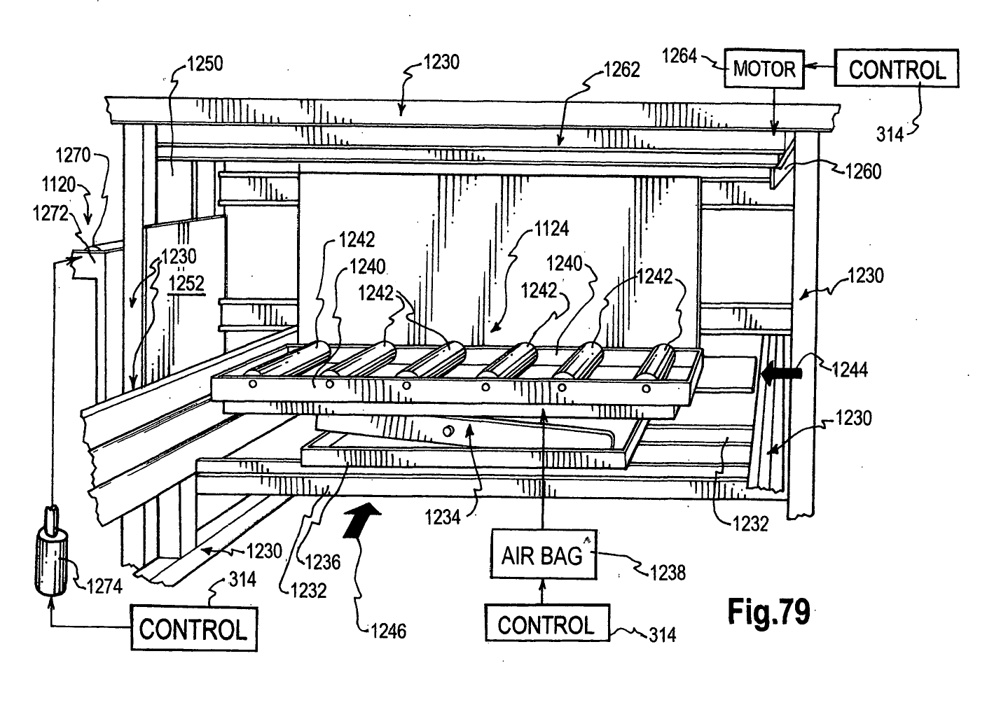

For further detail concerning the tie bundle entry station 1124, reference is now made to FIGS. 79-81. FIG. 79 depicts, in fragmentary perspective, one presently preferred station 1124. The station 1124 is supported upon fixed stationary framework 1230 comprising overhead beams, columns, side beams and lower cross beams 1232. Since the framework 1230 may be constructed in any of several desirable configurations, no extended detailed description is necessary to impart understanding to those skilled in the art.

A scissors lift, generally designated 1234 is rigidly mounted at its base 1236 to the two cross beams 1232 at lower frame 1236. The scissors lift 1234 is preferably a commercially-available Southworth of suitable capacity, which is lifted and lowered by activation of air bag 1238, responsive to commands from control 314. Air bag 1238 is an integral part of the commercially available scissors lift 1234.

Resting upon the top of the scissors lift 1234 is a rectangular framework 1240. Within the framework 1240 are rotatably mounted, spaced parallel idler rollers 1242. The framework 1240 and the idler rollers 1242 are shown in their lowest position in FIG. 79. A bundle of ties is delivered either from the side, as shown by arrow 1244, or from the front, as shown by arrow 1246, so that the bundle becomes accurately placed upon the rollers 1242, when the rollers 1242 and the frame 1240 are in their lowest position by reason of retraction of the scissors lift 1234. A forklift or a separate conveyor may be used to deliver bundles of ties to the top of rollers 1242. The space between the top of the rollers 1242 and the beams directly above the rollers 1242 comprising framework 1230 is sufficient to allow facile placement of the tie bundle on top of idler rollers 1242, free of interference with frame 1230.

With a tie bundle accurately positioned on idler rollers 1242, so that the ties are perpendicular to the rollers 1242, the control 314 activates air bag 1238 to elevate the scissors lift 1234 a distance sufficient for the top row of ties of the bundle to be aligned with discharge space 1250, directly above framework plate 1252. As shown in and described in relation to FIG. 25, rollers 343 may be used to insure that displacement of the scissors lift is vertical. At this point, the control 314 stops further inflation of the air bag 1238. In this position, the top row of ties of the bundle is not only directly aligned with opening 1250 but directly aligned with a push plate or rack sweep 1260. The push plate 1260 is, at this point in time, displaced from right to left as shown in FIG. 79 by any suitable means. For example, the push bar or plate 1260 is shown to be connected to a reversible conveyor drive 1262, so that displacement of the drive 1262 by motor 1264, under command of the control 314, will first move the push bar 1260 from right to left a sufficient distance to first engage and then displace the top row of ties the bundle from right to left as viewed in FIG. 79 so that the row of ties exits the tie bundle entry station 1124 and is received on elevated rollers disposed at tie row-to-conveyor station 1120, herein described in greater detail. The motor 1264 is reversible so that when the top row of ties has been displaced to the tie row-to-conveyor station 1120, the motor 1264 is reversed, under command of the control 314, and the push bar 1260 is returned to its initial position shown in FIG. 79.

At this point in time, under command of the control 314, the air bag 1238 incrementally elevates the scissors lift 1234 vertically to bring the next row on the bundle of ties into alignment with the discharge opening 1250 and the push plate 1264, at which time the new top row is timely displaced into the station 1120, in the manner explained above.

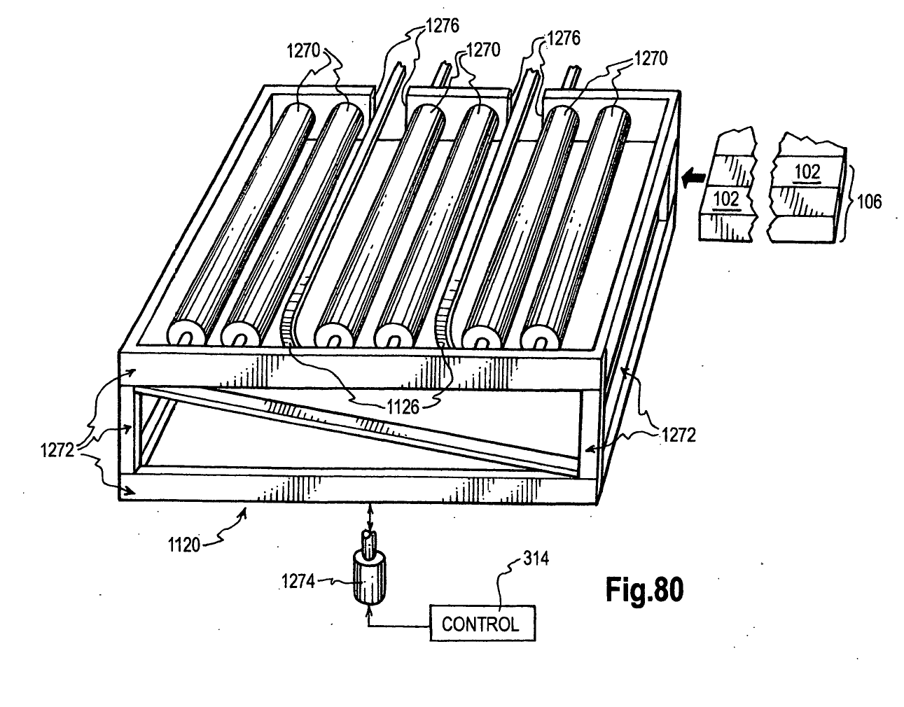

At station 1120, each row of ties there-received is positioned on idler rollers 1270, which are rotationally mounted on a frame 1272 perpendicular to the incoming ties. FIG. 80. The frame 1272 is vertically displaced up and down by activation and deactivation of one or more cylinders 1274, under command of the control 314, as explained hereinafter in greater detail.

In reference to FIG. 80, the row 106 of ties 102 displaced from station 1124 to station 1120 is essentially along a horizontal path through entry opening 1250 (FIG. 79) in a horizontal plane such that the bottom surfaces of the ties 102 will engage the exposed arcuate surfaces of idler rollers 1270, when the framework 1272 is in its elevated position, obtained by activation of the one or more cylinders 1274, under command of the control 314. The frame 1272 comprises two distal gaps 1276 to provide space for the conveyors 1126. When the rollers 1270 are in their most elevated position, the top of the rollers 1270 are slightly elevated above the adjacent surfaces of the spaced chain conveyors 1126, so that no interference occurs. As the ties 102 move from right to left as shown in FIG. 80 so as to be fully inserted into the station 1120, the idler rollers 1270 rotate to accommodate this entry of the row of ties.

When the ties are fully positioned on the rollers 1270 at station 1120, the one or more cylinders 1274, under command of the control 314, lowers the frame 1272, which in turn lowers the idler rollers 1270, leaving the lower surface of the row of ties resting on top of the spaced conveyors 1126, with the rollers 1270 spaced a desired vertical distance below the bottom surfaces of the ties.

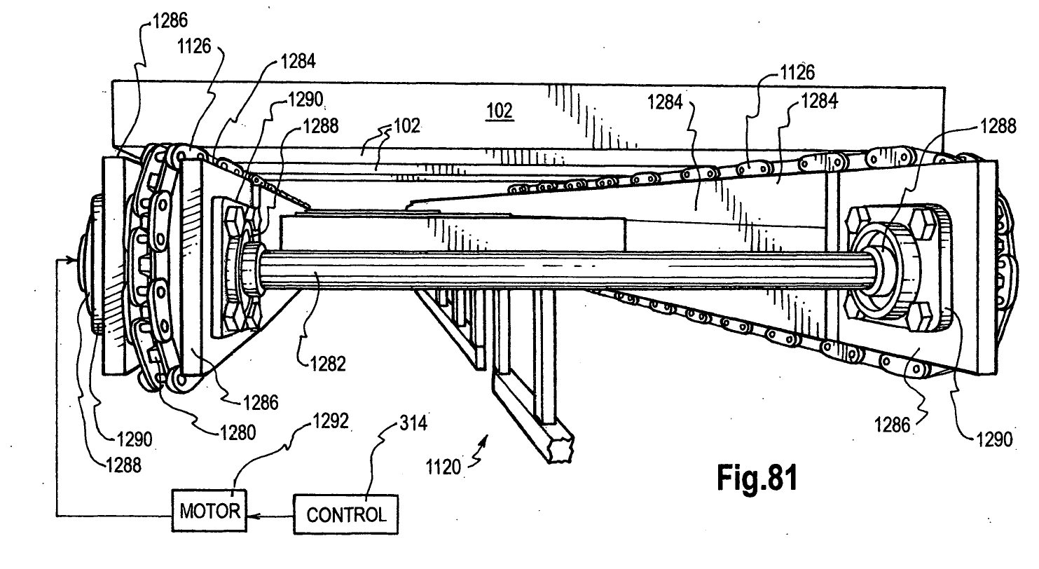

Reference is now made to FIG. 81, which is a fragmentary perspective showing one end of the spaced chain conveyors 1126. The chains of conveyors 1126 are mounted on spaced sprockets 1280, one on each side at each end of the conveyors 1126. The sprockets 1280 are non-rotatably secured to an idler shaft on one end of the conveyors 1126 and a drive shaft 1282 at the other end. The chain conveyors 1126 are retained horizontal as they move along the top surfaces 1285 of two space beams 1284. Attached to the ends of the beams 1284 are spaced frame plates 1286. The shafts 1282, at each end are journaled in bearings 1288, in a conventional way, to provide appropriate rotation for the ends of the shafts 1282, which in turn rotate the chain conveyors 1126 via sprockets 1280. Bolt-secured stationary plates 1290 are shown in FIG. 81 as rotationally supporting the respective ends of the shafts 1282 at bearing journals 1288.

Thus, responsive to sequential activation of motor 1292, under command of the control 314, the space chain conveyors 1126 with a row of ties 102 resting transversely on the top surface thereof, cause the row of ties to be displaced from the tie row-to-conveyor station 1120 to the underside drilling station 1140.

The frame 1272 and the rollers 1270 have been removed from FIG. 81 for purposes of clarity.

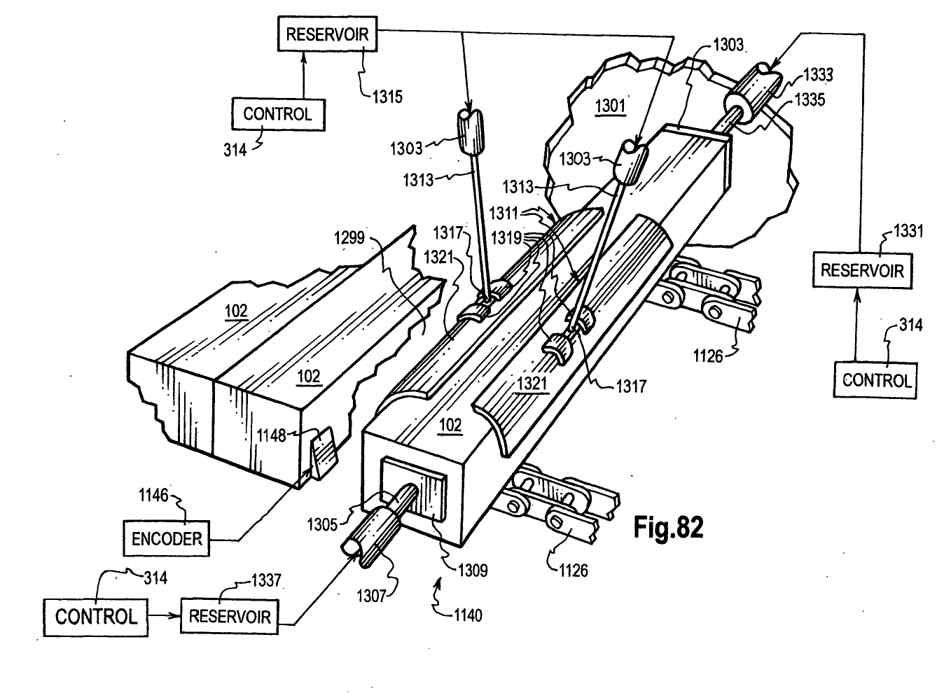

Each row of ties 102 leaving the tie row-to-conveyor station 1120 are displaced distally by engagement with the top of moving conveyors 1126. As one row of ties 102 is positioned accurately at station 1140, encoders 1146 detect this and cause the pop-up stops 1148 to elevate, thereby holding the row of ties stationary, except for the lead tie. FIG. 82. The control 314 causes discontinuing of rotation of the drive shaft 1282 and displacement of the conveyors 1126 a short time thereafter. This creates space 1299 between the first and second ties. The distal-most tie 102 at station 1140 is then upwardly drilled, as explained in greater detail below, to create six blind bore drill holes 128 at each of two spaced locations (FIG. 12) in the manner explained earlier, in respect to FIG. 11 and FIG. 32. As a result, a pattern of six drill holes at two separate lower surface locations on the first tie 102 is precisely drilled, where they need to be for accurate plate placement, at a later time. In this manner, the gauge of a railroad track section is precisely defined. When the first distal tie of the row has been so drilled, the control 314 activates the motor 1292 and the encoders 1146 lower the stops 1148, accommodating displacement of the ties at station 1140. Space 1299 is created between the second and third ties when the position detecting encoders 1146 senses the correct location and again elevates stops 1148 into the interface between the second and the third tics. The conveyors 1126 briefly continue displacement of the second tie to create the space 1299. This continues until all of the ties of the row have been drilled at the underside thereof in an upward direction, each at two accurately located and accurately spaced positions.

Continuing reference is made to FIG. 82, which depicts a presently preferred way of both accurately positioning a tie 102 at the drilling station and holding the tie as it is drilled. As motor 1128, under command of the control 314, displaces a row of ties 102 from station 1120 to station 1140, the ties are side-by-side contiguous one with the next. At station 1140, encoders 1146 sense the position of the row of ties being displace on conveyors 1126 and appropriately and timely elevate the spaced stops 1148 at the interface between the first and second ties 102, while the conveyors 1126 continue to displace the lead tie 102 the distance 1299, sufficient to allow the hold down mechanisms for the lead tie 102 to function. Thus, the stops 1148 when so elevated, prevent displacement of the ties 102, other than the lead tie, even though the conveyors 1126 may continue to displace the lead tie 102 for the short distance 1299. At this point, the control 314 disables the motor 1128 and the conveyors 1126 stop.

The lead tie 102 is transversely displaced against a push blade 1303, recessed in an abutment wall 1301. This distance can be relatively small, as determined by those skilled in the art. By doing so, the tie is accurately positioned over the underneath drill heads for accurate drilling. This displacement is illustrated in FIG. 82 as being caused by displacement of a piston rod 1305 when, under command of control 314, fluid is delivered from reservoir 1337 to cylinder 1307 to so extend the piston rod 1305 the required distance. Rigidly mounted at the distal end of piston rod 1305 is a push plate 1309, which engages the adjacent end of the tie 102 at the drilling station and pushes the tie against the return push plate 1303. When the tie 102 is so transversely displaced, control 314 deactivates reservoir 1337 and cylinder 1307, so that piston rod 1305 and push plate 1309 retain the tie 102 stationary in the displaced position illustrated in FIG. 82.

It is presently preferred that drill heads comprise commercially manufactured AutoDrill drill heads, used essentially in the manner disclosed herein in respect to FIGS. 11 and 32.

In addition to longitudinally securing the tie to be drilled between push plates 1309 and 1303, as mentioned above, the tie 102 to be drilled is held against misalignment and rotation by a clamshell holding mechanism, generally designated 1311. The holding device 1113 comprises two cylinders 1303, the piston rods 1313 of which are extended by fluid displacement from reservoir 1315, under command of the control 314.

The distal ends 1317 of the piston rods 1313 are rotationally connected respectably, each at a coupler 1319, to spaced arcuate blades 1321. Thus, when the piston rods 1313 are extended, the arcuate clam shell blades 1321 are both lowered, to exert a downward force on the top of the tie and are folded toward each other so as to create opposed forces on both longitudinal sides of the tie 102 at the drilling station 1140, thereby correctly longitudinally aligning the tie to be drilled and holding the tie against misalignment during drilling. Side clamping of the tie to be drilled from positions below the tie may be used in lieu of from the top, as shown in FIG. 82.

When the drilling has been completed the holding mechanism 1311 is lifted and the control 314 instructs the motor 1128 to once more incrementally displace the conveyors 1126 with the pop-up stops 1148 first retracted and then re-elevated at the interface between the second and third ties of the row by position control encoder 1146. The conveyors 1128 increment the second tie forward into the spaced position for drilling at the drilling station 1140, in the manner explained above, while the drilled tie 102 is moved forward retaining a spaced relation with the second tie 102. When the second tie 102 is at the station 1140 and the first drilled tie is distal of the station 1142, the drilling of the second tie will occur, as explained above.

However, each drilled tie must be repositioned accurately on conveyors 1126 so that the overlap on each side is essentially equal. This is done by appropriately delivering fluid from reservoir 1331 to cylinder 1333 to extend the piston rod 1335. The distal end of the piston rod 1335 is rigidly connected to the push plate 1303 so that extension of the piston rod 1135 correspondingly displaces push plate 1303 the precise distance needed to return the drilled tie 102 to its proper position on conveyors 1126.

From the foregoing, it is apparent that the drilled ties exiting from station 1140 are in spaced relation one to the next, with the drill holes down, and are not contiguous, as tie displacement to the tie inversion station 1142 occurs after drilling.

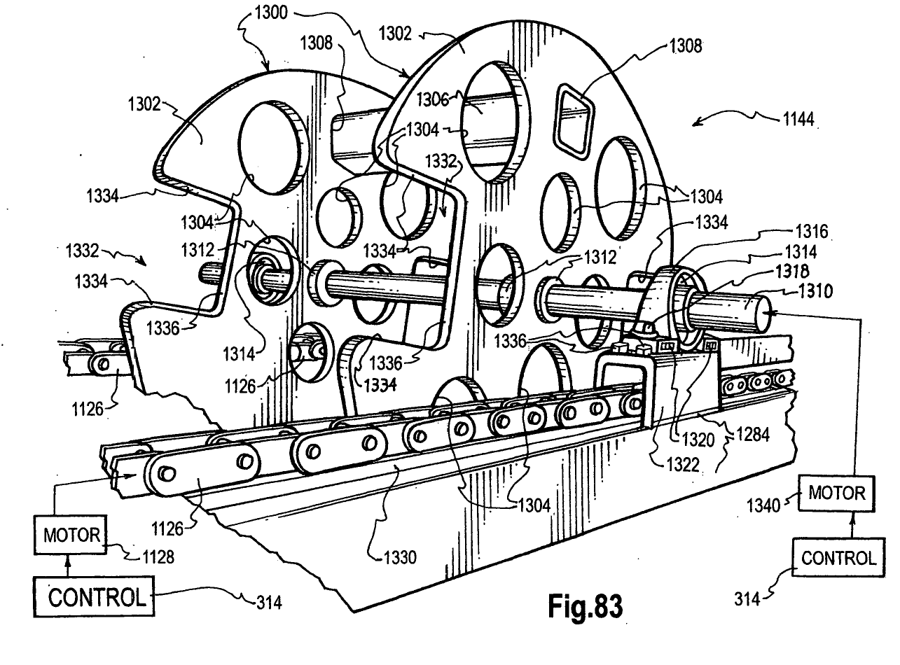

Reference is now made to FIG. 83, which illustrates an inversion wheel, generally designated 1300, at tie inversion station 1144. The tie inversion wheel 1300 comprises two spaced steel plates 1302, the weight of which is made lighter by apertures 1304 in the plates 1302. The plates 1302 are held firmly in spaced parallel relation, which is also parallel to the processing path defined by conveyors 1126, by two oppositely disposed cross struts 1306. The cross struts 1306 are illustrated as extending through rectangular holes 1308 in the two plates 1302, with the cross bars 1306 being welded to the plates 1302 at the two sites 1308. The struts 1306 are disposed essentially 180 degrees apart. The plates 1302 are rigidly fastened to a displacement shaft 1310. The shaft 1310 is welded on both sides of each plate 1302 at sites 1312 so that as the shaft 1310 is rotated, the plates are likewise rotated, while maintaining their parallel spaced relation. The shaft 1310 extends through end journals 1314, held in position by arcuate brackets 1316. The arcuate brackets 1316 are secured in position by bolts 1318 secured to shoes 1320. The shoes 1320 are welded or otherwise rigidly secured to an inverted U-shaped bracket 1322 on each side. The downwardly extending legs of each bracket 1322 rest upon and are welded to the associated beam 1284, at the top surface 1330.

As can best be seen in FIG. 83, the links of the conveyors 1126 rest upon and horizontally move along the top surface 1330, without sagging, and do not interfere with the brackets 1322 on each side because the chains pass through the inverted U existing between the downwardly extending legs of each bracket 1322.

Each plate 1302 comprises two open recesses 1332, which are 180 degrees out of phase one with another. The sets of recesses 1332 on each plate 1302 are respectfully horizontally aligned with recesses 1332 on the other plate. Each recess 1332 is defined by spaced side edges 1334 and a back edge 1336 so that each recess 1332 essentially forms three sides of a rectangle. Size of each recess 1332 is selected so as to receive, when properly located, a drilled tie into two of the aligned recesses 1332 for rotational displacement and inversion of the tie.

The plates 1302 are collectively displaced via shaft 1310 by a motor 1340, under command of the control 1314. The recesses or throats 1332 are positioned so that two of the recesses 1332, at bottom edge surfaces 1334 are directly in line with the bottom of an incoming drilled tie, drill holes down, such that continued displacement of the conveyors 1326 by a motor 1128, under command of the control 313, will displace the incoming tie into the two aligned proximately disposed recesses 1332 so that the bottom of the tie rests on the lower edges 1334 of the recesses 1332. At this point in time, the motor 1128, under command of the control 314, briefly stops the conveyors 1126 and the motor 1340. Under command of the control 314 the inversion wheel 1300 and the tie 102 are rotated through essentially 180 degrees thereby placing the drill holes in the tie in an upward position as the tie is discharged from the inversion wheel 1300, by centrifugal force and by gravity, back onto the spaced conveyors 1126.

At this point in time, the second set of recesses 1332 in plates 1302 are properly disposed proximally between the spaced conveyors 1126, preparatory to receiving the next drilled tie. The next drill tie is then displaced by motor 1128 and the conveyors 1126 into the parallel spaced proximally disposed recesses 1332 and the process of inverting a tie is repeated. As the conveyors 1126 displace the second tie into the second set of recesses 1132, the first inverted tie is moved distally along the conveyors 1126 upon which the first inverted tie rests. This process is repeated until all of the ties of the row have been inverted and the inverted ties are in spaced relation on and displaced by conveyors 1126 toward the drill tie discharge station 1164.

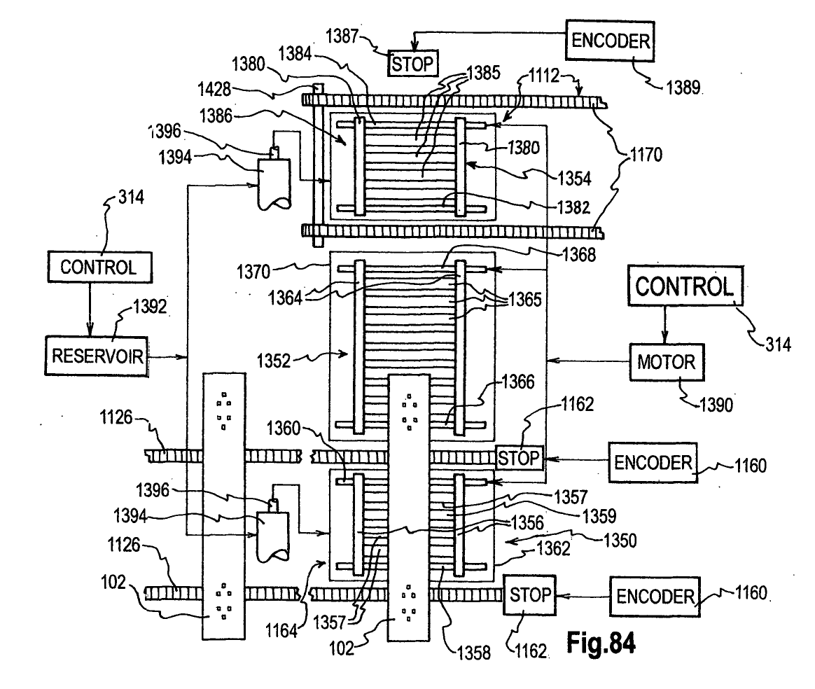

Reference is now made to FIG. 84, which diagrammatically illustrates the manner in which inverted drilled ties are individually transported from the drill tie discharge station 1164, at the end of conveyors 1126, to the plate, spike, clip, and rail assembly station 1112, disposed at the proximal end of two spaced conveyors 1170.

As the lead tie 102, resting upon and being displaced by conveyors 1126 approaches the distal end of conveyors 1126, encoders 1160 sense the final position of the tie 102 thereby causing pop-up stops 1162 to bring conveyors 1126 and the ties thereon to a stop. In this position, the tie 102 distally disposed at station 1164 is in alignment with station 1112, at the distal end of conveyors 1170.

Three sets of relatively short transfer conveyors, transverse to conveyors 1126 and 1170, are disposed in aligned tandem relation, i.e. conveyor systems 1350, 1352 and 1354. Conveyor system 1350 comprises spaced chain conveyors 1356 mounted about an idler shaft 1358 and a drive shaft 1360. Conveyor system 1350 is mounted upon a vertically displaceable frame 1362, which can be elevated to lift the associated tie upward off from conveyors 1126 and lowered to be free from interference with the next incoming tie 102. Cross struts 1359 extend between, and are connected to the frame 1362 and displaced with the conveyors 1356. Each tie rests on and is transported by displacement of cross struts 1359, which are spaced from each other by spaces 1357.

Conveyor system 1352 comprises spaced chain conveyors 1364, mounted upon an idler shaft 1366 and a power driven shaft 1368. Conveyor system 1354 is mounted upon a fixed frame 1370 at an elevation above conveyors 1126 and 1170 but in vertical alignment with conveyors 1356, when in their elevated position by reason of lifting of framework 1362, as explained below. Spaced cross struts 1365 extend between and are connected to the frame 1362 and displaced with the conveyors 1364. Each tie received by the conveyor 1364 rests on and is transported by displacement of cross struts 1365 toward station 1112.

The conveyor system 1354 is similar to conveyor system 1350 and comprises two parallel chain conveyors 1380 mounted upon and accommodating displacement around an idler shaft 1382 and a power driven shaft 1384. Spaced cross struts 1385 extend between and are connected to and displaced with conveyors 1380. Each tie received by the conveyors 1380 rests on and is transported by displacement of struts 1385 into an accurate position at station 1112. The conveyor system 1354 is mounted upon a lower frame 1386, which moves up and down, much the same as frame 1362, so as, in the down position, to avoid interference with conveyors 1170 and in the up position placing the top of the conveyors 1380 above the top surface of conveyors 1170 at essentially the same elevation as the top of the stationary conveyors 1364. Thus, when the support structure 1362 is in its upper position and the support structure 1386 in its up position, the conveyors 1356, 1364 and 1380 are at essentially the same elevation, which is above the elevation of the top of the conveyors 1126 and 1170. When all of the conveyors 1356, 1364 and 1380 are at the same elevation and operating, the tie at station 1164 is transported to station 1112, where plates, spikes, clips and rails are added. Motor 1390 drives drive shafts 1360, 1368 and 1384 under command of control 314, to displace conveyors 1356, 1364 and 1380, thereby placing the tie 102 so displaced accurately at station 1112, at which time, under command of the control 314, the motor 1390 is deactivated causing displacement of conveyors 1356, 1364 and 1380 to stop. This occurs when encoder 1389 senses tie 102 as being correctly located, causing stop 1387 to engage the distal end of the tie thereby bringing the tie to a stop. Under command of the control 314, the piston rods 1396 are retracted appropriately into the cylinders 1394, which causes the underframeworks 1154 and 1386 to return to their lower positions. The tie 102 at station 1112 thus comes to rest on conveyors 1170, out of contact with cross struts 1385.

Elevating and lowering of the underframeworks 1350 and 1386 is caused by displacement of air to and from reservoir 1392 to and from pneumatic cylinders 1394, under command of the control 314, causing the piston rods 1396 thereof to timely lift and lower the under-frameworks 1362 and 1386.

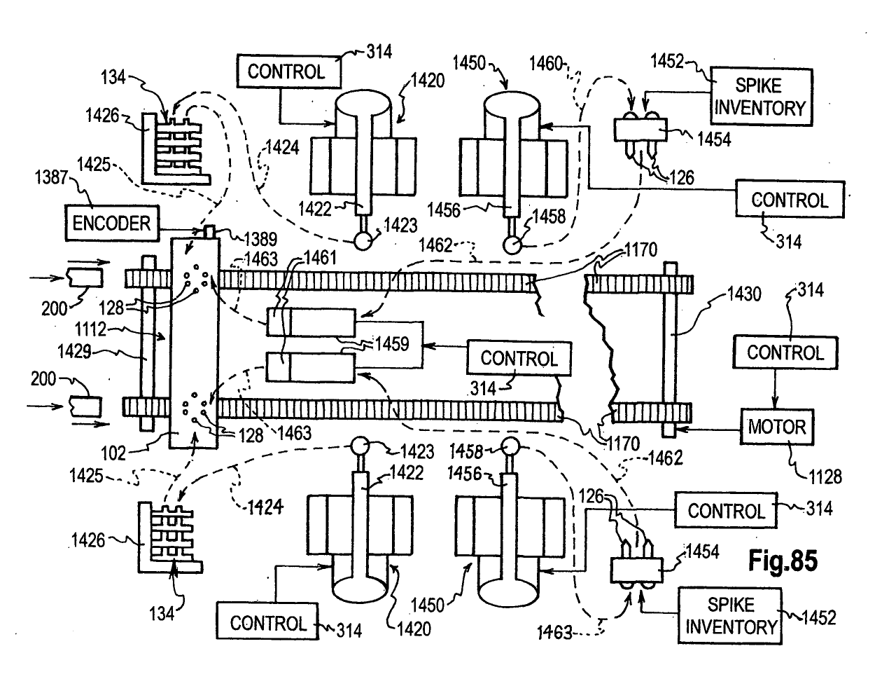

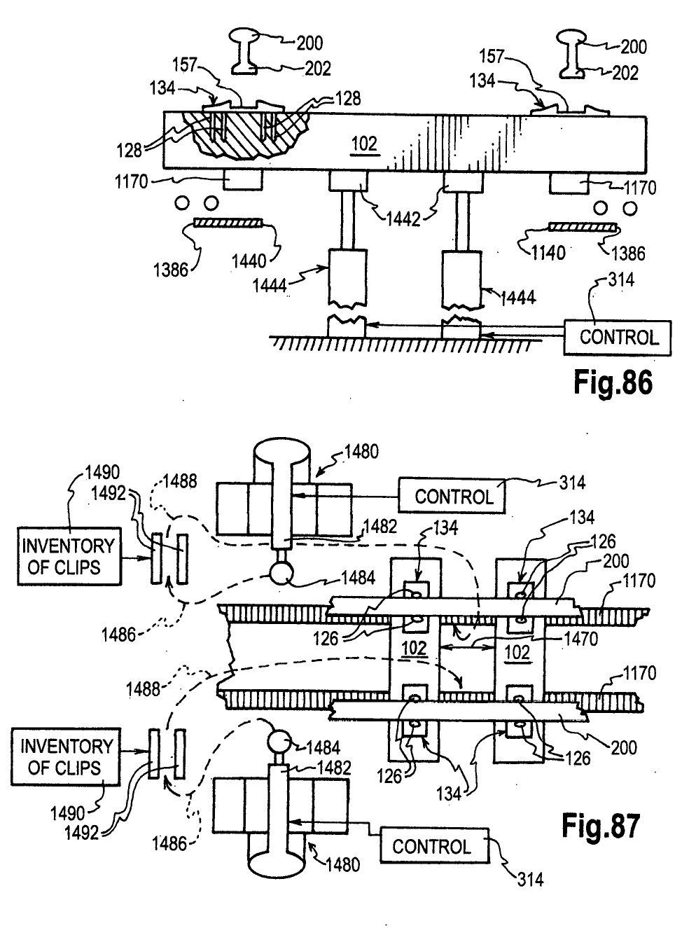

Reference is now made to the FIGS. 85-89 for the purpose of disclosing the events which take place at the plate, spike, clip and rail assembly station 1112. As explained above, the tie 102, with blind bore drill holes 126 upwardly directed, is correctly positioned at station 1112, as shown in FIG. 85. Encoder 1387 senses when the tie 102 is correctly positioned at station 1112 and causes pop-up stop 1387 to elevate thereby causing tie displacement to cease exactly, the tie is accurately placed across conveyors 1170. At this point in time, the conveyors 1170 are idle and the tie 102 rests upon the top rungs of conveyors 1170. The distal ends of the two rails 200, temporarily resting adjacent to the station 1102, are available to be advanced over top of the tie 102, as explained in greater detail below. Two robots 1420, one on each side of the conveyors 1170, are activated by control 314, causing the retrieval and placement arm 1422 of each to be rotated and extended to a position adjacent to an inventory of stacked tie plates 134 disposed at a plate retrieval sites 1426. This displacement is illustrated by dotted lines 1424 in FIG. 85. The robots 1420 are preferably models I R B 4400, manufactured by ABD. With the magnetic head 1423 at the distal end of each arm 1422 activated, each robot 1420 is caused to pick up one tie plate 134 and place it in superimposed relation over one of the two sets of blind bore drill holes 128, such that the apertures in the placed plates are vertically aligned with the blind bore drill holes 128. The displacement of the two tie plates 134 is illustrated by dotted lines 1425 in FIG. 85. In this position, the top surface of the tie 102 is at an elevation somewhat below the elevation of the bottom surface of the incoming rails 200. This is best illustrated in FIG. 86. This distance may be on the order of 4 inches.

With the plates resting properly at two locations over the blind bore drill holes 128 of tie 102, the rails 200 are advanced to a position so as to extend above and distally beyond the two plates. As mentioned earlier, the delivery of the two rails 200 is at a slight transverse angle downward from the field side to the gauge side, at a slope identical to the slope of the channels 157 of the plates 134.

With the rails advanced in this manner and then stopped, the tie and the plates are lifted vertically so that the bottom surface of the rails become firmly contiguous with the associated channel surfaces 157 of the plates 134. This causes the bottom surface of the tie 102 to vertically separate from the two conveyors 1170. The lifting is accomplished by two screwjacks 1444, under command of the control 314, such that abutments 1442 engage and lift the tie vertically, while preserving the horizontal orientation of the tie thus bringing the channels 157 of the tie plates 134 into contiguous relation with the bottom surface of the two rails 200. In reference to FIGS. 84 and 86, the structural support 1386 has a suitable opening 1440 to accommodate the structure and function of the screwjacks 1444. Likewise, the previously mentioned rollers 1385 at station 1354 have sufficient spacing to also accommodate the location and function of the screwjacks 1444. Preferably, the screwjacks 1444 are manufactured by Joyce-Dayton, model 5 ton ComDrives.

With the rails 200 resting on the plates 134, as mentioned above, the tie 102 is held in the elevated position by the screwjacks 1444, while the control 314 activates two robots 1450, one located on each side of conveyor 1170, so that their respective arms 1456 are rotated and extended along paths 1463, bringing magnetics heads 1458 into superposition with a metal spike holder 1454, into which three spikes have been placed from inventory 1452. FIG. 85. The holders 1454, with three spikes 126 in each holder, are respectively magnetically lifted and delivered to a combination spike clamshell and shuttle mechanism 1461, one for each of the two screwjacks 1459. Screwjacks 1444 preferably comprise 5 ton ComDrives, manufactured by Joyce Dayton. The three spaced spikes 126 in each holder 1454 are delivered, with the associated holder, to the clamshell shuttles 1461 along transport pathways 1462, where the spikes are positioned in the clamshell shuttles 1461 in spaced vertical alignment with the plate apertures through which the spikes are to be inserted. The clamshell shuttles 1461 are elevated directly above the three plate apertures in question and linearly downwardly force-inserted, without rotation, through the plate apertures and fully into the aligned blind bore drill holes 128. Two spikes 126 secure the associated rail and one secures the associated plate. The clamshell progressively opens, as the spikes are so displaced.

Once the spikes are in the clamshell shuttles 1461, the empty holders 1454 are returned, under command of the computers control 314, to their initial positions to each receive three more spikes. When the three spikes 126 are fully inserted into the tie 102 from the clamshell shuttles 1461, the clamshell shuttles are returned to their initial positions, under command of the control 314, preparatory to receiving three more spikes. The paths of the arm 1456 to the pickup sites where holders 1454 are disposed is identified by dotted lines 1460. The paths by which the arms 1456 of the robots 1450 move from the pickup sites to the clamshell shuttle sites is diagrammatically illustrated by dotted lines 1462. The paths from the clamshell shuttle sites to the spike installation locations is diagrammatically illustrated by dotted lines 1463. Preferably, the robots 1450 are manufactured by ABD, model I R B 4400.

At this point in time, under command of the control 314, the rails 200, together with the attached tie 102 are advanced in a distal direction, by motor displacement of the rails. As the screwjacks 144 retract the abutments 1442, under command of control 1314, the joined tie and the rails, due to the weight to the rails move the bottom surface of the tie 102 toward contact with the conveyors 1170. Eventually contact is achieved. Conveyors 1170 turn on idler shaft 1429 and are power-driven by shaft 1430. Under command of the control 314, the conveyors 1170 are incrementally moved forward to establish, with precision, the correct spacing between ties, as additional ties are displaced, as described above, until all ties are fully and accurately positioned at station 1112.

Each tie is processed in the same manner, as described above in conjunction with the first tie, so as to position plates on the second tie, advance the rails, lift the second tie 102 until the tie is contiguous at the channels 157 at the bottom of the two ties 200, after which the plates are spiked, as described above. As to the second tie, which has been advanced, reference is made to FIG. 87, showing the first and second ties correctly spaced one from another, as indicated by arrow line 1470. However, when deemed appropriate by those skilled in the art, the first two ties may be temporarily contiguous, as illustrated in FIG. 91.

FIG. 87 diagrammatically illustrates the manner in which clips 1492 are secured under and between the lower flanges of each rail, at two locations per rail between two adjacent ties to retain the spacing between ties and to prevent relative movement between the rails, the ties and the plates during prefabrication of the track sections, transportation to an installation site and manipulation of the track section at the installation site so as to become part of a new or repaired railroad line.

FIG. 87 shows two inventories 1490 of rail-engaging clips 1492, one disposed on each side of the conveyors 1170. Two robots 1480, preferably manufactured by ABD, model I R B 2400, are provided. The robots 1480 each comprise a moveable arm 1482 and a magnetic head 1484. Under command of the control 314, the robots 1480 are activated, causing the arms 1482 to rotate and extend along pathways 1486 to the clip pickup sites, where two clips 1492 at each site are magnetically captured by the heads 1484. The two magnetically-held clips 1492 are attached to the heads 1484, the heads 1484 and the clips 1492 are displaced along pathways 1488 to an installation site on the gauge side of the associated rail 200. The two clips 1492 at both sites are placed in holders 1500 and forced under and snapped into a retained relation with the bottom flange 202 of the two rails 200, in a manner described in connection with FIGS. 18-21, one difference being only two clips are used in the FIG. 87 embodiment, whereas more than two clips are described as being used in respect to FIGS. 18-21.

When the four clips have been placed on the gauge side of the two rails 200, under command of the control 314, the robots 1480 are returned to their initial positions.

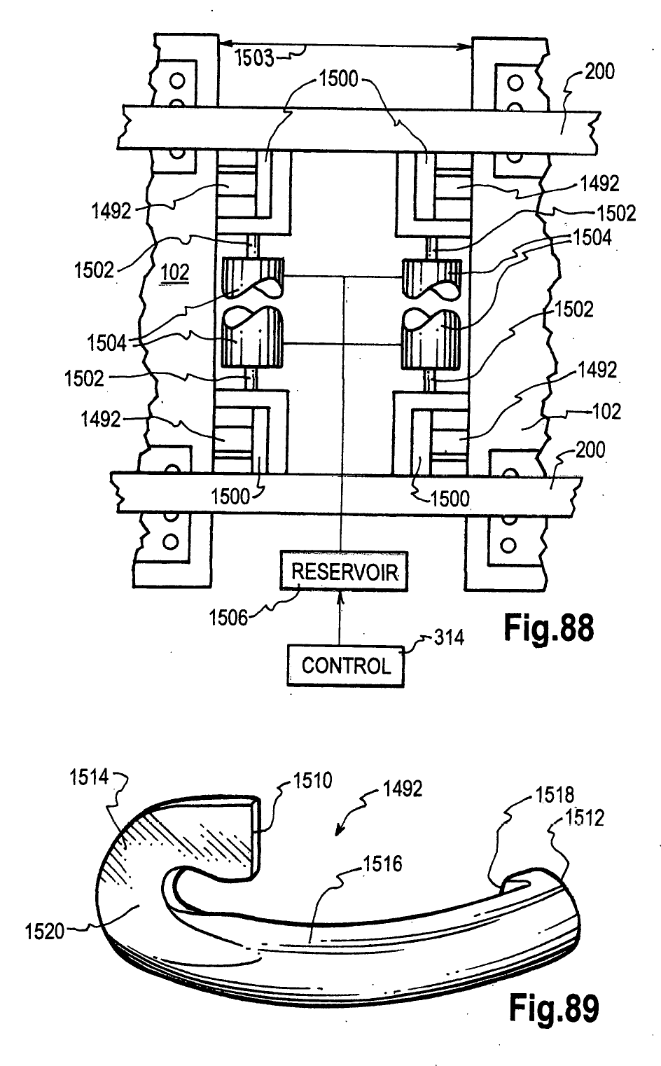

Thus, in lieu of the approach described in connection with FIGS. 18-21, a second approach may be used, illustrated diagrammatically in FIG. 88. The robots 1480 are programmed to deliver the two spaced clips 1492 to each gauge side of the two rails in such a way that the clips 1492 become disposed in open top L-shaped holders 1500, with one side of each clip 1492 contiguous with the adjacent side of the associated tie 102, the ties 102 being correctly spaced one from the next as shown by arrow 1503 in FIG. 88. The L-shaped holders 1500 are respectively rigidly attached to the distal end of a piston rod 1502, which is extended from and retracted by an associated cylinder 1504.

Once the clips 4192 are loaded into the holders 1500, under command of the control 314, compressed air, for example, is delivered from reservoir 1506 to the cylinders 1504, causing extension of the piston rods 1502. This displaces the associated holder 1500 and the associated clip 1492 underneath the associated rail 200, causing the clips 1492 to engage the lower flange 202 of each rail 200 and to snap into place so as to avoid inadvertent removal. Each clip 1492, as it is being displaced, slides contiguously along the adjacent surface of the associated tie 102. The holders 1500 have a vertical dimension such that they do not interfere with the displacement of conveyors 1170 or the displacement of the ties, plates, spikes and rails mounted on top of the ties. When the clips 1492 have been correctly snapped into place beneath the rails 200, the holders 1500 are retracted into their initial positions, under command of the control 314, as the piston rods 1502 are retracted into their initial positions.

At this point in time, the conveyors 1170, under command of the control 314, advance the track section incrementally, i.e. the distance necessary for correct placement on a third incoming tie 102 at station 1112, to be added to the track section in the manner described above.

Reference is made to FIG. 89, which illustrates one presently preferred embodiment of the clip 1492. The clip 1492 of FIG. 89 comprises a gauge end 1510 and the field end 1512. Clip 1492 is comprised of structural grade steel and comprises a reverse curve 1514 and a central slightly arcuate portion 1516, as well as a rail-engaging slot 1518. When installed, a throat 1520 engages the associated rail flange 202 on the gauge side, the notch 1518 is sized and shaped so as to engage and lock over the field side of the flange 202 in retained relation.

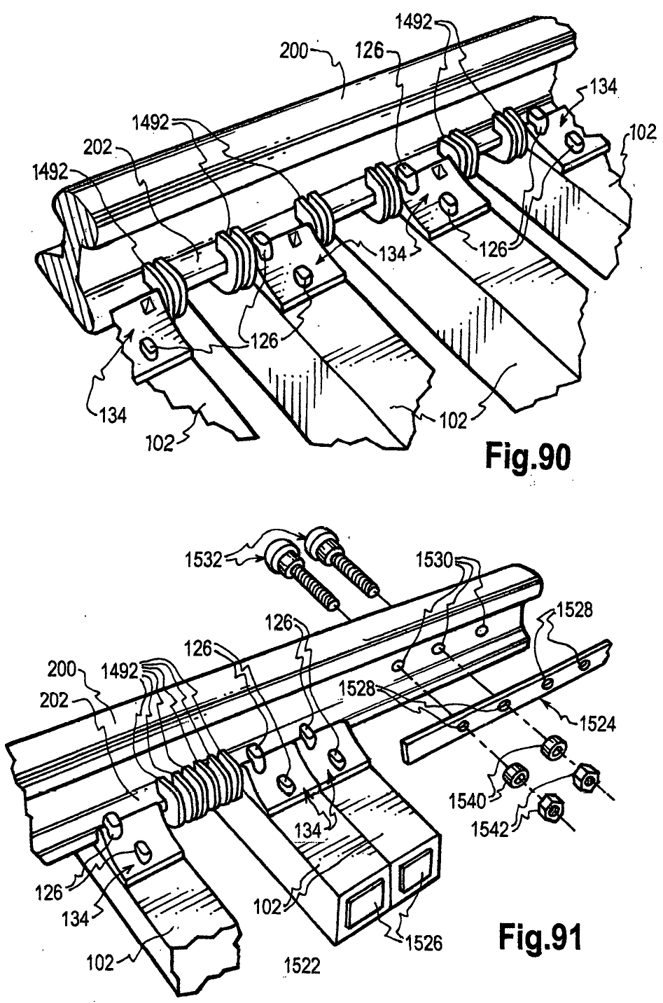

In the manner describe above, the tie placement continues so that rails are superimposed upon tie plates 134 and spikes 126 inserted though the apertures to the tie plates 134 and to the blind bore drill holes 128 and the clips are snapped onto the lower flanges of the rails, as best illustrated in FIG. 90. When the rail section is completed, a suitable forklift or other lifting device will hoist the sometimes 1100 pound track section, which may be 40 feet in length, from the conveyors 1170. The completed track section is loaded onto a transport vehicle and taken to an installation site. In the alternative, the track section may be temporarily stored for later delivery to an installation site.

It is convenient, for purposes of track section installation that the two distal-most ties on the track section sometimes be in contiguous side-by-side relation, as shown in FIG. 91, at interface 1522. This accommodates ease of connection of one track section to the next, using joint bars, generally designated 1524. The distal-most contiguous two ties 102 are illustrated as having crack-inhibiting end cleats 1526.

When one joint bar 1524 has been bolt connected to the distal end of one rail of a track section and the proximal end of other rail of a second track section, the contiguous distal tie 102 is forcibly displaced in a distal direction the precise distance required between adjacent ties. As shown in FIG. 91, three clips are illustrated as having been placed between the second and third ties 102 of the track section. Using a sledge hammer or other force-imposing instrument, the central clip 1492 is later removed and repositioned correctly on the bottom flange of the associated rail between the first and second ties, after the correct spacing between the first and second ties has been obtained. While three clips 1492 are shown in FIG. 91, four clips may be so placed to provide two clips to be removed from between the second and third ties and repositioned between the first and second ties once they are separated. As an alternative, an additional separately-stored 102 clip may be properly affixed to the lower flange 202 of the associated rail 200 between the first and second ties 102.

As shown in FIG. 91, the joint bar 1524, preferably of high grade steel, with a plurality of preformed transverse apertures 1528, being provided. The ends of the two adjacent rails 200 each comprise two preformed transverse apertures 1530, which have a space therebetween equal to the space between the apertures 1528 of the joint bar 1524. When the apertures in the rails and in the joint bar are aligned, bolts 1532 are inserted through the apertures 1528 and 1530 and secured in place by washers 1540 and nuts 1542. The joint bar 1524 is sized so as to be contiguous with the central vertical portion of each rail, being disposed between the bulbous top and the lower flange. Typically, two threaded bolts 1532, the shank of which is sized to fit within the apertures 1528 and 1530, are inserted through aligned apertures 1528 and 1530. The threaded ends of the bolts 1532, which are exposed beyond joint bar 1524, when properly inserted, receive, respectively, an annular washer 1540, which are secured in place by interiorly threaded nut 1542, which, when tightened, secures the nut, the washer and bolt in place, with about 50% of the joint bar 1524 extending distally beyond the distal end of the rail 200. This joint bar extension is used to connect the joint bar 1524 to the next adjacent track section, in the manner explained above.

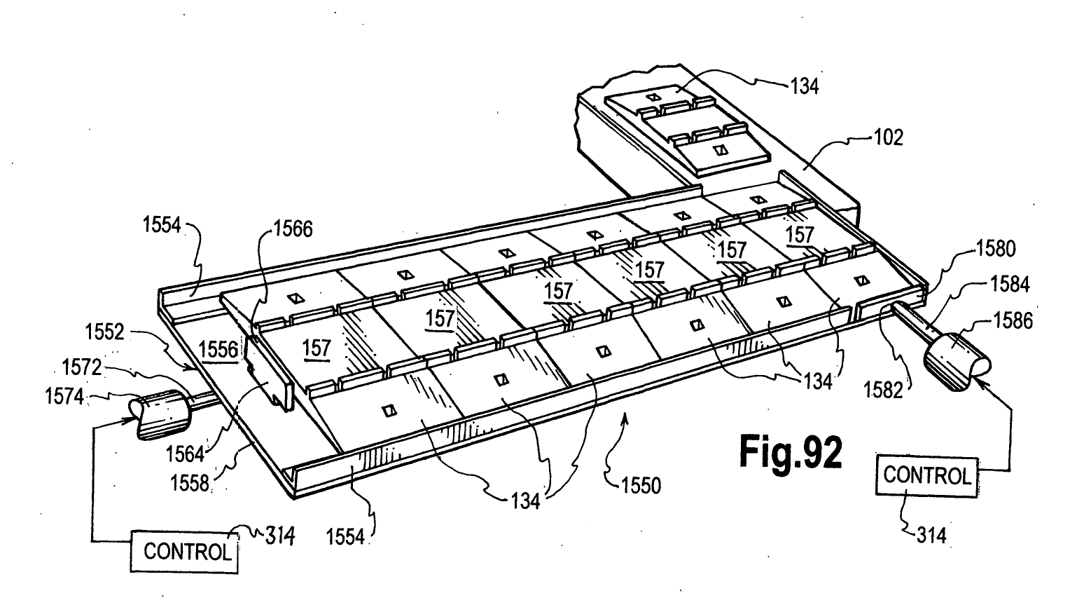

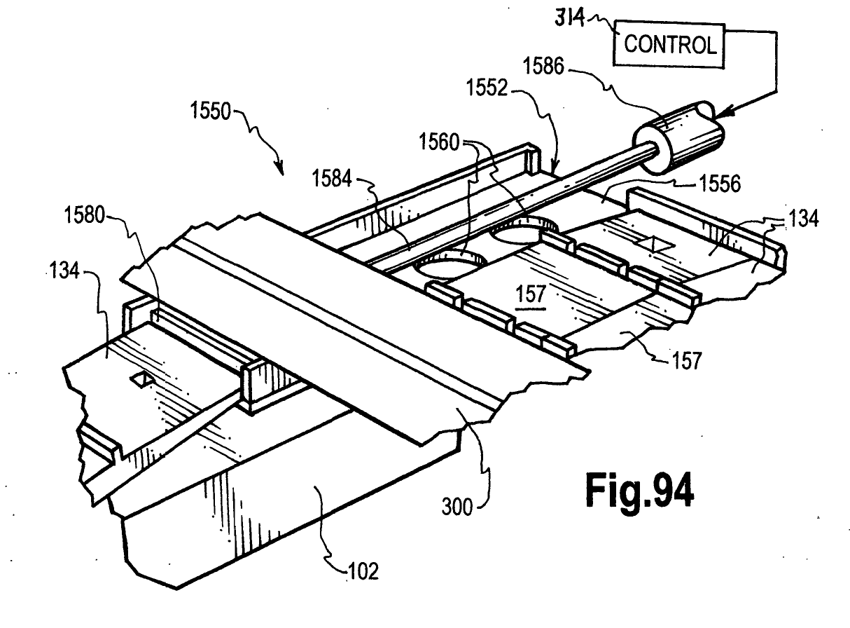

In lieu of the plate delivery and placement system shown and described in conjunction with FIG. 85, the plate delivery system 1550 shown in FIGS. 92-94 may be used. Tie plates 132, with channels 157 up, are sequentially placed on a reciprocal tray 1552, the width of which is slightly greater than the width of tie plate 134. FIG. 92. Thus, the tandem plates 134 are aligned between and perpendicular to the opposed guide flanges 1554 of the tray 1552. Each plate 134 rests upon the top surface 1556 of a bottom plate 1558 of the tray 1552. Apertures 1560 in the bottom plate 1556 reduce weight.

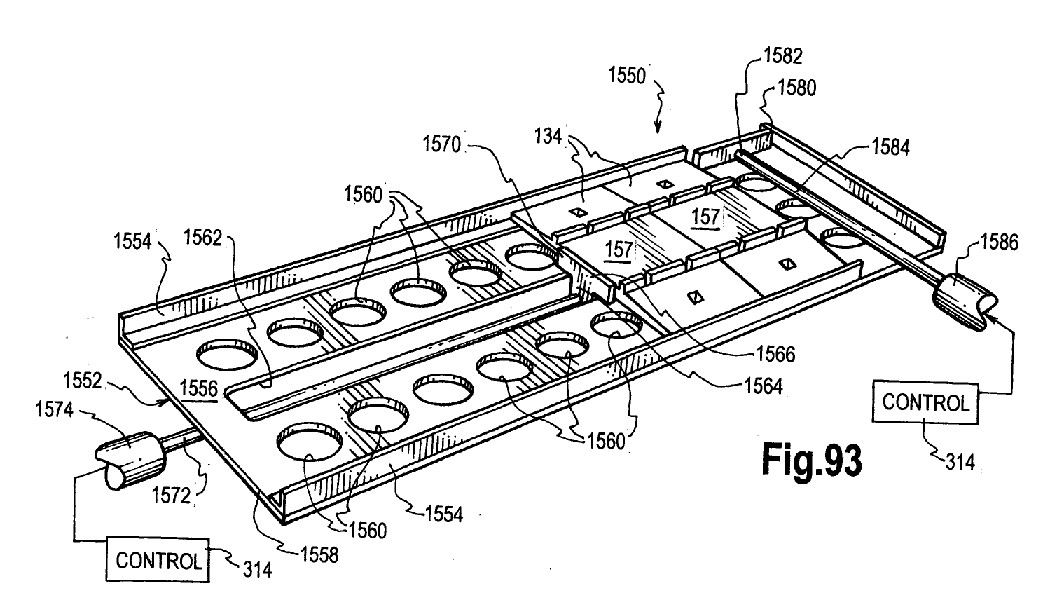

The bottom plate 1556 also comprises a longitudinal lineal slot 1562, located equal distance between the flanges 1554. A T-shaped push plate 1564 reciprocates in the slot 1562, with the top portion 1566 of the push plate 1564 being above and wider than the width of the slot 1562. As such, the top portion 1566 engages the trailing edge of the last tie plate 134 in the tray 1552. Displacement of the push plate 1564, from left to right, as viewed in FIGS. 92 and 93, displaces all of the plates 134 located in the tray 1552, at any given time, with the realization that the plates 134 are sequentially discharged from the tray 1552, as explained hereinafter.

Tie plates 134 are picked one at a time by each robot 1420 and placed on a waiting trough 1554 (FIGS. 92-94.) The tie plate cylinder 1574, under command of control 314, extends piston rod 1572, thereby crowding the plates toward the plate discharge end. At the discharge end, the plate pusher 1580 pushes the distal plate 134 perpendicularly to the tray 1552 responsive to activation of cylinder 1586 and extension of piston rod 1584 thereby pushing the distal plate on to the railroad tie 102.

Thereafter, the control 314, causes the piston rod 1584 to retract into the cylinder 1586, causing the pusher 1586 to return to its initial position.

The rectangular reciprocal push plate 1580 is positioned in a recess in one of the flanges 1554, as shown in FIG. 92. The push plate 1580 is integrally connected to the distal end 1582 of piston rod 1584, so that advancement and retraction of piston rod 1554 by associated cylinder 1586, under command of control 314 advances and retracts the push plate 1580.

Ties 102 are sequentially displaced into and from the position shown in FIG. 92. One tie is shown as located there in FIG. 92. One set of drill holes (facing up) in the tie 102 are accurately aligned with the distal plate 134, after it is displaced from the tray 1552. The one set of tie drill holes is precisely at a given distance from the distal plate 134, when the distal plate is on the tray 1552, so that when the cylinder 1586 displaces the rod 1584 and the push plate 1580 causing the distal plate 134 to be displaced from the tray 1552 a predetermined distance causing the displace plate 134 to be rests exactly over the drill holes in the tie 102, ready to receive spikes through the apertures in the tie plate into drill holes in the tie.

It is to be understood that a second plate delivery and placement system 1550 is disposed at the other end of the tie 102 and operates, as described above, to precisely place a second tie plate 134 over the other set of drill holes in the tie.

Once the spikes are insert through the plate apertures into the tie drill holes, the tie and rails are spiked to form part of a track section, in a manner explained herein. As the tie is formed as part of the track section, the rails move ahead the required distance, then another tie is moved in place and two plates are positioned as described above and are spiked. This repeats until the section of track is complete.

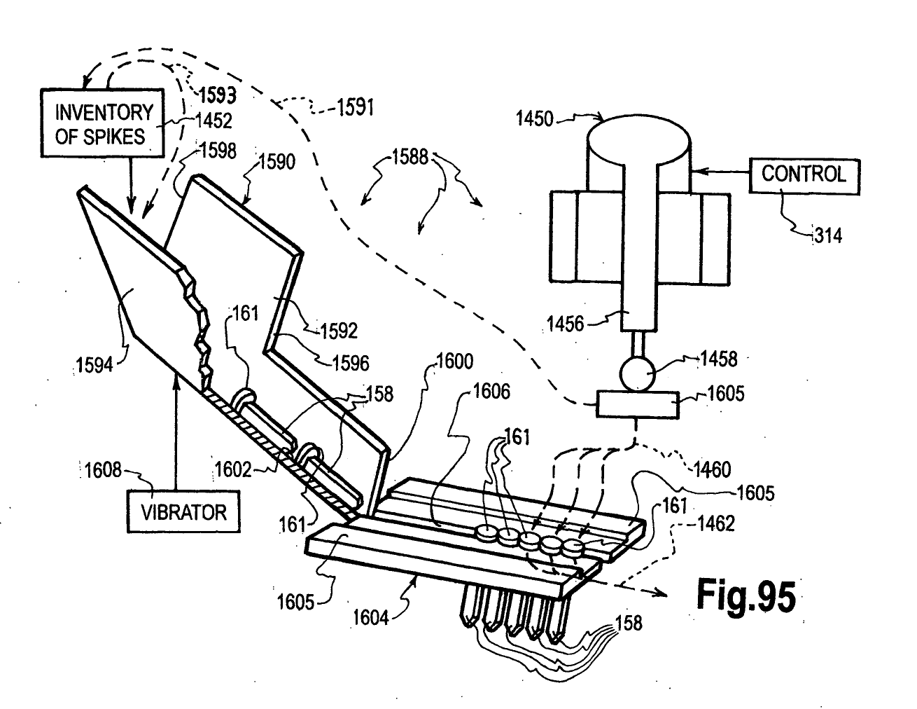

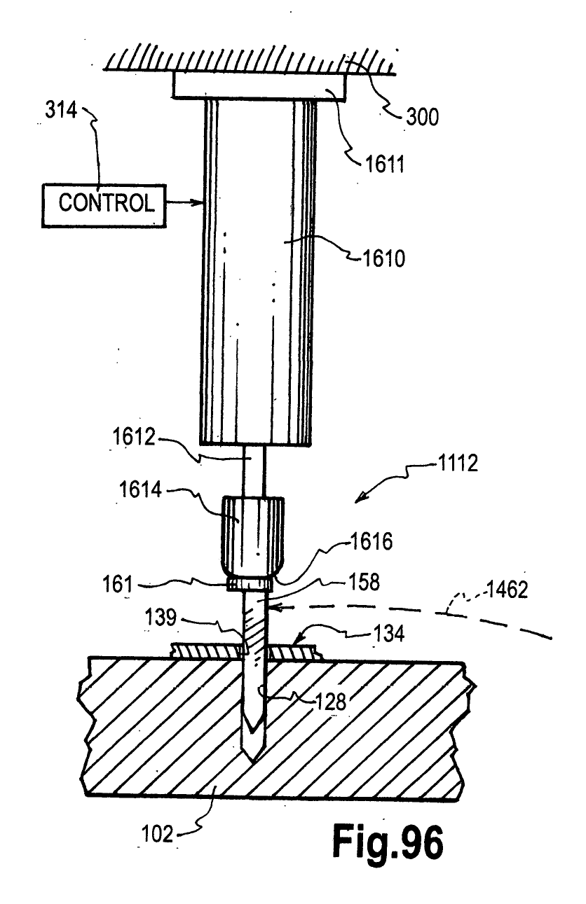

Reference is now made to FIGS. 95 and 96, which illustrate another presently preferred spike pick-up, delivery and placement system, generally designated 1588. The system 1588 comprises an inventory of spikes 1452, from which spikes 158 are discharged point down. The system 1588 further comprises the previously mentioned spike pick-up, delivery and displacement robot 1450. It should be realized that two systems 1588 will be used, one on each side of a tie 102 receiving spikes 158. Preferably robot 1450 removes spikes 158 one or more at a time from inventory 1452 and drops them into chute 1590, along travel paths 1591 and 1593.

Thus, the system 1588 comprises V-shaped sloped trough 1590 comprising downward converging planar sides 1592 and 1594. The V-shaped trough 1590 also comprises a proximal end edge 1598 and a distal end edge 1600. Adjacent to the trough distal end 1600 is disposed a spike holder 1604, also comprising part of the system 1588. Holder 1604 is slightly sloped from left to right as shown in FIG. 95 and receives spikes 158, head up, sequentially in a slot 1606.

As spikes 158 are discharged from inventory 1452, by robot 1450, they are dropped and land at the intersection, inverted apex or merger site 1602 of the converging sides 1592 and 1594 of the V-shaped trough, tip down and head up, as illustrated adjacent to intersection 1602. The spikes 158 move downwardly in succession along the merger line 1602, by force of gravity stimulated by vibrations receive from vibrator 1608.

The cutout 1596 in trough side 1592, accommodates visual inspection of the spikes 158 as they move down the intersection 1602, as well as manual removal or reorientation by an observer to the extent necessary.

The V-shaped trough may be formed of any suitable material, such as wood, steel, aluminum or synthetic material.

The force of gravity and vibration of the V-shaped trough 1590 accommodate the spikes 158, in sequence, to move and then fall off from the distal end 1600 of the V-shaped trough 1590 in alignment with the slot 1606 so that the tips of the spikes 158 extend downwardly and the heads 161 are held above the spike holder 1604 contiguous therewith and directly above to the slot 1606. The spike heads 161 are larger than slot 1606. Thus, the series of spikes 158 are placed in the position shown in FIG. 95 with respect to slotted holder 1604, such that the spikes may be readily lifted in a vertical upward direction by the heads 161.

At appropriate time, under command of the control 314, the robot 1450 is activated causing the arm 1456 to extend and swing to the extent necessary to follow path 1460 thereby bringing the magnetic head 1605, held by the pickup adapter 1458 of the robot 1450 into superposition immediately above and in alignment with one or more of the spikes nearest the right end of the holder 1604, as viewed in FIG. 95. When the pickup head 1605 to pick up one spike is magnetized, one or more spikes 158 is lifted out of the holder 1604. When three spikes 158 are simultaneously so lifted, the spikes are correctly spaced for tie insertion by reason of selective magnetism at head 1605, are lifted into the air by displacement of the robotic arm 1456. The lifted spike or spikes 158 and the magnetic head 1605 move along path 1462. See both FIGS. 95 and 96.

While one or three spikes 158 are described as being spatially lifted at any point in time, it should be readily apparent that one, two or more than three spikes could be so processed, as determined by those skilled in the art, when that is the best choice.

With reference to FIG. 96, the spike or spikes 158, spatially held magnetically by the head 1605, are moved into the correct positions above the tie 102 being assembled as part of a railroad track at station 1112. Only one such spike is illustrated in FIG. 96. The spike or spikes 158 are placed over one or more associated apertures 139 in an associated plate 134. For ease of description only one plate aperture 139 is illustrated in FIG. 95. Upon delivery of the spike or spikes 158, the robotic arm 1456 downwardly displaces each spike 158 a short distance to set the tip of the spike through the associated aperture 139 into the associated predrilled aligned bore 128 in the tie to essentially set each spike 158 so that its vertical orientation is temporarily retained, as shown in FIG. 96.

The spike placement system at station 1112 comprises one screwjack 1610 per spike to be inserted, secured at its proximal base 1611 rigidly to the frame 300. Screwjack 1610 is illustrated as comprising reciprocal rod 1612 to which a distal adapter 1614 is attached. The adapter 1614 comprises a rounded distal end surface 1616.

Activation of screwjack 1610, under command of control 314, causes the rod 1612 and the adapter 1614 to extend downwardly until the rounded surface 1616 becomes contiguous with the head 161 of the aligned spike 158 and, thereafter, drives the spike 158 downward until it is fully inserted into associated blind bore 128, with the spike head 161 firmly contiguous with the top adjacent surface of the plate 134. It is to be appreciated that the illustrated spike 158 is a plate-holding spike. It follows that when the spike 158 is used as a rail-retaining spike to ultimately engage a lower flange of the rail, the screwjack 1610 will displace the head 161 of the spike 158 downward only until the head 161 is firmly contiguous with the top surface of the lower rail flange.

When the spike 158 is fully inserted, under command of the control 314, the screwjack 1610 retracts the rod 1612 and the adapter 1614, returning the same to their initial locations.

The robotics depicted in FIGS. 75B, 85, 87 and 95 and disclosed herein comprise commercially-available adjustable robots having internal programming, which are conventionally set for their specific operative functions by those skilled in the art.

As is well known to those of ordinary skill in the art, the adjustment in the programming of each robot is conventionally accomplished with a hand pendant, where the robot arm end effector is moved into a position to pick a part, such as a plate, one or more spikes and a clip. A command syntax opens and closes the gripper or other device on the end of the end effector. Then the robot is moved to additional positions, which are saved as the path transversed by the robot. The path ensures that the robot arm does not contact other devices or obstacles in the vicinity of the robot. When a robot is working in conjunction with other pieces of automated equipment, conventional handshake signals are provided between the robot and the other pieces of automated equipment. This prevents collisions between the two. When a robot runs in automatic mode, the robot moves in a straight line to the next programmed position.

As depicted in FIG. 18A, certain of the controls 314 comprise both a conventional optical sensor 315, which responds to certain tie or other positions, and a commercially available activator 317, which respond to a position sensed by the associated optical sensor 315, causing the associated activator to initiate a predetermined mechanical response. The activator may be a cylinder, motor or the like. The optical sensors may comprise model E57P, manufactured by EATON CORP., or any other suitable commercially available optical sensor.

All optical sensors 315 are controlled by a master control 319, as shown in FIG. 18B. The master control comprises a commercially available product, such as model Prim Series 18-LM, available from EATON CORP. As is conventional, the robots handshake with the master control to time pick-up and delivery of plates, spikes and chips to prevent travel conflicts.

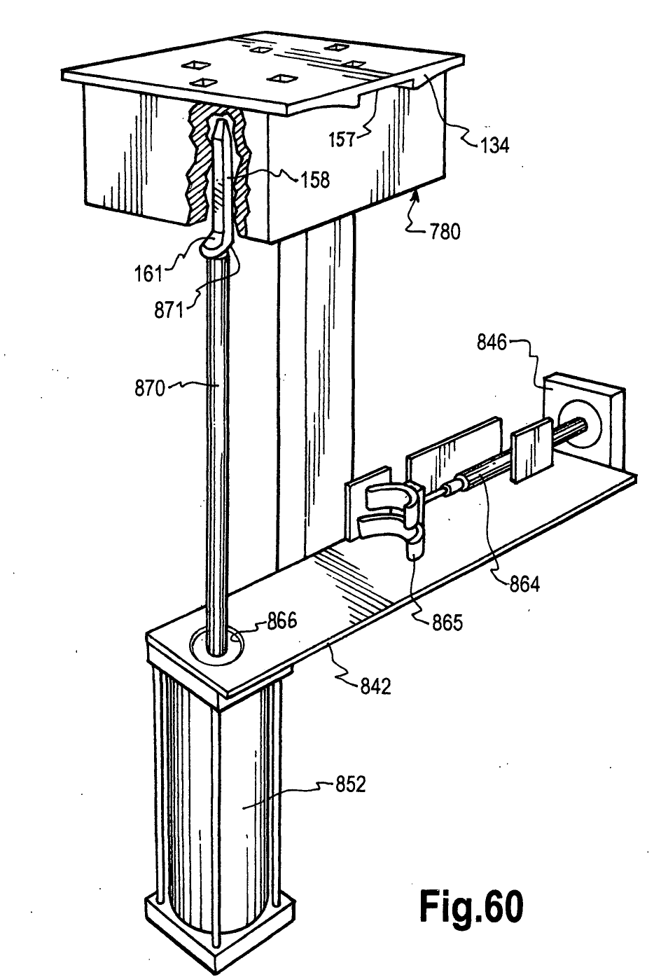

The following tabulation correlates the functions of the optical sensors 315 and the associated activators 317:

| | | Location of | | |
|---|---|---|---|---|
| | Number of | Each Control | Functions of the Optical | Type and Function of |
| FIG. | Controls 314 | 314 | Sensor 315 | Activator 317 |
| 18 | Four | Upper left | Instructs reservoir 239 | With clips in holders 232 |
| | | | and cylinder 242 to | and the lower, opposed |
| | | | lower and raise cylinder | piston rods 244 (FIG. 21) |
| | | | 234 assembly and clip | retracted, cylinder 342 |
| | | | holders 232. | lowers dual cylinder |
| | | | | assembly from the position |
| | | | | of FIG. 18 to that of |
| | | | | FIG. 20; later, afater the |
| | | | | clips are snapped onto the |
| | | | | rails and the piston rods |
| | | | | 244 retracted, the dual |
| | | | | cylinder is raised by |
| | | | | cylinder 242. |
| | | Central left | Activates and | Pushes both clip holders |
| | | and | deactivates cylinders | 230, when loaded with |
| | | Upper right | 226 when the dual | clips, into close proximity |
| | | | cylinders 234 are in | of dual cylinder 234 and, |
| | | | their upper positions. | when empty, to retract the |
| | | | | clip holders 230 away from |
| | | | | the dual cylinders 234. |
| | | Lower right | Detects when dual | Causes dual cylinder 234 |
| | | | cylinder assembly 234 | to extend piston rods 244 |
| | | | in its lower position | when in the lower position |
| | | | with clip holders 230 | to install the clips on the |
| | | | loaded with clips in | rails and then retracts the |
| | | | close proximity and, | rods 244 and empty |
| | | | later, detects the empty | holders 236. |
| | | | retracted clip holders. | |
| 23 | One | Central left | Detects a tie bundle 103 | Activates cylinder 312 to |
| | | | when correctly | move the tie bundle from |
| | | | positioned at ingress site | the ingress site 104 to full |
| | | | 104 and later when the | insertion at station 108 and |
| | | | tie bundle is fully | then, later, returns cylinder |
| | | | inserted within station | 312 to its beginning |
| | | | 108. | position. |
| 25 | Two | Lower right | Detects when a bundle | Activates the air bag 354 |
| | | | 103 of ties is accurately | of the scissor lift to 340 the |
| | | | located above scissor lift | tie bundle sequentially to |
| | | | 340, and, thereafter, | accommodate row-after- |
| | | | when the tie bundle is | row displacement of ties |
| | | | lift by one tie depth and | under force of push plate |
| | | | later still when the tie | 330 and, after full |
| | | | bundle has been fully | discharge of the tie bundle, |
| | | | discharged from the | returns the scissors lift 340 |
| | | | scissor lift 340. | and the air bag 354 to their |
| | | | | beginning positions. |
| | | Central left | Detects when a row of | Activates motor 334 |
| | | | ties is ready to be | causing conveyor belt 332 |
| | | | discharged from the tie | to rotate through a full |
| | | | bundle and, later, when | cycle discharging the row |
| | | | a tie row has been so | of ties from the tie bundle |
| | | | discharged. | and, thereafter, returning |
| | | | | the push plate 330 to its |
| | | | | beginning position. |
| 26 | One | Lower right | Detects a correctly | Activates power drive 382 |
| | | | position row of ties | to rotate the knurled rollers |
| | | | upon knurled rollers 372 | 372 thereby displacing the |
| | | | and, later, when there is | tie on the knurled rollers |
| | | | not a row of ties on | from left to right and, later, |
| | | | knurled rollers 372 | deactivates rollers 372 |
| | | | | when ties are not on the |
| | | | | rollers 372. |
| 27 | One | Lower right | As each tie is displaced | The left piston rods 396 are |
| | | | as explained in respect | retracted and the right |
| | | | to FIG. 26, this | piston rods 394, are |
| | | | movement is detected | progressively extended as |
| | | | and, later, when no ties | the ties are displaced to |
| | | | are on the rollers 372, | thereby space the ties of |
| | | | this is detected. | the row from each other, as |
| | | | | shown in FIG. 29. |
| 31 | Two | Lower right | Senses when one row of | Deactivates motor 446 |
| | | | ties is correctly | when the tie row is |
| | | | positioned at station 118 | accurately positioned at |
| | | | and, later, when drilling | station 118 and, later, after |
| | | | of ties has been | drilling activates motor |
| | | | completed. | 446 causing the knurled |
| | | | | rollers 440 to displace the |
| | | | | row of ties from station |
| | | | | 118. |
| | | Lower left | Senses a stationary row | Activates cylinders 428 to |
| | | | of ties correctly | cause cross beams 432 to |
| | | | positioned at station 118 | forcibly engage and hold |
| | | | and activates cylinders | the spaced row of ties |
| | | | 428 and, later, | stationary as drilling |
| | | | deactivates cylinders | occurs and, later, after |
| | | | 428 when tie drilling has | drilling, deactivates |
| | | | been completed. | cylinders 428 to lift cross |
| | | | | beams 432 thereby |
| | | | | accommodating |
| | | | | displacement of the drilled |
| | | | | row of ties from station |
| | | | | 118. |
| 32 | Two | Lower left | Detects the row of ties | Activates cylinder 450 to |
| | | | correctly positioned is | progressively elevate and |
| | | | being held stationary at | then lower drill bits 126 to |
| | | | station 118. | drill each tie in two spaced |
| | | | | locations. |
| | | Lower right | Detects the stationary | Activates power drive 456 |
| | | | row of ties correctly | to rotate drill bits 126 as |
| | | | positioned and held | they elevated and, later, |
| | | | stationary at station 118. | rotation stops as the drill |
| | | | | bits are lowered. |
| 34 | Five | Upper left | Senses when a tie is | Activates cylinders 428 to |
| and | | and | positioned against stop | lower fingers 510 to |
| 35 | | Upper right | 540. | correctly align the tie by |
| | | | | finger engagement with |
| | | | | spread rollers 512 and to |
| | | | | activate cylinders 474 to |
| | | | | lower tie holding clamps |
| | | | | 534 on to the top surface of |
| | | | | tie and, after drilling, |
| | | | | deactivates cylinders 428 |
| | | | | and 474. |
| | | Lower right | Senses when a tie is | Activates the motor 490 to |
| | | | positioned against the | rotate drum 470 thereby |
| | | | stop 540. | insuring that the tie is |
| | | | | inverted by drum 470 and |
| | | | | the top surface of the tie is |
| | | | | horizontal, before stops |
| | | | | 534 are lowered and, later, |
| | | | | deactivates motor 490. |
| | | Lower left | Detects when the tie is | Cylinders 450 are activated |
| | | and | accurately aligned in all | to lift drill heads 122 and |
| | | Central right | respects and in contact | the drill bits are caused to |
| | | | with stop 540. | rotate and to be elevated to |
| | | | | drill the tie at the bottom. |
| 35A | One | Upper right | Senses the saw kerf 477 | Causes rotation of the |
| | | | in the associated tie | barrel 470 to horizontally |
| | | | when the tie is fully | orient and inverted tie |
| | | | inserted into the barrel | thereby placing the kerf at |
| | | | 470. | the bottom of the tie. |
| 36 | Two | Central left | Senses when a tie is | Activates cylinders 428 to |
| | | and | positioned against stop | lower fingers 510 against |
| | | Central right | 540. | spaced rollers 512 to |
| | | | | engage and correctly align |
| | | | | the inverted tie end-to-end. |
| 37 | One | Upper left | Senses when the tie is | Cylinders 474 are activated |
| | | | inverted and accurately | which cause stop pads 534 |
| | | | aligned in all respects | to engage and hold the tie |
| | | | and in contact with stop | inverted tie stationary, |
| | | | 540. | while the drill bits are |
| | | | | rotated and elevated. |
| 38 | One | Lower right | After drilling, retraction | Activates cylinders 535 to |
| | | | of the drill bits is | displace the tie to elevate |
| | | | sensed. | the proximal stop 540 |
| | | | | allowing the knurled |
| | | | | rollers to displace the tie. |
| 39 | One | Upper Central | Senses a tie adjacent to | Activates cylinders 482 to |
| | | | stop 564 and, later, | advance and retreat stop |
| | | | detects when the tie has | 564 where advancement of |
| | | | been drilled. | stop 564 causes continuous |
| | | | | forceful engagement with |
| | | | | the tie by the stop 564 and, |
| | | | | to extent necessary |
| | | | | advances the tie until the |
| | | | | tie engages stop 540 and, |
| | | | | later, retracts the stop via |
| | | | | deactivation of cylinders |
| | | | | 482 after drilling. |
| 40 | Two | Upper left | Senses a tie plate on | Causes power drive 583 to |
| | | | conveyor 582 and, later, | displace conveyor 582 and, |
| | | | senses the absence of a | later, stops displacement of |
| | | | tie plate on conveyor | conveyor 582. |
| | | | 582. | |
| | | Central left | Senses a tie plate on | Causes conveyors 586 and |
| | | | conveyor 582 adjacent | 588 to be displaced. |
| | | | to conveyor 588. | |
| 41 | Two | Lower left | Senses a tie plate | Activates rotation of |
| | | | adjacent to conveyor | conveyor 586, 588, 597 |
| | | | 586 and, later, the | and 630; later, after a time |
| | | | absence of a plate on | delay, deactivators rotation |
| | | | conveyor 586. | of conveyors 586, 588, 597 |
| | | | | and 630 in the absence of |
| | | | | one or more tie plates. |
| | | Upper right | Functions to: (1) detect | (1) and (2) activates |
| | | | a first tie plate at push | cylinder 616 to displace the |
| | | | plate 612; (2) detect | push plate 612 and the tie |
| | | | displacement of first tie | plate transferring the first |
| | | | plate and push plate | tie plate onto the conveyor |
| | | | 612; (3) detect a second | 630 and then retracts the |
| | | | tie plate at push plate | push plate 612 while |
| | | | 684; (4) detects | causing cylinders 664 to |
| | | | displacement of the | lift stop 622; (3) and (4) |
| | | | second tie plate and | activates cylinder 680 to |
| | | | push plate 684; (5) | displace push plate 684 and |
| | | | detects a tie plate at | the second tie plate |
| | | | push plate 635; (6) | transferring the second tie |
| | | | detect displacement of | plate along stop 670 onto |
| | | | the first tie plate and the | conveyor 630 while |
| | | | push plate 635; (7) | causing cylinder to lower |
| | | | detect the second tie | stop 622 and then retracts |
| | | | plate at push plate 706; | push plate 684; (5) and (6) |
| | | | (8) detects displacement | activates cylinder 654 to |
| | | | of the second tie plate | displace push plate 635 and |
| | | | and the push plate 706; | the first tie plate along stop |
| | | | (9) after an interval of | 636 transferring the first tie |
| | | | time when no tie plate is | plate onto the aligned tie |
| | | | detected on conveyor | plate inverter 660, while |
| | | | 597, power drive 598 is | causing cylinder 700 to |
| | | | deactivated and | elevate stop 636 as push |
| | | | conveyors 586, 585, 597 | plate 635 is retracted by |
| | | | and 630 are stopped. | cylinder 654; and (7) and |
| | | | | (8) activates cylinder 710 |
| | | | | to displace the push plate |
| | | | | 706 and the second tie |
| | | | | plate transferring the |
| | | | | second tie plate along stop |
| | | | | 704 onto the second tie |
| | | | | plate inverter 660, while |
| | | | | causing cylinder 700 to |
| | | | | lower stop 636. |
| 42 | Two | Upper left | Covered in respect to | Covered in respect to |
| | | | FIGS. 40 and 41, | FIGS. 40 and 41, above. |
| | | | above. | |
| | | Lower central | Covered in respect to | Covered in respect to |
| | | | FIGS. 40 and 41, | FIGS. 40 and 41, above. |
| | | | above. | |
| 43 | Two | Upper right | Covered in respect to | Covered in respect to |
| | | | FIG. 41. | FIG. 41. |
| 44 | Two | Upper left | Covered in respect to | Covered in respect to |
| | | | FIG. 41. | FIG. 41. |
| | | Lower left | Senses presence of an | Reciprocates the associated |
| | | and | inverted tie plate in the | activator 753 to push the |
| | | Right central | associated magazine 660 | aligned inverted bottom tie |
| | | | ready to be discharged. | plate out of the associated |
| | | | | magazine 668 using push |
| | | | | plate 755 (FIG. 44A). |
| 44A | One | Upper right | Covered in respect to | Reciprocates the associated |
| | | | FIG. 44 | activator 753 to push the |
| | | | | bottom aligned inverted tie |
| | | | | plate out of the associated |
| | | | | magazine 668 using push |
| | | | | plate 755. |
| 45 | Two | Lower left | Senses a full shuttle 760 | Activates cylinders 770 to |
| | | | over cylinders 770 | lift the five inverted tie |
| | | | | plates from the shuttle 760 |
| | | | | for placement on the |
| | | | | underside of a tie as shown |
| | | | | in FIG. 50. |
| | | Lower right | Senses each inverted tie | Activates power drive 766 |
| | | | plate discharged from | to advance shuttle 760 to |
| | | | magazine 660 onto | first sequentially receive |
| | | | shuttle 754. | additional spaced inverted |
| | | | | tie plates and, when the |
| | | | | shuttle is full, to transport |
| | | | | the loaded shuttle into |
| | | | | superposition over |
| | | | | cylinders 770 and, later, |
| | | | | when empty, the shuttle is |
| | | | | returned to its initial |
| | | | | position. |
| 47 | Three | Upper left | Senses when a row of | Activates cylinders 428 to |
| | | and | spaced ties is correctly | lower cross beams 432 to |
| | | Upper right | located at station 129. | hold the row of spaced ties |
| | | | | stationary as the tie plates |
| | | | | on shuttles 754 and 760 are |
| | | | | elevated against the |
| | | | | undersides of the ties and, |
| | | | | later, deactivate cylinders |
| | | | | 428 to elevate crossbeams |
| | | | | 432 after tie plates are |
| | | | | secured on tie ties. |
| | | Lower right | Senses when a row of | Stops shafts 442 and |
| | | | spaced ties is correctly | knurled rollers 440 until |
| | | | located at station 129. | the tie plates are elevated |
| | | | | and secured to the |
| | | | | undersides of the ties at |
| | | | | station 129 and then |
| | | | | triggers further rotation of |
| | | | | the shafts 442 and rollers |
| | | | | 440 to discharge the plated |
| | | | | ties from station 129 after |
| | | | | the cylinders 428 are |
| | | | | deactivated thereby lifting |
| | | | | cross beams 432. |
| 52 | Four | Upper left | Senses when a spike has | Activates cylinder 846 so |
| | | | been loaded on | that its piston rod displaces |
| | | | reciprocating tray 844. | to tray 844 and the loaded |
| | | | | spike to the position of |
| | | | | FIGS. 58 and 60. |
| | | Upper left | Senses a spike from arm | Activates spike |
| | | central | 798 available at ingress | displacement cylinder 808 |
| | | | site to the spike cylinder | (FIG. 54) to deliver a |
| | | | 815 | spike to the spike receiving |
| | | | | cylinder 815 and causes |
| | | | | rotation of spike-receiving |
| | | | | cylinder 815. |
| | | Upper central, | Senses a spike in the | Activates cylinder 852 to |
| | | central | position shown in FIG. | elevate piston rod 870 and |
| | | | 58. | the associated spike from |
| | | | | the position of FIG. 58 |
| | | | | through the position of |
| | | | | FIG. 60 to insert the |
| | | | | spike into the elevated tie |
| | | | | and, later, when the spike |
| | | | | is detected as being fully |
| | | | | inserted into the tie, |
| | | | | retracting the piston rod |
| | | | | 870 to its starting position. |
| | | Upper right | Senses when the spike | Activates cylinder 840 to |
| | | | has been inserted into | relocate rack 814. |
| | | | the tie and rod 870 has | |
| | | | been lowered and the | |
| | | | rack 814 is ready to be | |
| | | | relocated. | |
| 55 | One | Upper left | Senses when a spike has | Causes cylinder 815 to |
| | | | been displaced in to the | accept the incoming spike, |
| | | | spike ingress site of the | as shown in FIG. 56, and |
| | | | cylinder 815 and later | later causes rotation of the |
| | | | when the ingress site in | cylinder 815 via motor 862 |
| | | | vacant | accommodating spike |
| | | | | discharge from the cylinder |
| | | | | 815, as shown in FIG. |
| | | | | 57. |
| 56 | Two | Upper central | Senses the absence of a | Causes motor 862 to rotate |
| | | | spike at the ingress site | cylinder 815 into the spike- |
| | | | to cylinder 815 and later | receiving position of |
| | | | senses an inserted spike | FIG. 56 and later, with |
| | | | at cylinder 815. | spike received into cylinder |
| | | | | 815, rotates the spike and |
| | | | | the cylinder to the spike |
| | | | | discharge position of |
| | | | | FIG. 57. |
| | | Lower right | Senses when the spike | Activates cylinder 852 to |
| | | | discharged from | extend piston rod 870 and |
| | | | cylinder 815 is in the | later deactivates cylinder |
| | | | position of FIG. 58 | 852 to retract piston rod |
| | | | and later senses when | 870. |
| | | | position rod 870 has | |
| | | | fully inserted the | |
| | | | associated spike into the | |
| | | | elevated tie. | |
| 58 | One | Lower right | Senses the availability | Activates cylinder 817 to |
| | | | of a spike in cylinder | extend piston rod 819 |
| | | | 815 ready to be | thereby lifting cylinder 815 |
| | | | discharged, and later | a distance sufficient to |
| | | | when the spike has been | avoid interference with the |
| | | | discharged. | head 161 of the spike as |
| | | | | the spike is discharged |
| | | | | from cylinder 818 and later |
| | | | | deactivates cylinder 817 so |
| | | | | the piston rod 819 and the |
| | | | | cylinder 815 return to their |
| | | | | initial position. |
| 62 | Three | Upper central | Senses when a bottom | Deactivates conveyor |
| | | | plated tie has been | system 910 when one tie to |
| | | | correctly delivered to | be inverted therein is in |
| | | | station 900 and, later, | rack 912 and, later, |
| | | | when another tie on | activates conveyor system |
| | | | conveyor 910 needs to | 910 to introduce another tie |
| | | | be so delivered, | into station 900 at rack |
| | | | | 912. |
| | | Upper right | Senses proper placement | Activates reversible motor |
| | | | of the incoming tie in | 932 to turn shaft 922 |
| | | | rack 912 and later when | rotating the tie-receiving |
| | | | the tie in rack 912 has | rack 912 and inserted tie to |
| | | | been inverted and | invert and discharge the tie |
| | | | discharged from rack | followed by reversal of the |
| | | | 912. | motor 932 to return the |
| | | | | shaft 922 and the rack 912 |
| | | | | to their initial positions. |
| | | Lower central | Senses when an inverted | Activates cylinders 940 to |
| | | | tie is not adjacent to stop | place the stop 934 in its |
| | | | 934 and later when an | lower position to hold |
| | | | inverted tie is adjacent | stationary an incoming tie |
| | | | to stop 934. | conveyed on conveyor 936 |
| | | | | and 938 by contact with |
| | | | | the lowered stop 934 and, |
| | | | | later, deactivates the |
| | | | | cylinders 940 to lift the |
| | | | | stop 934, allowing the |
| | | | | adjacent tie to be displaced |
| | | | | onto conveyor 936 and 938 |
| | | | | and thence onto either |
| | | | | conveyors 970 and 972, |
| | | | | 954 and 956 in the process |
| | | | | of creating two tiers of |
| | | | | dischargeable ties. |
| 63 | Two | Upper right | Covered in respect to | Covered in respect to |
| | | | FIG. 62, above. | FIG. 62, above. |
| | | Lower central | Covered in respect to | Covered in respect to |
| | | | FIG. 62, above. | FIG. 62 above. |
| 64 | Four | Upper right | Somewhat respecting | Somewhat respecting |
| | | | motor 932 covered in | motor 932 some covered in |
| | | | respect to FIG. 62, | respect to FIG. 62, above |
| | | | above | |
| | | Central right | Senses delivery of ties | Activates motors 976 and |
| | | (part not | from beam 964 to | 950 respectively to |
| | | covered in | conveyors 970 and 972 | sequentially rotate |
| | | respect to motor | for lower tier placement | conveyors 970 and 972 and |
| | | 932 in FIG. | and directly to | 954 and 956. |
| | | 62) | conveyors 954 and 956 | |
| | | | for upper tier placement. | |
| | | Central left | Senses sequential ties | Activates and deactivates |
| | | And | being released by lifting | cylinder 966 to lift and |
| | | Upper right | stop 934 destined | lower beams 962 and 964 |
| | | | respectively for upper | with one tie thereon to |
| | | | and lower tier | introduce the tie via |
| | | | accumulations. | activation of push blade |
| | | | | 967 to the upper tier of ties |
| | | | | and accommodates direct |
| | | | | conveyor displacement of |
| | | | | the next tie to the lower tier |
| | | | | via activation of push blade |
| | | | | 967. |
| | | Upper left | Senses a tie being | Displaces conveyors 970 |
| | | | introduced onto | and 972 by one tie width as |
| | | | conveyors 990 and 972. | push blade 967 pushes the |
| | | | | tie onto conveyors 970 and |
| | | | | 972. |
| 65A | Three | Central right | Senses a tie in the | Activates motor 932 to |
| | | | upright rack 912 | rotate shaft 922 inverting |
| | | | | the tie and rack 912, |
| | | | | discharging the tie onto |
| | | | | conveyors 936 and 938. |
| | | Central left | Senses a tie on | Activates cylinder 940 to |
| | | | conveyors 936 and 938 | lift stop 934 allowing |
| | | | against stop 934. | conveyors 936 and 938 to |
| | | | | displace the tie onto |
| | | | | conveyors 954 and 956 |
| | | | | from conveyors 936 and |
| | | | | 938. |
| | | Lower right | Senses discharge of a tie | Activates motor 936 to |
| | | | from rack 912 onto | displace conveyors 936 |
| | | | conveyors 936 and 938. | and 938 and the tie. |
| 65B | Two | Upper left | Covered in respect to | Covered in respect to |
| | | | FIG. 65A, above. | FIG. 65A, above. |
| | | Lower right | Scnses delivery of each | Activates motor 950 to |
| | | | successive tie onto | incrementally displace |
| | | | conveyors 954 and 956. | conveyors 954 and 956 |
| | | | | forward by one tie width at |
| | | | | a time to create a group of |
| | | | | contiguous ties on |
| | | | | conveyors 954 and 956. |
| 65C | Two | Central left | Senses displacement of | Activates cylinder 940 to |
| | | | ties on conveyors 954 | lower stop 934 to restrain |
| | | | and 956. | the next tie on conveyors |
| | | | | 936 and 938. |
| | | Lower right | Senses every-other tie | Activates cylinder 966 to |
| | | | on conveyors 954 and | elevate short beams 962 |
| | | | 956. | and 964 to elevate every |
| | | | | other tie on beams 960 and |
| | | | | 962 for placement at the |
| | | | | upper tier of ties. |
| 65D | Three | Upper right | Senses an elevated tie | Activates cylinder 973 to |
| | | | on beams 962 and 964. | extend push plate 967 |
| | | | | thereby displacing the tie |
| | | | | from beams 960 and 962 |
| | | | | onto conveyors 970 and |
| | | | | 972. |
| | | Lower right | Covered in respect to | Covered in respect to |
| | | | FIG. 65C. | FIG. 65C. |
| | | Lower central | Senses delivery of a tie | Momentarily activates |
| | | | onto conveyors 970 and | motor 970 to advance |
| | | | 972. | conveyors 970 and 972 a |
| | | | | distance equal to one tie |
| | | | | width. |
| 67 | One | Upper left | Senses a row of spaced | Activates power drive |
| | | | plated ties ready to be | 1010 to rotate shafts 442 |
| | | | displaced into station | and knurled rollers 440 to |
| | | | 184. | displace the row of plated |
| | | | | ties into station 184 against |
| | | | | stop 1012 (FIG. 68). |
| 69 | One | Central right | Senses a row of spaced | Activates a plurality of |
| | | | plated ties against stop | cylinders 1016 to lower |
| | | | 1012. | force - applying beam |
| | | | | 1020 into engagement with |
| | | | | the top of the ties; holding |
| | | | | ties in the correct spacing |
| | | | | to assist in forming a track |
| | | | | section. |
| 70 | Three | Upper Central | Senses an available rails | Activates the rail delivery |
| | | | from inventory 1024. | equipment bringing the |
| | | | | available rails to the |
| | | | | ingress site of conveyor |
| | | | | 1028. |
| | | Lower right | Senses entry of a rail | Activates motor 1032 to |
| | | | onto conveyor 1028. | displace conveyor 1028 |
| | | | | and the entering rails when |
| | | | | deposited thereon. |
| | | Lower central | Senses a rail being | Activates motor 1036 to |
| | | | discharged from | displace the conveyor 1031 |
| | | | conveyor 1028. | and the rails when placed |
| | | | | thereon. |
| 73 | One | Central right | At the track section | Activates cylinder 1054 |
| | | | assembly station senses | forceably drives tie rail- |
| | | | when plated ties are | engaging spikes fully in |
| | | | correctly positioned | rods 1060 using rods 1060. |
| | | | with rail-engaging | |
| | | | spikes partially inserted | |
| | | | through tie plate | |
| | | | apertures and into drill | |
| | | | holes in the ties. | |
| 75A | Two | Upper left | Senses availability of | Activates motor 1110 to |
| | | | two rails for periodic | power rotate rollers 1108 |
| | | | displacement from the | and thereby displace the |
| | | | rail discharge station | two rails to station 1112. |
| | | | 1102 to the track | |
| | | | assembly station 1112. | |
| | | Lower right | Senses each successive | Activates motor 1128 to |
| | | | plated tie placed at the | sequentially displace the |
| | | | discharge end of | ties from the discharge end |
| | | | conveyors 1126. | of conveyors 1126 to track |
| | | | | assembly station 1112. |
| 75B | Seven | Upper left | Senses when an | Activates plate robots 1 |
| | | and | Incoming pre-drilled tie | and 2 to accurately place |
| | | Lower left | is correctly positioned at | two tie plates on top of the |
| | | | station 1112. | tie. |
| | | Upper left | Senses when the two tie | Activates spike robots 1 |
| | | central | plates are accurately | and 2 to accurately insert |
| | | and | placed on the top of the | spikes through tie plate |
| | | Lower central | tie at station 1112. | apertures into the pre- |
| | | | | drilled blind bores in the |
| | | | | tie. |
| | | Upper right | Senses, at station 1112, | Activates clip robots 1 and |
| | | central | the correct positioning | 2 to accurately place two |
| | | and | of at least two plated | clips between two adjacent |
| | | Lower central | and spiked ties. | spaced ties on the bottom |
| | | | | flange of both rails. |
| | | Upper right | Senses when a | Activates joint bar robots 1 |
| | | And | completed track section | and 2 thereby delivering |
| | | Lower right | exists at station 1112. | two joint bars to the distal |
| | | | | end of the track section. |
| 78 | One | Upper left | Senses when station | Activates motor 1211 |
| | | | 1112 is emptying and | causing the two spaced |
| | | | when station 1202 has | rails to be displaced |
| | | | two correctly positioned | incrementally toward |
| | | | rods in place and it is | station 1112 using optical |
| | | | time to assemble a track | encoder 1114 and pop-up |
| | | | station at station 1112. | stops 1116. |
| 79 | Three | Lower central | Senses when a bundle of | Activates air bag 1238 to |
| | | | ties has been correctly | elevate the bundle of ties, |
| | | | placed on rollers 1242 | the rollers 1242 and the |
| | | | over scissors lift 1234 | frame 1248 to the most |
| | | | and later when a row of | elevated position and, later, |
| | | | ties has been displaced | elevates the bundle of ties, |
| | | | from the top of the | the frame 1240 and the |
| | | | bundle. | rollers 1242 by one row |
| | | | | after one row has been |
| | | | | displaced from the bundle. |
| | | Upper right | Senses when a row of | Activates motor 1264 to |
| | | | ties comprising the | displace push plate 1260 |
| | | | bundle is elevated and | from right to left thereby |
| | | | ready to be displaced | displacing the most |
| | | | from the bundle. | elevated row of ties from |
| | | | | the bundle through opening |
| | | | | 1250 onto rollers 1278 |
| | | | | (FIG. 80). |
| | | Lower left | Senses an incoming row | Moves the frame 1272 and |
| | | | of ties passing through | the rollers 1270 up and |
| | | | opening 1230 into site | down by activation and |
| | | | 1126. | deactivation of cylinder |
| | | | | 1274 to accommodate |
| | | | | aligned reception of an |
| | | | | incoming row of ties |
| | | | | through opening 1250, the |
| | | | | rollers 12570 being |
| | | | | positioned to accommodate |
| | | | | reception of the ties and |
| | | | | conveyance from rollers |
| | | | | 1270 on conveyors 1126. |
| 80 | One | Lower central | Covered in respect to | Covered in respect to |
| | | | FIG. 79, above. | FIG. 79, above. |
| 81 | One | Lower left | Senses the presence of a | Activates motor 1292 to |
| | | | row of ties on conveyors | displace the conveyors |
| | | | 1126. | 1126 with the row of |
| | | | | contiguous ties thereon to |
| | | | | station 1114. |
| 82 | Three | Lower left | Senses when encoder | Sequentially activates |
| | | | 1146 activates stops | cylinder 1307 to push a |
| | | | 1148 by which a | spaced tie against wall |
| | | | forward tie becomes | 1301 at push blade 1303 |
| | | | spaced at 1299 from the | and then activates cylinders |
| | | | next tie and the | 1311 causing clamshell |
| | | | conveyors 1126 stop | blades 1321 to engage the |
| | | | after the space 1299 has | spaced tie thereby aligning |
| | | | been obtained. | and holding the spaced tie |
| | | | | in place as it receives drill |
| | | | | holes at two sites at the |
| | | | | underside of the spaced tie, |
| | | | | after which the blades 1321 |
| | | | | are lifted and cylinder 1333 |
| | | | | activated causing push |
| | | | | plate 1303 to return the |
| | | | | drilled tie into alignment |
| | | | | with the other ties on |
| | | | | conveyors 1126. |
| 83 | Two | Lower left | As a spaced row of ties | When a tie in recesses |
| | | and | is displaced on | 1332 is detected, motor |
| | | Lower right | conveyors 1126 to an | 1340 is activated to rotate |
| | | | ingress location directly | the inversion wheel 1300 |
| | | | adjacent to inversion | to lift the tie in recesses |
| | | | wheel 1300, the lead tie | 1332, invert the tie and |
| | | | is advanced into spaced | redeposit the tie on |
| | | | recesses 1332, where it | conveyors 1126 at the exit |
| | | | is detected. | side of inversion wheel |
| | | | | 1300, drill holes up. |
| 84 | Two | Central left | When a tie, on | Conveyor systems 1350 |
| | | and | conveyors 1126, holes | and 1354 are elevated to |
| | | Central right | up, is accurately placed | the same elevation as |
| | | | at station 1164 and the | stationary conveyor system |
| | | | conveyors 1126 are | 1352 by activation of |
| | | | briefly stopped, this | cylinders 1394, after which |
| | | | placement of the tie is | motor 1390 is activated |
| | | | sensed. | thereby driving displacing |
| | | | | conveyors 1350, 1352 and |
| | | | | 1354 thereby delivering the |
| | | | | distal tie from station 1164 |
| | | | | into super position over |
| | | | | conveyors 1170, the distal |
| | | | | tie coming to rest on the |
| | | | | conveyors 1170 after |
| | | | | detecting thereof, followed |
| | | | | by deactivation of motor |
| | | | | 1390 and lowering of |
| | | | | conveyors 1350 and 1354 |
| | | | | by deactivation of |
| | | | | cylinders 1394. |
| 85 | Five | Upper left, | When a tie is accurately | Plate placement robots |
| | | Lower left | positioned at station | 1420 are activated to |
| | | and | 1112 on stationary | retrieve and correctly |
| | | Right central | conveyors 1170, such is | placed two spaced tie |
| | | | sensed and later placed | plates over the two spaced |
| | | | tie plates on the tie are | sets of drill holes in the tie |
| | | | sensed and then the | and thereafter motor 1128 |
| | | | advanced placement of | is activated to advance the |
| | | | the plated tie adjacent to | conveyors 1170 and the |
| | | | robots 1450 is sensed. | plated tie to a location |
| | | | | adjacent to robots 1450 |
| | | | | after which robots 1450 are |
| | | | | activated to retrieve and |
| | | | | insert spikes through tie |
| | | | | plate apertures into at least |
| | | | | some drill holes in the tie |
| | | | | after which the tie is lifted, |
| | | | | as explained in respect to |
| | | | | FIG. 86, below. |
| 86 | One | Lower right | When the tie is plated | Activates screwjacks 1444 |
| | | | and spiked, the tie is at a | (FIG. 86) to lift the |
| | | | location lower than the | plated and spiked tie |
| | | | incoming rails, which is | upward away from |
| | | | sensed. | conveyors 1170 so that the |
| | | | | channels of the tie plates |
| | | | | are contiguous with the |
| | | | | somewhat cambered |
| | | | | bottom surface of the |
| | | | | correctly positioned |
| | | | | incoming rails as the robots |
| | | | | 1450 retrieve and insert |
| | | | | spikes through some of the |
| | | | | tie plate apertures into at |
| | | | | least some of the drill holes |
| | | | | in the tie, after which the |
| | | | | screwjacks 1444 are |
| | | | | lowered. |
| 87 | Two | Upper right | Senses two spaced | Activates robots 1480 to |
| | | and | plated and spiked ties | retrieve clips from |
| | | Lower right | attached to rails in a | inventory 1490 and causes |
| | | | stationary lowered | the clips to be placed on |
| | | | position on conveyors | the bottom flanges of both |
| | | | 1170. | rails to accurately hold the |
| | | | | two ties in the correct |
| | | | | spaced relationship as a |
| | | | | track section is formed. |
| 88 | One | Lower central | Senses when robots | Activates cylinders 1504 to |
| | | | 1480 have placed a clip | snap the clips onto the |
| | | | in each of the four | lower flanges of the rails. |
| | | | adjacent clip holders | |
| | | | 1500 for insertion onto | |
| | | | the lower flanges of the | |
| | | | rails. | |
| 92, 93 | Two | Lower left | Senses when the space | Activates cylinder 1574 |
| and | | and | adjacent to push bar | causing push plate 1566 to |
| 94 | | Lower right | 1580 does not contain a | advance all tie plates 134 |
| | | | tie plate and when a tie | on tray 1552 toward the |
| | | | is positioned to receive a | discharge end thereof and, |
| | | | tie plate from tray 1552. | when a tie plate is at the |
| | | | | distal end of tray 1552, |
| | | | | activates cylinder 1586 |
| | | | | causing advancement of |
| | | | | push plate 1580 to |
| | | | | correctly advance the distal |
| | | | | tie plate on to the top of the |
| | | | | tie accurately over pre- |
| | | | | drilled holes in the tie. |
| 95 | One | Upper right | Senses a need for spikes | Activates robot 1450 to |
| | | | in magazine 1604 and | magnetically retrieve |
| | | | later senses a need for | spikes from inventory 1452 |
| | | | transfer of spikes from | and drop them into sloped |
| | | | magazine 1604 for plate | chute 1590 for tandem |
| | | | and tie insertion, | grouping in slot 1606 of |
| | | | | magazine 1604 and alter |
| | | | | activates robot 1450 to |
| | | | | magnetically pick up |
| | | | | multiple spikes from |
| | | | | magazine 1604 for partial |
| | | | | insertion through apertures |
| | | | | in the tie plate into drill |
| | | | | holes in the tie. |
| 96 | One | Upper left | Senses when one or | Activates one or more |
| | | | more spikes have been | screwjacks 1610 causing |
| | | | partially inserted | one or more adaptors 1614 |
| | | | through apertures in the | to move downwardly to |
| | | | tie plate drill holes. | engage associated spike |
| | | | | heads 161 to drive the |
| | | | | spikes either fully against |
| | | | | the tie plate or left |
| | | | | somewhat elevated to |
| | | | | allow passage of a rail |
| | | | | beneath the spike head. |

While any suitable commercially available software may comprise part of the systems disclosed above, it is presently preferred that Schneider Unity Pro S (for PLC Software together with CNC machine technology) be used to control all mechanisms and their movements. This software easily becomes accommodating to the disclosed systems by those skilled in the art, using ordinary skill. Accordingly, no detailed software disclosure is required.

The invention may be embodied in other specific forms without departing from the spirit of the essential characteristics thereof. The present embodiments, therefore, are to be considered in all respects as illustrative and are not restrictive, the scope of the invention being indicated by the appended claims rather than by the foregoing description, and all changes which come within the meaning and range of equivalency of the claims are therefore intended to be embraced herein.

What is claimed and desired to be secured by Letters Patent is:

1. A fully automated method of constructing, at an off-site location, a length of railroad track, comprising the acts of:
automatically displacing one or more wooden railroad ties to a drilling station; automatically drilling holes through one surface of the one or more ties into two spaced sites such that the drilled holes each comprise a pattern defining the gauge, such that the pattern of drilled holes match apertures of yet-to-be-provided railroad plates;
automatically placing and retaining spaced railroad plates contiguously upon the one tie surface of the one or more ties so that apertures in each plate are aligned with the drilled holes;
automatically delivering railroad spikes to the plate locations on the one or more ties and automatically force-inserting spikes through apertures in the contiguous plates into the drilled holes in the one or more ties to retain the plates and ties together; automatically placing the plurality of plated ties in parallel spaced relation with the plates up forming two linear rows of plates; automatically placing two parallel rails upon a central channel of the plates of each row in perpendicular relation to the ties;
automatically force-displacing spikes so that they extend through plate apertures into drilled holes in the ties and contiguously and retainingly engage the bottom flanges of the two rails to thereby provide an off-site section of railroad track.

2. A method according to claim 1 wherein the one or more ties comprise rows of ties sequentially displaced to the drilling station.

3. A method according to claim 1 wherein the ties of each row are displaced into spaced parallel relation.

4. A method according to claim 1 wherein automatic drilling occurs in an upward direction.

5. A method according to claim 1 wherein automatic drilling occurs in a downward direction.

6. A method according to claim 1 wherein the plates are placed below the ties and the spikes are force-inserted in an upward direction.

7. A method according to claim 1 wherein the plates are placed above the ties and the spikes are force-inserted in a downward direction.

8. A method according to claim 1 wherein rail-engaging spikes are partially inserted through plate apertures into the drilled holes during the first force-inserting act, leaving room for rail placement under heads of the rail-engaging spikes.

9. A method according to claim 1 wherein the drilled holes comprise blind bores.

10. A method according to claim 1 wherein the ties are displaced parallel to a tie processing path.

11. A method according to claim 1 wherein the ties are displaced perpendicular to a tie processing path.

12. A method according to claim 1 wherein the displacing act comprises correctly longitudinally and transversely positioning the ties at the drilling to insure accurate drilling.

13. A method according to claim 12 wherein the placing and retaining and the delivering acts comprises correctly longitudinally and transversely positioning the ties to insure tie placement accuracy.

14. A method according to claim 1 where the drilling, the placing and returning and delivering acts are accompanied by the act of position-securing each tie in its proper and accurate location against tie displacement.

15. A method according to claim 1 wherein the plates are biased in position as the spikes are force-inserted.

16. A method according to claim 1 wherein the delivering act comprises processing spikes in sequence from a source into a revolving spike accumulator and thence dispatching spikes sequentially into an installation head followed by force insertion of each spike into the tie through an aperture in an associated plate.

17. A method according to claim 1 wherein the force-inserting spikes act is selected from the group comprising force-inserting rail spikes before the placing act, force-inserting rail spikes after the placing act and force-inserting rail spikes in part before and in part after the placing act.

18. A method according to claim 1 wherein the ties delivered to the drilling station are spaced as a row of ties by surface-gripping rollers non-rotatably but slideably carried on successive power-driven shaft such that the surface-gripping rollers grab and displace the ties longitudinally and laterally.

19. A method according to claim 6 wherein the ties with spike-held plates secured on the bottom of the ties are discharged and inverted so that tie plates are on the top of the ties.

20. A method according to claim 1 where the placing and retaining acts comprises transporting plates sequentially from a source, accumulating the plates on spaced trays and positioned and retained the plates by a resilient basis prior to and during the force-inserting act.

21. A fully automated method of off-site constructing a length of railroad track comprising the acts of:
a. automatically placing one or more wooden railroad ties in a processing position;
b. automatically drilling holes through one surface of the one or more ties into two spaced sites such that the drilled holes define the gauge and match apertures in yet-to-be-provided railroad plates;
c. automatically placing and retaining spaced railroad plates contiguously upon the one tie surface so that apertures in each plate are aligned with drilled holes;
d. automatically delivering railroad spikes and automatically force-inserting spikes through apertures in the contiguous plates into the drilled holes to retain these plates and ties together;
e. automatically placing the plated ties in spaced parallel relation with the plates up in two parallel rows;
f. automatically placing two parallel rails upon the two rows of plates in perpendicular relation to the ties;
g. automatically force-inserting some spikes so that they not only extend through plate apertures into drilled holes in the ties but also contiguously and retainingly engage bottom flanges of the rails with spike heads to thereby complete the section of off-site railroad track.

22. A method according to claim 21 wherein the drilled holes comprise blind bores.

23. A fully automated method of obtaining an off-site section of railroad track, comprising the acts of:
Pre-plating a plurality of wooden railroad ties without manual human intervention including forming holes in one surface of the ties, placing plates against the one surface of each tie, force-inserting spikes through apertures in the plates and into the holes, without human intervention, to thereby secure the plates to the ties;
constructing a section of railroad track remote from an installation site by creating an array comprising the pre-plated ties placed in the spaced parallel relation with the plates in two rows in aligned relation above the ties, without manual human intervention;
placing two rails across the aligned rows of plates, without manual human intervention;
forcing rail-retaining spikes through apertures in the plates and into the holes bringing heads of the rail-retaining spikes into contiguous relation with bottom flanges of the rails, without human intervention.

24. A method according to claim 23 further comprising the acts of transporting the section of railroad track to an installation site and installing the section as part of a railroad line.

25. A method of assembling a pre-fabricated section of railroad track, comprising the acts of:
pre-plating a plurality of railroad ties with plates and spikes;
pre-fabricating the section of railroad track by placing the pre-plated ties in spaced parallel relation, superimposing spaced rails upon the plates and spike-securing the rails to the plates and the ties, without manual human intervention.

26. A method according to claim 25 wherein the pre-plating act is without manual human intervention.

27. A fully automated method of pre-plating a wooden railroad tie, comprising the acts of:
automatically placing one or more wooden railroad ties at a bore-forming station; automatically forming bores through one surface of the one or more ties into two spaced sites such that the bores define the gauge and match apertures of yet-to-be-provided railroad plates;
automatically placing and retaining spaced railroad plates contiguously upon the one tie surface so that apertures in each plate are aligned with the bores;
automatically delivering railroad spikes to the plate and tie locations; and automatically force-inserting spikes through apertures in the contiguous plates and into bores in the one or more ties to retain the plates and ties together.

28. A method according to claim 27 wherein the bore-forming, the plate placement and the spike insertion take place in an upward direction.

29. A method according to claim 27 wherein the bore-forming, the plate placement, and the spike insertion take place in a downward direction.
